(19) United States
(12) Patent Application Publication
(10) Pub. No.: US 2010/0202711 A1
(43) Pub. Date: Aug. 12, 2010

(54) IMAGE PROCESSING APPARATUS, IMAGE PROCESSING METHOD, AND PROGRAM

(75) Inventors: Tetsujiro Kondo, Tokyo (JP); Tetsushi Kokubo, Kanagawa (JP); Satoshi Inoue, Tokyo (JP); Hiroto Kimura, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/668,839

(22) PCT Filed: Jul. 18, 2008
(86) PCT No.: PCT/JP2008/062997

§ 371 Date: Jan. 12, 2010

(30) Foreign Application Priority Data
Jul. 19, 2007 (JP) 2007-187879

(51) Int. Cl. G06K 9/40

(52) U.S. Cl. 382/254

(57) ABSTRACT

The present invention relates to an image processing apparatus, an image processing method, and a program with which processed images at the time of applying a plurality of different image processings on one moving image can be easily compared.

Image processing units 213-1 to 213-3 execute a predetermined image processing on an input image supplied from an image distribution unit 212 at the same time and supply processed images which are the images after the processing to an image synthesis unit 214. The image synthesis unit 214 uses the input image and the three types of the processed images to generate a synthesized image to be supplied to an image presentation unit 215. Also, the image synthesis unit 214 supplies a main image which is an image functioning as a principal among a plurality of images used for the synthesized image to an image recording unit 216. The present invention can be, for example, to an image processing apparatus configured to apply a plurality of different image processings on the moving image.

### TECHNICAL FIELD

The present invention relates to an image processing apparatus, an image processing method, and a program, in particular, an image processing apparatus, an image processing method, and a program suitable to a case in which processed images are easily compared when a plurality of different image processings are applied on one moving image.

### BACKGROUND ART

In a case where a plurality of different image processings are applied on a certain image and the image processing results are mutually compared and reviewed, a method of alternately displaying the plurality of processed images after the image processings on one monitor for comparison is easily considerable. Also, a method of displaying the plurality of processed images on the monitor at the same time for comparison also exists (for example, see Patent Documents 1 and 2).
Patent Document 1: Japanese Unexamined Patent Application Publication No. 2000-305193
Patent Document 2: Japanese Unexamined Patent Application Publication No. 2006-67155

### DISCLOSURE OF INVENTION

### Technical Problem

However, in a case where the plurality of comparison target processed images are still images, the processed images arranged and displayed on the monitor can be thoroughly compared and reviewed, but in a case where the plurality of comparison target processed images are moving images, the images are changed in a moment, and it is therefore difficult to perform the comparison only by simply looking at the processed images arranged and displayed on the monitor.

The present invention has been made in view of the above-mentioned circumstances and is aimed at making it possible to easily compare processed images when a plurality of different image processings are applied on one moving image.

### Technical Solution

An image processing apparatus according to an aspect of the present invention includes: a plurality of image processing means configured to perform a plurality of different image processings on one input image which is an image constituting a moving image and is sequentially input; and synthesized image generation means configured to generate a synthesized image in which a plurality of processed images which are respectively processed by the plurality of image processing means are synthesized, in which the synthesized image changes in accordance with results of the plurality of image processings.

Each of the plurality of image processing means can include: image quality change processing means configured to change an image quality of the input image into image qualities different in each of the plurality of image processing means; and expansion processing means configured to perform an expansion processing while using a predetermined position of the image after the change processing which is subjected to the change processing by the image quality change processing means as a reference, and control means configured to decide the predetermined position on the basis of change processing results by the image quality change processing means of the plurality of image processing means can be further provided.

The control means can decide a position as the predetermined position where a difference is large when the plurality of images after the change processings are mutually compared.

The synthesized image can be composed of a main image which is the processed image instructed by a user and a plurality of sub images which are the other processed images, and the synthesized image generation means can change an arrangement of the processed image which is set as the main image and the processed images set as the sub images on the basis of an instruction of the user.

The synthesized image generation means can perform a highlight display of the sub image selected by the user.

The plurality of image processing means can perform the plurality of different image processings by using a class classification adaptive processing.

Each of the plurality of image processing means can include: tracking processing means configured to track the predetermined position of the input image in tracking systems different in each of the plurality of image processing means; and expansion processing means configured to perform an expansion processing while using a tracking position which is a result of the tracking processing by the tracking processing means as a reference.

Control means configured to supply the tracking position selected by a user among the plurality of tracking positions as the predetermined position to the tracking processing means can be further provided.

The synthesized image can be composed of a main image which is the processed image instructed by a user and a plurality of sub images which are the other processed images, and the synthesized image generation means can change an arrangement of the sub images in accordance with a ratio of a horizontal component and a vertical component of a tracking difference vector representing a difference between the tracking position of the main image and the tracking position of the sub image.

Detection means configured to detect a time code representing which scene of the moving image the input image is on the basis of characteristic amounts of the plurality of input images and the same number of decision means configured to decide the predetermined positions as the number of the image processing means can be further provided, in which the decision means can store the predetermined position in the input image while corresponding to the time code and decide the different predetermined positions by each of the plurality of decision means corresponding to the detected time code, and each of the plurality of image processing means can include expansion processing means configured to perform an expansion processing while using the predetermined position decided by the decision means as a reference.

The plurality of expansion processing means can include the expansion processing means configured to perform a high image quality expansion processing and the expansion processing means configured to perform a low image quality expansion processing, and control means can be further provided which is configured to control a supply of an expanded image selected by a user among a plurality of expanded images subjected to the expansion processing by each of the plurality of expansion processing means to the expansion processing means at the predetermined position decided by the decision means so as to be processed by the expansion processing means configured to perform the high image quality expansion processing.

The synthesized image can be composed of a main image which is the processed image instructed by the user and a plurality of sub images which are the other processed images, and the synthesized image generation means can change an arrangement of the processed images so as to set the expanded image processed by the expansion processing means configured to perform the high image quality expansion processing as the main image.

The synthesized image generation means can calculate correlation values between the expanded image of the main image and the expanded images of the sub images and change an arrangement of the plurality of sub images in a descending order.

An image processing method according to an aspect of the present invention includes: performing a plurality of different image processings on one input image which is an image constituting a moving image and is sequentially input; and generating a synthesized image in which a plurality of processed images obtained as a result of being subjected to the image processings are synthesized, in which the synthesized image changes in accordance with results of the plurality of image processings.

A program according to an aspect of the present invention causes a computer to execute a processing including: performing a plurality of different image processings on one input image which is an image constituting a moving image and is sequentially input; and generating a synthesized image in which a plurality of processed images obtained as a result of being subjected to the image processings are synthesized, in which the synthesized image changes in accordance with results of the plurality of image processings.

According to an aspect of the present invention, the plurality of different image processings are performed on one input image which is the image constituting the moving image and is sequentially input, and the synthesized image is generated in which the plurality of processed images obtained as the result of being subjected to the image processings are synthesized.

### Advantageous Effects

According to an aspect of the present invention, it is possible to readily compare the processed images when the plurality of different image processings are applied on one moving image.

### BRIEF DESCRIPTION OF DRAWINGS

FIG. 1 is a block diagram showing a configuration example of an image conversion apparatus for performing an image conversion processing based on a class classification adaptive processing.

FIG. 2 is a flow chart for describing the image conversion processing by the image conversion apparatus.

FIG. 3 is a block diagram showing a configuration example of a learning apparatus for learning a tap coefficient.

FIG. 4 is a block diagram showing a configuration example of a learning unit of the learning apparatus.

FIG. 5 is a diagram for describing various image conversion processings.

FIG. 6 is a flow chart for describing a learning processing by the learning apparatus.

FIG. 7 is a block diagram showing a configuration example of the image conversion apparatus for performing the image conversion processing based on the class classification adaptive processing.

FIG. 8 is a block diagram showing a configuration example of the coefficient output unit of the image conversion apparatus.

FIG. 9 is a block diagram showing a configuration example of the leaning apparatus for learning coefficient seed data.

FIG. 10 is a block diagram showing a configuration example of the learning unit of the learning apparatus.

FIG. 11 is a flow chart for describing a learning processing by the learning apparatus.

FIG. 12 is a block diagram showing a configuration example of the leaning apparatus for learning the coefficient seed data.

FIG. 13 is a block diagram showing a configuration example of the learning unit of the learning apparatus.

FIG. 14 is a block diagram showing a configuration example of an embodiment of an image processing apparatus to which the present invention is applied.

FIG. 15 is a block diagram showing a first detailed configuration example of the image processing apparatus of FIG. 14.

FIG. 16 is a diagram for describing a detail of an image comparison processing.

FIG. 17 is a diagram for describing a detail of the image comparison processing.

FIG. 18 is a flow chart for describing a detail of the image comparison processing.

FIG. 19 is a flow chart for describing a first image processing.

FIG. 20 is a diagram showing an example of a display screen.

FIG. 21 is a diagram for describing a screen control according to a first embodiment.

FIG. 22 is a diagram for describing the screen control according to the first embodiment.

FIG. 23 is a diagram for describing the screen control according to the first embodiment.

FIG. 24 is a diagram for describing a parameter setting screen.

FIG. 25 is a diagram for describing the parameter setting screen.

FIG. 26 is a block diagram showing a second detailed configuration example of the image processing apparatus of FIG. 14.

FIG. 27 is a diagram for describing a tracking processing.

FIG. 28 is a flow chart for describing the tracking processing.

FIG. 29 is a flow chart for describing a second image processing.

FIG. 30 is a diagram for describing a screen control according to a second embodiment.

FIG. 31 is a diagram for describing the screen control according to the second embodiment.

FIG. 32 is a diagram showing another example of the display screen.

FIG. 33 is a diagram for describing a screen control.

FIG. 34 is a block diagram showing a third detailed configuration example of the image processing apparatus of FIG. 14.

FIG. 35 is a diagram for describing a time code detection processing.

FIG. 36 is a diagram for describing a screen control according to a third embodiment.

FIG. 37 is a diagram for describing the screen control according to the third embodiment.

FIG. 38 is a diagram for describing the screen control according to the third embodiment.

FIG. 39 is a flow chart for describing a third image processing.

FIG. 40 is a diagram for describing another screen control according to the third embodiment.

FIG. 41 is a diagram for describing another example of an image synthesis.

FIG. 42 is a block diagram showing a configuration example of an embodiment of a computer to which the present invention is applied.

### EXPLANATION OF REFERENCE NUMERALS

200 IMAGE PROCESSING APPARATUS, 213-1 TO 213-3 IMAGE PROCESSING UNIT, 214 IMAGE SYNTHESIS UNIT, 217 CONTROL UNIT, 241A TO 241C IMAGE QUALITY CHANGE PROCESSING UNIT, 242A TO 242C EXPANSION PROCESSING UNIT, 262 IMAGE COMPARISON UNIT, 341A TO 341C TRACKING PROCESSING UNIT, 242A′ TO 242C′ EXPANSION PROCESSING UNIT, 471 SYNCHRONIZATION CHARACTERISTIC AMOUNT EXTRACTION UNIT, 472A TO 472C SEQUENCE REPRODUCTION UNIT, 242A″ TO 242C″ EXPANSION PROCESSING UNIT, 473 SWITCHER UNIT

### BEST MODES FOR CARRYING OUT THE INVENTION

Embodiments of an image processing apparatus (system) to which the present invention is applied will be described, but beforehand, a class classification adaptive processing utilized for a signal processing performed by the image processing apparatus will be described. It should be noted that the class classification adaptive processing is an example of a processing utilized for the signal processing performed by the image processing apparatus, and the signal processing performed by the image processing apparatus may also be one not utilizing the class classification adaptive processing.

Also, herein, the class classification adaptive processing will be described while using an image conversion processing for converting first image data (image signal) into the second image data (image signal) as an example.

The image conversion processing for converting the first image data into the second image data becomes various signal processings depending on a definition of the first and second image data.

That is, for example, when the first image data is set as the image data with a low spatial resolution and also the second image data is set as the image data with a high spatial resolution, the image conversion processing can be mentioned as a spatial resolution creation (improvement) processing for improving the spatial resolution.

Also, for example, when the first image data is set as the image data with a low S/N (Signal/Noise) and also the second image data is set as the image data with a high S/N, the image conversion processing can be mentioned as a noise removal processing for removing the noise.

Furthermore, for example, when the first image data is set as the image data with a predetermined pixel number (size) and also the second image data is set as the image data with a pixel number more or fewer than the first image data, the image conversion processing can be mentioned as a resize processing for performing the resize (expansion or reduction) of the image.

Also, for example, when the first image data is set as the image data with a low temporal resolution and also the second image data is set as the image data with a high temporal resolution, the image conversion processing can be mentioned as a temporal resolution creation (improvement) processing for improving the temporal resolution.

Furthermore, for example, when the first image data is set as decoded image data obtained by decoding image data coded in units of block such through an MPEG (Moving Picture Experts Group) coding and also when the second image data is set as the image data before the coding, the image conversion processing can be mentioned as a distortion removal processing for removing various distortions such as a block distortion generated by the MPEG coding and decoding.

It should be noted that in the spatial resolution creation processing, when the first image data which is the image data with the low spatial resolution is converted into the second image data which is the image data with the high spatial resolution, the second image data can be set as the image data with the same pixel number as the first image data and can also be the image data with a pixel number larger than the first image data. In a case where the second image data is set as the image data with the pixel number larger than the first image data, the spatial resolution creation processing is a processing for improving the spatial resolution and also a resize processing for expanding the image size (pixel number).

As described above, depending on the image conversion processing, various signal processings can be realized depending on how to define the first and second image data.

In the class classification adaptive processing serving as the above-described image conversion processing, through a computation using a tap coefficient of a class obtained by performing a class classification on (a pixel value of) an attention pixel which attracts an attention among the second image data into one of a class among a plurality of classes and (a pixel value of) a pixel of the first image data selected with respect to the attention pixel, (the pixel value of) the attention pixel is obtained.

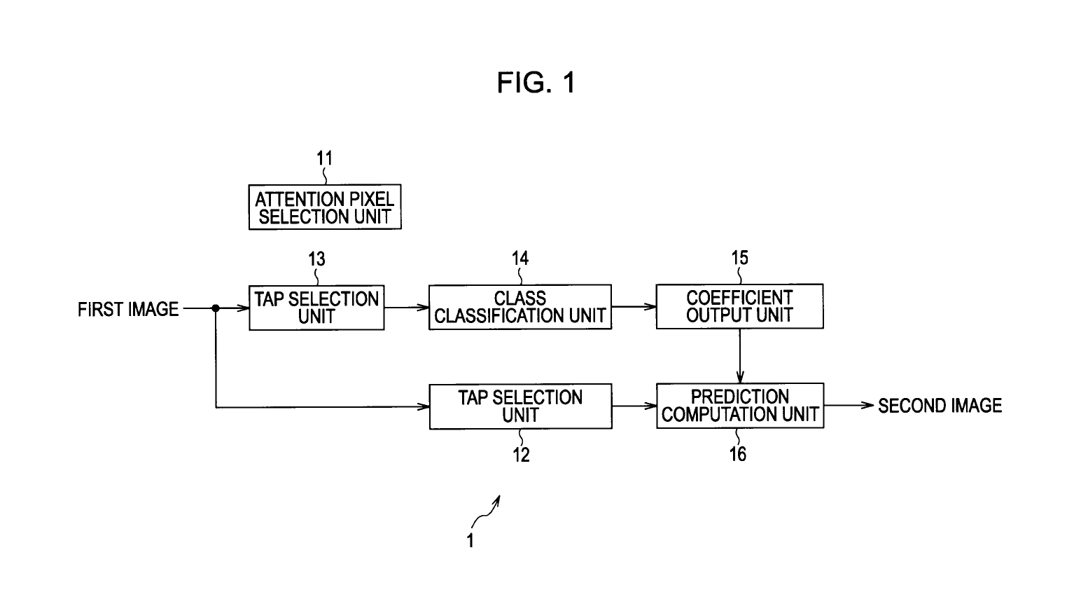

That is, FIG. 1 shows a configuration example of an image conversion apparatus 1 configured to perform the image conversion processing based on the class classification adaptive processing.

In the image conversion apparatus 1, image data supplied thereto is supplied as the first image data to tap selection unit 12 and 13.

An attention pixel selection unit 11 sequentially sets a pixel constituting the second image data as an attention pixel and supplies information representing the attention pixel to a necessary block.

The tap selection unit 12 selects some of (pixel values of) pixels constituting the first image data used for predicting (the pixel value of) the attention pixel as a prediction tap.

Specifically, the tap selection unit 12 selects a plurality of pixels of the first image data at positions spatially or temporarily close to a position in the temporal space of the attention pixel as the prediction tap.

The tap selection unit 13 selects some of pixels constituting the first image data used for performing the class classification for classifying the attention pixel into one of some classes as a class tap. That is, similarly as the tap selection unit 12 selects the prediction tap, the tap selection unit 13 selects the class tap.

It should be noted that the prediction tap and the class tap may have the same tap structure or may also have different tap structures.

The prediction tap obtained in the tap selection unit 12 is supplied to a prediction computation unit 16, and the class tap obtained in the tap selection unit 13 is supplied to a class classification unit 14.

On the basis of the class tap from the tap selection unit 13, the class classification unit 14 performs the class classification of the attention pixel and supplies a class code corresponding to the class obtained as the result to a coefficient output unit 15.

Herein, as a method of performing the class classification, for example, ADRC (Adaptive Dynamic Range Coding) or the like can be adopted.

In the method using the ADRC, (the pixel values of) the pixels constituting the class tap are subjected to an ADRC processing, and the class of the attention pixel is decided while following an ADRC code obtained as the result.

It should be noted that in a K-bit ADRC, for example, the maximum value MAX and a minimum value MIN of the pixel value for the pixel constituting the class tap are detected, and DR=MAX−MIN is set as a local dynamic range of an aggregate. On the basis of this dynamic range DR, the pixel values of the respective pixels constituting the class tap are re-quantized into K bits. That is, from the pixel values of the respective pixels constituting the class tap, the minimum value MIN is subtracted, and the subtracted value is divided by DR/2^{K} (re-quantized). Then, a bit sequence in which the pixel values in the K bits of the respective pixels constituting the class tap obtained in the above-mentioned manner are arranged in a predetermined order is output as the ADRC code. Therefore, in a case where the class tap is subjected, for example, to a 1-bit ADRC processing, the pixel values of the respective pixels constituting the class tap is divided by an average value of the maximum value MAX and the minimum value MIN (cutting of a fractional part), and according to this, the pixel values of the respective pixels are set in 1 bit (binarized). Then, a bit sequence in which the pixel values in 1-bit are arranged in a predetermined order is output as the ADRC code.

It should be noted that it is also possible to cause the class classification unit 14 to output a pattern of the pixel values of, for example, the pixels constituting the class tap as the class code as it is. However, in this case, when the class tap is constructed by the pixel values of N pixels, and the pixel values of the respective pixels are allocated with K bits, the number in the case of the class code output by the class classification unit 14 is (2^{N})^{K} patterns, which is an enormous number exponentially in proportion to the bit number K of the pixel values of the pixels.

Therefore, in the class classification unit 14, the class classification is preferably performed while the information amount of the class tap is compressed by the above-mentioned ADRC processing, a vector quantization, or the like.

The coefficient output unit 15 stores the tap coefficients for each class obtained through a learning which will be described below and further outputs the tap coefficient (the tap coefficient of the class represented by the class code supplied from the class classification unit 14) stored in an address corresponding to the class code supplied from the class classification unit 14 among the stored tap coefficients. This tap coefficient is supplied to the prediction computation unit 16.

Herein, the tap coefficient is comparable to a coefficient multiplied with input data in a so-called tap in a digital filter.

The prediction computation unit 16 obtains the prediction tap output by the tap selection unit 12 and the tap coefficient output by the coefficient output unit 15 and uses the prediction tap and the tap coefficient to perform a predetermined prediction computation for obtaining a predicted value of a true value of the attention pixel. According to this, the prediction computation unit 16 obtains and outputs (a predicted values of) the pixel value of the attention pixel, that is, the pixel value of the pixel constituting the second image data.

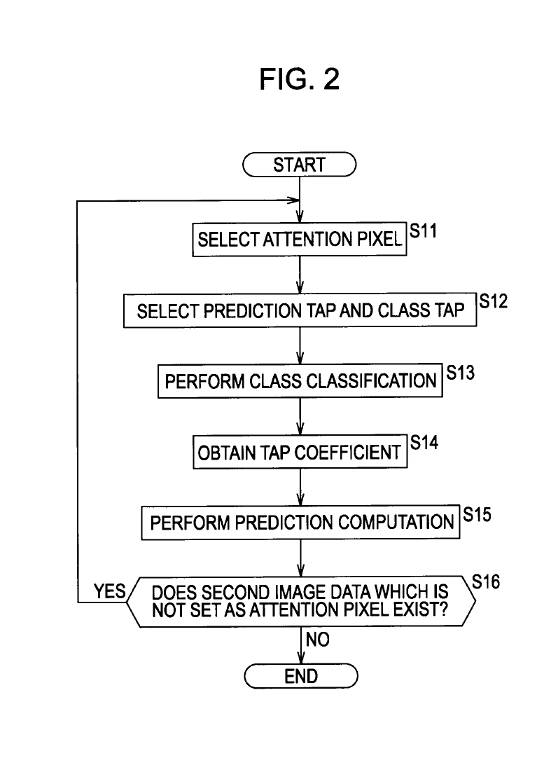

Next, with reference to a flow chart of FIG. 2, the image conversion processing by the image conversion apparatus 1 of FIG. 1 will be described.

In step S11, the attention pixel selection unit 11 selects one which is not set as the attention pixel yet as the attention pixel among the pixels constructing the second image data with respect to the first image data input to the image conversion apparatus 1. For example, among the pixels constructing the second image data, in a raster scan order, one which is not set as the attention pixel yet is selected as the attention pixel.

In step S12, the tap selection unit 12 and the tap selection unit 13 respectively select the prediction tap and the class tap regarding the attention pixel from the first image data supplied thereto. Then, the prediction tap is supplied from the tap selection unit 12 to the prediction computation unit 16, and the class tap is supplied from the tap selection unit 13 to the class classification unit 14.

The class classification unit 14 receives the class tap regarding the attention pixel from the tap selection unit 13, and in step S13, performs the class classification of the attention pixel on the basis of the class tap. Furthermore, the class classification unit 14 outputs a class code representing the class of the attention pixel obtained as a result of the class classification to the coefficient output unit 15.

In step S14, the coefficient output unit 15 obtains and outputs the tap coefficient stored in an address corresponding to the class code supplied from the class classification unit 14. Furthermore, in step S14, the prediction computation unit 16 obtains the tap coefficient output by the coefficient output unit 15.

In step S15, the prediction computation unit 16 uses the prediction tap output by the tap selection unit 12 and the tap coefficient obtained from the coefficient output unit 15 to perform a predetermined prediction computation. According to this, the prediction computation unit 16 obtains and outputs the pixel value of the attention pixel.

In step S16, the attention pixel selection unit 11 determines whether or not the second image data which is not set as the attention pixel yet exists. In step S16, in a case where it is determined that the second image data which is not set as the attention pixel yet exists, the processing returns to step S11, and afterward the similar processing is repeatedly performed.

Also, in step S16, in a case where it is determined that the second image data which is not set as the attention pixel yet does not exist, the processing is ended.

Next, the prediction computation in the prediction computation unit 16 of FIG. 1 and the learning of the tap coefficient stored in the coefficient output unit 15 will be described.

Now, a case is considered, for example, in which the image data with a high image quality (high image quality image data) is set as the second image data, and also the image data with a low image quality (low image quality image data) whose image quality (resolution) is decreased while the high image quality image data is subjected to filtering by an LPF (Low Pass Filter) or the like is set as the first image data to select the prediction tap from the low image quality image data, and by using the prediction tap and the tap coefficient, a pixel value of the pixel in the high image quality image data (high image quality pixel) is obtained (predicted) through a predetermined prediction computation.

As the predetermined prediction computation, for example, when a linear first-order prediction computation is adopted, the pixel value y of the high image quality pixel is obtained through the next linear primary expression.

$$\begin{matrix}[ Expression 1 ] & \\ y = {\sum }_{n = 1}^{N} {w}_{n} {x}_{n} & ( 1 )\end{matrix}$$

Where, in Expression (1), xₙ denotes a pixel value of the pixel in the n-th low image quality image data constituting the prediction tap regarding the high image quality pixel y (hereinafter, which is appropriately referred to as low image quality pixel), and wₙ denotes n-th tap coefficient to be multiplied with (the pixel value of) the n-th low image quality pixel. It should be noted that in Expression (1), the prediction tap is constituted by N low image quality pixel x₁, x₂, . . . , x_{N}.

Herein, the pixel value y of the high image quality pixel can also be obtained through a higher-order expression equal to or higher than second-order instead of the linear primary expression shown in Expression (1).

Now, when a true value of the pixel value of the k-th sample high image quality pixel is denoted by yₖ and also a predicted value of the true value yₖ obtained through Expression (1) is denoted by yₖ′, a prediction error eₖ thereof is represented by the following expression.

[Expression 2]

eₖ=yₖ−yₖ′ (2)

Now, as the predicted value yk′ in Expression (2) is obtained while following Expression (1), when yk′ in Expression (2) is replaced while following Expression (1), the following expression is obtained.

$$\begin{matrix}[ Expression 3 ] & \\ {e}_{k} = {y}_{k} - ( {\sum }_{n = 1}^{N} {w}_{n} {x}_{n , k} ) & ( 3 )\end{matrix}$$

It should be however that in Expression (3), x_{n, k} denotes n-th the low image quality pixel constituting the prediction tap regarding the k-th sample high image quality.

A tap coefficient wₙ where the prediction error eₖ is 0 in Expression (3) (or Expression (2)) becomes an optimal one for predicting the high image quality pixel, and regarding all the high image quality pixels, it is generally difficult to obtain such tap coefficient wₙ.

In view of the above, if the method of least squares is adopted as a rule representing that the tap coefficient wₙ is the optimal one, for example, the optimal tap coefficient wₙ can be obtained by minimizing a total sum E for the square errors represented by the following expression.

$$\begin{matrix}[ Expression 4 ] & \\ E = {\sum }_{k = 1}^{K} {e}_{k}^{2} & ( 4 )\end{matrix}$$

It should be however that in Expression (4), K denotes the number of samples of sets of the high image quality pixel yₖ and the low image quality pixels x_{1, k}, x_{2, k}, . . . , x_{N, k} constituting the prediction tap regarding the high image quality pixel yₖ (the number of learning material samples).

The minimum value (local minimal value) of the total sum E for the square errors in Expression (4) is obtained by wₙ in which, as shown in Expression (5), the total sum E is subjected to partial differentiation by the tap coefficient wₙ is set as 0.

$$\begin{matrix}[ Expression 5 ] & \\ \frac{\partial E}{\partial {w}_{n}} = {e}_{1} \frac{\partial {e}_{1}}{\partial {w}_{n}} + {e}_{2} \frac{\partial {e}_{2}}{\partial {w}_{n}} + … + {e}_{k} \frac{\partial {e}_{k}}{\partial {w}_{n}} = 0 ( n = 1 , 2 , … , N ) & ( 5 )\end{matrix}$$

In view of the above, when the above-mentioned Expression (3) is subjected to partial differentiation by the tap coefficient wₙ, the following expression is obtained.

$$\begin{matrix}[ Expression 6 ] & \\ \frac{\partial {e}_{k}}{\partial {w}_{1}} = - {x}_{1 , k} , \frac{\partial {e}_{k}}{\partial {w}_{2}} = - {x}_{2 , k} , … , \frac{\partial {e}_{k}}{\partial {w}_{N}} = - {x}_{N , k} , \\ ( k = 1 , 2 , … , K ) & ( 6 )\end{matrix}$$

From Expressions (5) and (6), the following expression is obtained.

$$\begin{matrix}[ Expression 7 ] & \\ {\sum }_{k = 1}^{K} {e}_{k} {x}_{1 , k} = 0 , {\sum }_{k = 1}^{K} {e}_{k} {x}_{2 , k} = 0 , … {\sum }_{k = 1}^{K} {e}_{k} {x}_{N , k} = 0 & ( 7 )\end{matrix}$$

As eₖ in Expression (7) is assigned to Expression (3), Expression (7) can be represented by a normal equation shown in Expression (8).

$$\begin{matrix}[ Expression 8 ] & \\ ( \begin{matrix}( {\sum }_{k = 1}^{K} {x}_{1 , k} {x}_{1 , k} ) & ( {\sum }_{k = 1}^{K} {x}_{1 , k} {x}_{2 , k} ) & … & ( {\sum }_{k = 1}^{K} {x}_{1 , k} {x}_{N , k} ) \\ ( {\sum }_{k = 1}^{K} {x}_{2 , k} {x}_{1 , k} ) & ( {\sum }_{k = 1}^{K} {x}_{2 , k} {x}_{2 , k} ) & … & ( {\sum }_{k = 1}^{K} {x}_{2 , k} {x}_{N , k} ) \\ ⋮ & ⋮ & ⋱ & ⋮ \\ ( {\sum }_{k = 1}^{K} {x}_{N , k} {x}_{1 , k} ) & ( {\sum }_{k = 1}^{K} {x}_{N , k} {x}_{2 , k} ) & … & ( {\sum }_{k = 1}^{K} {x}_{N , k} {x}_{N , k} )\end{matrix} ) ( \begin{matrix}{w}_{1} \\ {w}_{2} \\ ⋮ \\ {w}_{N}\end{matrix} ) = ( \begin{matrix}( {\sum }_{k = 1}^{K} {x}_{1 , k} {y}_{k} ) \\ ( {\sum }_{k = 1}^{K} {x}_{2 , k} {y}_{k} ) \\ ⋮ \\ ( {\sum }_{k = 1}^{K} {x}_{N , k} {y}_{k} )\end{matrix} ) & ( 8 )\end{matrix}$$

The normal equation of Expression (8) can solve the tap coefficient wₙ, for example, by using the discharge method (Gauss-Jordan elimination method) or the like.

As the normal equation of Expression (8) is established for each class and solved, the optimal tap coefficient (herein, the coefficient for minimizing the total sum E for the square errors) wₙ can be obtained for each class.

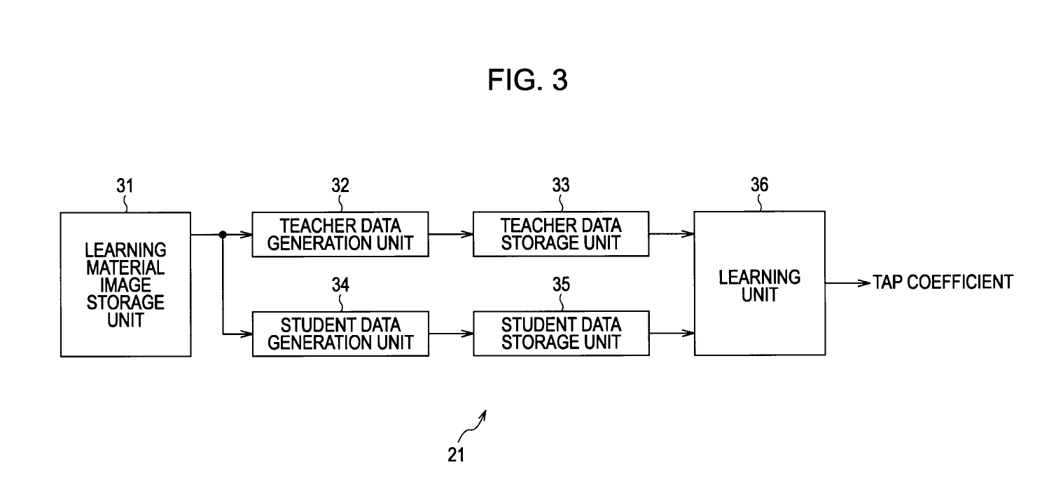

FIG. 3 shows a configuration example of a learning apparatus 21 configured to perform a leaning for obtaining the tap coefficient wₙ by establishing and solving the normal equation of Expression (8).

A learning material image storage unit 31 stores learning material image data used for leaning the tap coefficient wₙ. Herein, for the learning material image data, for example, the high image quality image data with a high resolution can be used.

A teacher data generation unit 32 reads out the learning material image data from the learning material image storage unit 31. Furthermore, the teacher data generation unit 32 generates the teacher for the learning on the tap coefficient (true value), that is, teacher data which is a pixel value of a mapping destination of mapping serving as a prediction computation through Expression (1) from the learning material image data to be supplied to a teacher data storage unit 33. Herein, the teacher data generation unit 32 supplies, for example, the high image quality image data serving as the learning material image data to the teacher data storage unit 33 as the teacher data as it is.

The teacher data storage unit 33 stores the high image quality image data serving as the teacher data supplied from the teacher data generation unit 32.

A student data generation unit 34 reads out the learning material image data from the learning material image storage unit 31. Furthermore, the student data generation unit 34 generates a student for the learning on the tap coefficient, that is, student data which is a pixel value of a conversion target by the mapping serving as a prediction computation through Expression (1) from the learning material image data to be supplied to a student data storage unit 174. Herein, the student data generation unit 34 performs, for example, a filtering on the high image quality image data serving as the learning material image data for decreasing the resolution to generate the low image quality image data and supplies this low image quality image data as the student data to the student data storage unit 35.

The student data storage unit 35 stores the student data supplied from the student data generation unit 34.

A learning unit 36 sequentially sets pixels constituting the high image quality image data serving as the teacher data stored in the teacher data storage unit 33 as an attention pixel and regarding the attention pixel, selects the low image quality pixel with the same tap structure as one selected by the tap selection unit 12 of FIG. 1 among the low image quality pixels constituting the low image quality image data serving as the student data stored in the student data storage unit 35 as the prediction tap. Furthermore, the learning unit 36 uses the respective pixels constituting the teacher data and the prediction tap selected when the pixel is set as the attention pixel to obtain the tap coefficient for each class by establishing and solving the normal equation of Expression (8) for each class.

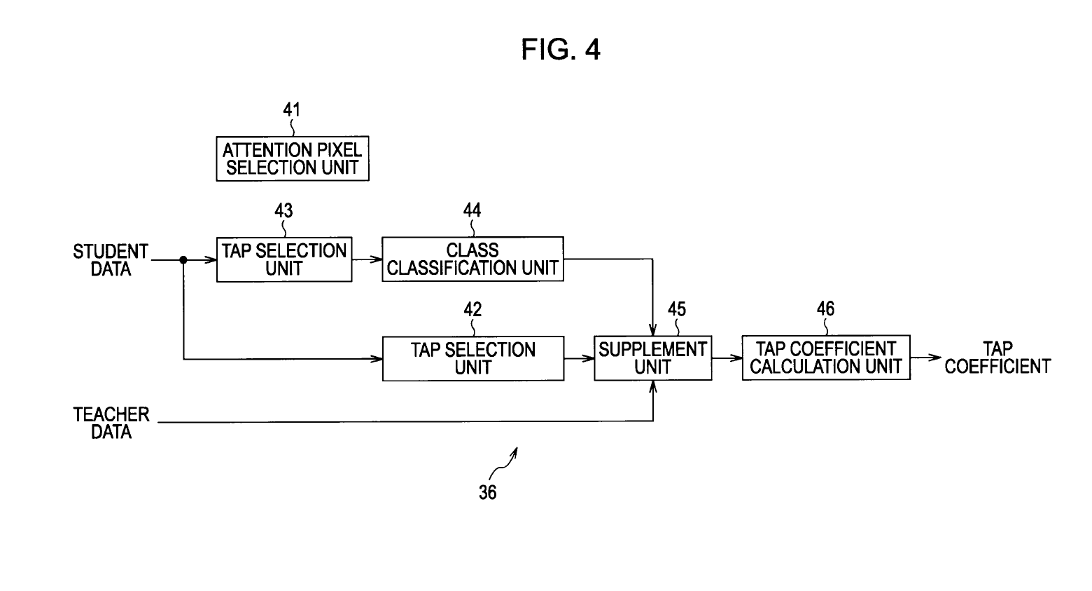

That is, FIG. 4 shows a configuration example of the learning unit 36 of FIG. 3.

An attention pixel selection unit 41 sequentially selects the pixels constituting the teacher data stored in the teacher data storage unit 33 as the attention pixel and supplies information representing the attention pixel to a necessary block.

A tap selection unit 42 selects, regarding the attention pixel, the same pixel as the one selected by the tap selection unit 12 of FIG. 1 from the low image quality pixel constituting the low image quality image data serving as the student data stored in the student data storage unit 35, and according to this, obtains the prediction tap with the same tap structure as the one obtained in the tap selection unit 12 to be supplied to a supplement unit 45.

A tap selection unit 43 selects, regarding the attention pixel, the same pixel as the one selected by the tap selection unit 13 of FIG. 1 from the low image quality pixel constituting the low image quality image data serving as the student data stored in the student data storage unit 35, and according to this, obtains the class tap with the same tap structure as the one obtained in the tap selection unit 13 to be supplied to a class classification unit 44.

On the basis of the class tap output by the tap selection unit 43, the class classification unit 44 performs the same class classification as the class classification unit 14 of FIG. 1 and outputs a class code corresponding to the class obtained as the result to the supplement unit 45.

The supplement unit 45 reads out the teacher data (pixel) which becomes the attention pixel from the teacher data storage unit 33 and performs supplement in which the attention pixel and the student data (pixel) constituting the prediction tap supplied from the tap selection unit 42 regarding the attention pixel are set as the targets for each class code supplied from the class classification unit 44.

That is, the supplement unit 45 is supplied with the teacher data yₖ stored in the teacher data storage unit 33, the prediction tap x_{n, k} output by the tap selection unit 42, and the class code output by the class classification unit 44.

Then, for each class corresponding to the class code supplied from the class classification unit 44, the supplement unit 45 uses the prediction tap (student data) x_{n, k} to perform a multiplication of mutual student data in a matrix on the left side in Expression (8) (x_{n, k}x_{n′, k}) and a computation comparable to the summation (Σ).

Furthermore, for each class corresponding to the class code supplied from the class classification unit 44, the supplement unit 45 all the same uses the prediction tap (student data) x_{n, k} and the teacher data yₖ to perform a multiplication of the student data x_{n, k} in the vector on the right side in Expression (8) and the teacher data yₖ (x_{n, k}yₖ) and a computation comparable to the summation (Σ).

That is, the supplement unit 45 stores the component (Σx_{n, k}x_{n′, k}) in a matrix on the left side in Expression (8) and the component (Σx_{n, k}yₖ) in a vector on the right side obtained regarding the teacher data set as the attention pixel in the previous time in a built-in memory thereof (not shown) and with respect to the component (Σx_{n, k}x_{n′, k}) in the matrix or the component (Σx_{n, k}yₖ) in the vector, regarding the teacher data newly set as the attention pixel, supplements the corresponding component x_{n, k+1}x_{n′, k+1} or x_{n, k+1}yₖ₊₁ calculated by using the teacher data yₖ₊₁ and the student data x_{n, k+1} (performs the addition represented by the summation in Expression (8)).

Then, the supplement unit 45 sets all the teacher data stored in the teacher data storage unit 33 (FIG. 3) as the attention pixel and performs the above-mentioned supplement, so that for the respective classes, when the normal equation shown in Expression (8) is established, the normal equation is supplied to a tap coefficient calculation unit 46.

The tap coefficient calculation unit 46 obtains and outputs the optimal tap coefficient wₙ for the respective classes by solving the normal equation for the respective classes supplied from the supplement unit 45.

The coefficient output unit 15 in the image conversion apparatus 1 of FIG. 1 stores the tap coefficient wₙ for each class obtained as described above.

Herein, depending on a manner of selecting the image data serving as the student data corresponding to the first image data and the image data serving as the teacher data corresponding to the second image data, for the tap coefficient, as described above, one for performing the various image conversion processings can be obtained.

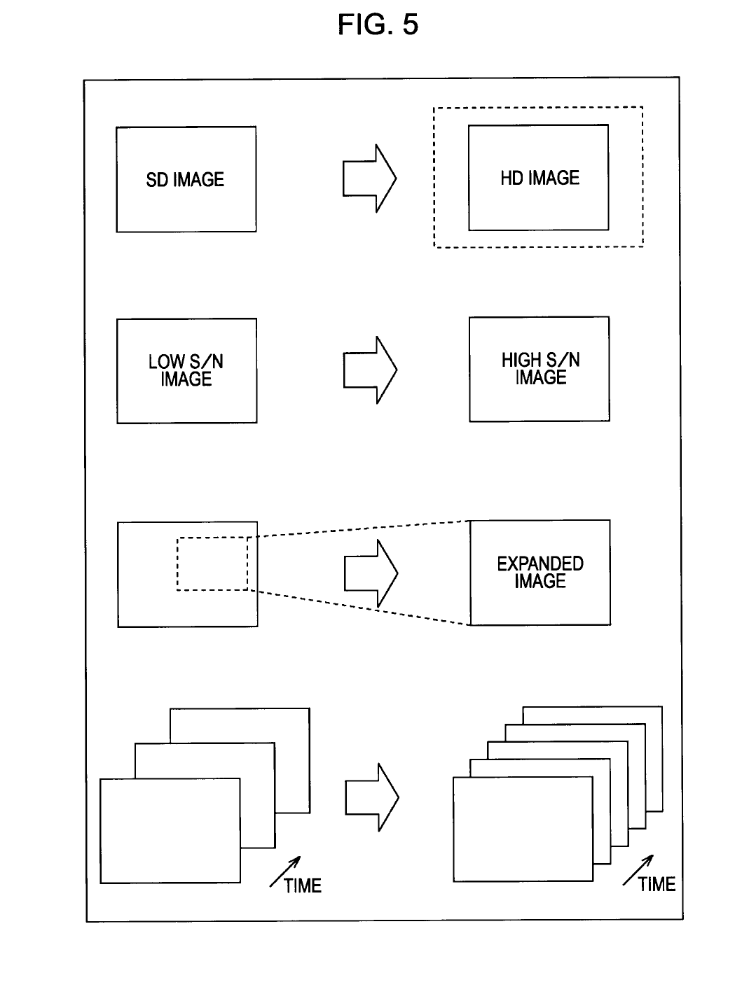

That is, as described above, by performing the learning on the tap coefficient while the high image quality image data is set as the teacher data corresponding to the second image data and also the low image quality image data in which the spatial resolution of the high image quality image data is degraded is set as the student data corresponding to the first image data, for the tap coefficient, as shown in the first from the top of FIG. 5, one for performing the image conversion processing as the spatial resolution creation processing for converting the first image data which is the low image quality image data (SD (Standard Definition) image) into the second image data which is the high image quality image data (HD (High Definition) image data) in which the spatial resolution is improved can be obtained.

It should be noted that in this case, the pixel number of the first image data (student data) may be the same as or may be smaller than that of the second image data (teacher data).

Also, for example, by performing the learning on the tap coefficient while the high image quality image data is set as the teacher data and also the image data where noise is overlapped with respect to the high image quality image data serving as the teacher data is set as the student data, for the tap coefficient, as shown in the second from the top of FIG. 5, one for performing the image conversion processing as the noise removal processing for converting the first image data which is the image data with the low S/N into the second image data which is the image data with the high S/N from which the noise included therein is removed (reduced) can be obtained.

Furthermore, for example, by performing the learning on the tap coefficient while certain image data is set as the teacher data and also the image data where the pixel number of the image data serving as the teacher data is thinned out is set as the student data, for the tap coefficient, as shown in the third from the top of FIG. 5, one for performing the image conversion processing as the expansion processing (resize processing) for converting the first image data which is a part of the image data into the second image data which is the expanded image data in which the first image data is expanded can be obtained.

It should be noted that the tap coefficient for performing the expansion processing can also be obtained by the learning on the tap coefficient while the high image quality image data is set as the teacher data and also the low image quality image data in which the spatial resolution of the high image quality image data is degraded by thinning out the pixel number is set as the student data.

Also, for example, by performing the learning on the tap coefficient while the image data with a high frame rate is set as the teacher data and also the image data in which the frames of the image data with the high frame rate serving as the teacher data are thinned out is set as the student data, for the tap coefficient, as shown in the fourth from the top of FIG. 5 (bottom), one for performing the image conversion processing as the temporal resolution creation processing for converting the first image data with a predetermined frame rate into the second image data with a high frame rate can be obtained.

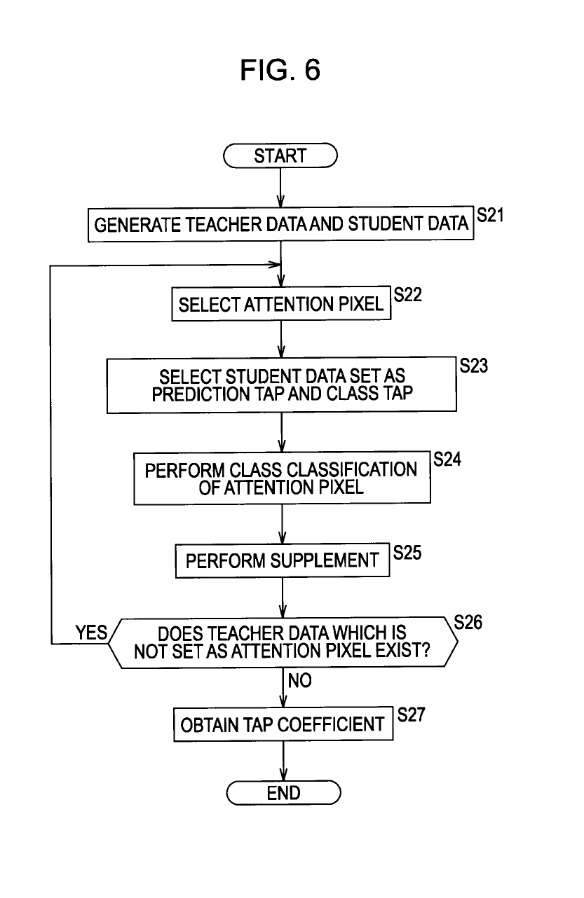

Next, with reference to a flow chart of FIG. 6, a processing (learning processing) by the learning apparatus 21 of FIG. 3 will be described.

First, in step S21, the teacher data generation unit 32 and the student data generation unit 34 generate the teacher data and the student data from the learning material image data stored in the learning material image storage unit 31 and to be respectively supplied to the teacher data storage unit 33 and the student data generation unit 34 and stored.

It should be noted that in the teacher data generation unit 32 and the student data generation unit 34, respectively, what kinds of student data and teacher data are generated are varied depending on the learning on the tap coefficient performed for one of the processings among the image conversion processings of the above-mentioned types.

After that, the processing proceeds to step S22, and in the learning unit 36 (FIG. 4), the attention pixel selection unit 41 selects one which is not set as the attention pixel yet as the attention pixel among the teacher data stored in the teacher data storage unit 33. In step S23, the tap selection unit 42 selects the pixel serving as the student data as the prediction tap from the student data stored in the student data storage unit 35 regarding the attention pixel to be supplied to the supplement unit 45, and also the tap selection unit 43 all the same selects the student data set as the class tap from the student data stored in the student data storage unit 35 regarding the attention pixel to be supplied to the class classification unit 44.

In step S24, the class classification unit 44 performs the class classification of the attention pixel on the basis of the class tap regarding the attention pixel and outputs the class code corresponding to the class obtained as the result to the supplement unit 45.

In step S25, the supplement unit 45 reads out the attention pixel from the teacher data storage unit 33 and performs the supplement of Expression (8) for each of the class codes supplied from the class classification unit 44 while the attention pixel and the student data constituting the prediction tap selected with regard to the attention pixel supplied from the tap selection unit 42 are set as the targets.

In step S26, the attention pixel selection unit 41 determines whether or not the teacher data which is not set as the attention pixel is still stored in the teacher data storage unit 33. In step S26, in a case where it is determined that the attention pixel is still stored in the teacher data storage unit 33, the processing returns to step S22, and afterward the similar processing is repeatedly performed.

Also, in step S26, in a case where it is determined that the attention pixel is not stored in the teacher data storage unit 33, the processing proceeds to step S27, and the supplement unit 45 supplies the matrix on the left side and the vector on the right side in Expression (8) for each of the classes obtained through the processing up to the present in steps S22 to S26 to the tap coefficient calculation unit 46.

Furthermore, in step S27, by solving the normal equation for each of the classes constituted by the matrix on the left side and the vector on the right side in Expression (8) supplied from the supplement unit 45 for each of the classes, the tap coefficient calculation unit 46 obtains and outputs the tap coefficient wₙ for each of the classes, and the processing is ended.

It should be noted that due to a state or the like where the number of the learning material image data is not sufficient, a class may be generated with which the number of the normal equations necessary for obtaining the tap coefficient cannot be obtained. However, as to such a class, the tap coefficient calculation unit 46 is configured to output, for example, a default tap coefficient.

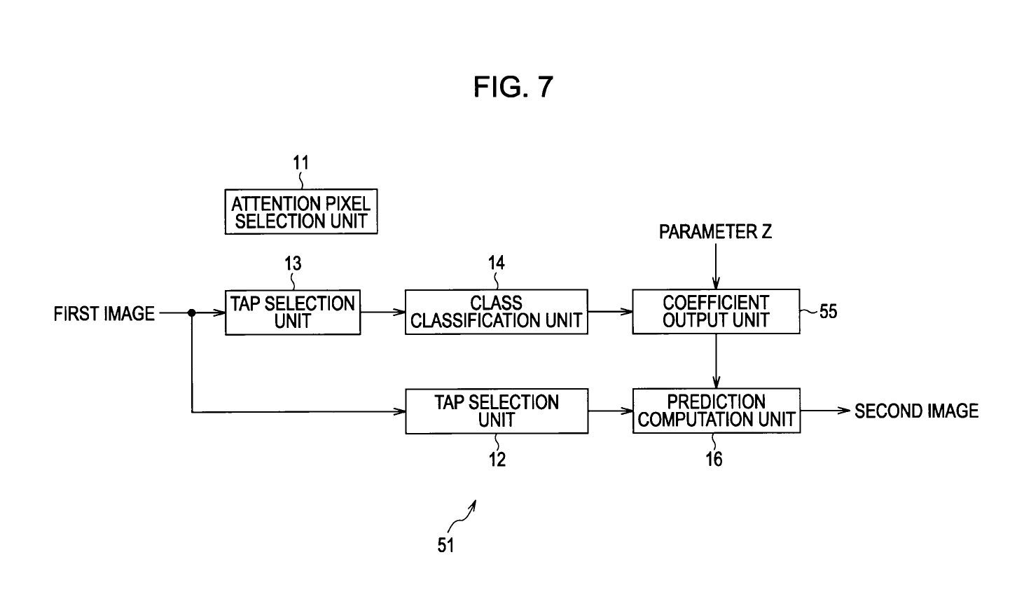

FIG. 7 shows a configuration example of an image conversion apparatus 51 which is another image conversion apparatus configured to perform the image conversion processing based on the class classification adaptive processing.

It should be noted that in the drawing, a part corresponding to the case in FIG. 1 is assigned with the same reference symbol, and hereinafter, a description thereof will be appropriately omitted. That is, the image conversion apparatus 51 is similarly configured as in the image conversion apparatus 1 of FIG. 1 except that a coefficient output unit 55 is provided instead of the coefficient output unit 15.

To the coefficient output unit 55, in addition to the class (class code) supplied from the class classification unit 14, for example, a parameter z input from the outside in accordance with an operation of the user is supplied. As will be described below, the coefficient output unit 55 generates the tap coefficient for each class corresponding to the parameter z and outputs the tap coefficient for the class from the class classification unit 14 among the tap coefficients for the respective classes to the prediction computation unit 16.

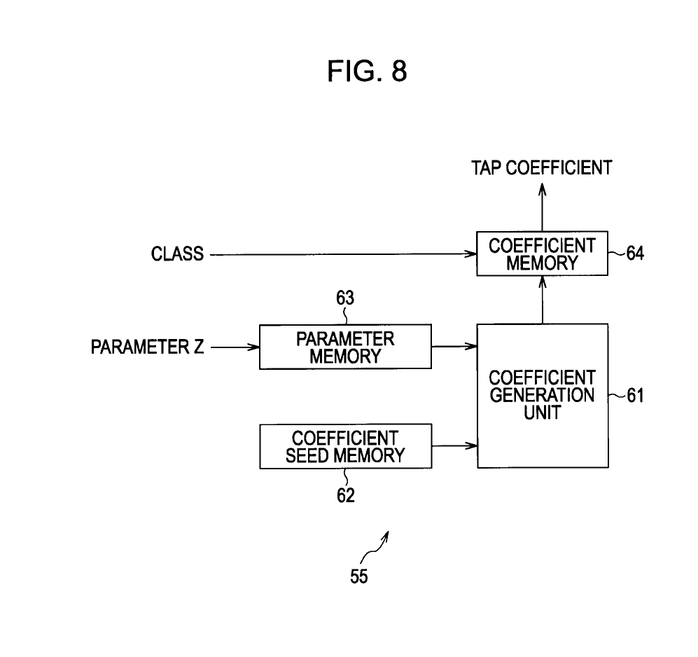

FIG. 8 shows a configuration example of the coefficient output unit 55 of FIG. 7.

A coefficient generation unit 61 generates a tap coefficient for each class on the basis of coefficient seed data stored in a coefficient seed memory 62 and a parameter z stored in a parameter memory 63 to be supplied to a coefficient memory 64 and stored in an overwriting manner.

The coefficient seed memory 62 stores the coefficient seed data for each class obtained through a learning on the coefficient seed data which will be described below. Herein, the coefficient seed data is so-called data becoming a seed for generating the tap coefficient.

The parameter memory 63 stores the parameter z input from the outside in accordance with the operation of the user or the like in an overwriting manner.

The coefficient memory 64 stores the tap coefficient for each class supplied from the coefficient generation unit (the tap coefficient for each class corresponding to the parameter z). Then, the coefficient memory 64 reads out the coefficient for the class supplied from the class classification unit 14 (FIG. 7) to be output to the prediction computation unit 16 (FIG. 7).

In the image conversion apparatus 51 of FIG. 7, when the parameter z is input to the coefficient output unit 55 from the outside, in the parameter memory 63 of the coefficient output unit 55 (FIG. 8), the parameter z is stored in an overwriting manner.

When the parameter z is stored in the parameter memory (when the storage content of the parameter memory 63 is updated), the coefficient generation unit 61 reads out the coefficient seed data for each class from the coefficient seed memory 62 and also reads out the parameter z from the parameter memory 63, and on the basis of the coefficient seed data and the parameter z, obtains the tap coefficient for each class. Then, the coefficient generation unit 61 supplies the tap coefficient for each class to the coefficient memory 64 to be stored in an overwriting manner.

The image conversion apparatus 51 stores the tap coefficient, and in the coefficient output unit 55 provided instead of the coefficient output unit 15 for outputting the tap coefficient, except for generating and outputting the tap coefficient corresponding to the parameter z, a processing is performed which is similar to the processing following the flow chart of FIG. 2 performed by the image conversion apparatus 1 of FIG. 1.

Next, a prediction computation in the prediction computation unit 16 of FIG. 7 as well as a tap coefficient generation in the coefficient generation unit 61 of FIG. 8 and the learning on the coefficient seed data stored in the coefficient seed memory 62 will be described.

As in the case according to the embodiment of FIG. 1, a case is considered where the prediction tap is selected from the low image quality image data while the image data with a high image quality (high image quality image data) is set as the second image data and also the image data with a low image quality (low image quality image data) in which the spatial resolution of the high image quality image data is decreased is set as the first image data, and by using the prediction tap and the tap coefficient, the pixel value of the high image quality pixel which is the pixel of the high image quality image data is obtained (predicted), for example, through the linear first-order prediction computation of Expression (1).

Herein, the pixel value y of the high image quality pixel can also be obtained through a higher-order expression equal to or higher than the second order instead of the linear primary expression shown in Expression (1).

According to the embodiment of FIG. 8, in the coefficient generation unit 61, the tap coefficient wₙ is generated from the coefficient seed data stored in the coefficient seed memory 62 and the parameter z stored in the parameter memory 63, but this generation of the tap coefficient wₙ in the coefficient generation unit 6 is performed, for example, through the following expression using the coefficient seed data and the parameter z.

$$\begin{matrix}[ Expression 9 ] & \\ {w}_{n} = {\sum }_{m = 1}^{M} {β}_{m , n} {z}^{m - 1} & ( 9 )\end{matrix}$$

Where, in Expression (9), β_{m, n} denotes the m-th coefficient seed data used for obtaining the n-th tap coefficient wₙ. It should be noted that in Expression (9), the tap coefficient wₙ is obtained by using M coefficient seed data β_{1, n}, β_{2, n}, . . . , β_{M, n}.

Herein, from the coefficient seed data β_{m, n} and the parameter z, the expression for obtaining the tap coefficient wₙ is not limited to Expression (9).

Now, a value z^{m-1} decided by the parameter z in Expression (9) is defined by the following expression while a new variable tₘ is introduced.

[Expression 10]

tₘ=z^{m-1} (m=1, 2, . . . , M) (10)

As Expression (10) is assigned to Expression (9), the following expression is obtained.

$$\begin{matrix}[ Expression 11 ] & \\ {w}_{n} = {\sum }_{m = 1}^{M} {β}_{m , n} {t}_{m} & ( 11 )\end{matrix}$$

According to Expression (11), the tap coefficient wₙ is obtained by the linear primary expression based on the coefficient seed data β_{m, n} and the variable tₘ.

Incidentally, now, when a true value of the pixel value for the high image quality pixel of the k-sample is denoted by yₖ and also a predicted value of the true value yₖ obtained through Expression (1) is denoted by yₖ′, the prediction error eₖ is represented by the following expression.

[Expression 12]

eₖ=yₖ−yₖ′ (12)

Now, as the predicted value yₖ′ in Expression (12) is obtained while following Expression (1), yₖ′ in Expression (12) is replaced while following Expression (1), the following expression is obtained.

$$\begin{matrix}[ Expression 13 ] & \\ {e}_{k} = {y}_{k} - ( {\sum }_{n = 1}^{N} {w}_{n} {x}_{n , k} ) & ( 13 )\end{matrix}$$

Where, in Expression (13), x_{n, k} denotes the n-th low image quality pixel constituting the prediction tap with regard to the high image quality pixel of the k-sample.

As Expression (11) is assigned to wₙ in Expression (13), the following expression is obtained.

$$\begin{matrix}[ Expression 14 ] & \\ {e}_{k} = {y}_{k} - ( {\sum }_{n = 1}^{N} ( {\sum }_{m = 1}^{M} {β}_{m , n} {t}_{m} ) {x}_{n , k} ) & ( 14 )\end{matrix}$$

Although the coefficient seed data β_{m, n} where the prediction error eₖ in Expression (14) is 0 becomes an optimal one for predicting the high image quality pixel, regarding all the high image quality pixels, it is generally difficult to obtain such coefficient seed data β_{m, n}.

In view of the above, if the method of least squares is adopted as a rule representing that the coefficient seed data β_{m, n} is optimal, for example, the optimal coefficient seed data β_{m, n} can be obtained by minimizing the total sum E for the square errors represented by the following expression.

$$\begin{matrix}[ Expression 15 ] & \\ E = {\sum }_{k = 1}^{K} {e}_{k}^{2} & ( 15 )\end{matrix}$$

Where, in Expression (15), K denotes the sample number (the number of learning material samples) of sets of the high image quality pixel yₖ and the low image quality pixels x_{1, k}, x_{2, k}, . . . , x_{N, k} constituting the prediction tap with regard to the high image quality pixel yₖ.

The minimum value (local minimal value) of the total sum E for the square errors in Expression (15) is given by β_{m, n}, as shown in Expression (16), where the total sum E subjected to a partial differentiation by the coefficient seed data β_{m, n} is set as 0.

$$\begin{matrix}[ Expression 16 ] & \\ \frac{\partial E}{\partial {β}_{m , n}} = {\sum }_{k = 1}^{K} 2 \cdot \frac{\partial {e}_{k}}{\partial {β}_{m , n}} \cdot {e}_{k} = 0 & ( 16 )\end{matrix}$$

As Expression (13) is assigned to Expression (16), the following expression is obtained.

$$\begin{matrix}[ Expression 17 ] & \\ {\sum }_{k = 1}^{K} {t}_{m} {x}_{n , k} {e}_{k} = {\sum }_{k = 1}^{K} {t}_{m} {x}_{n , k} ( {y}_{k} - ( {\sum }_{n = 1}^{N} ( {\sum }_{m = 1}^{M} {β}_{m , n} {t}_{m} ) {x}_{n , k} ) = 0 & ( 17 )\end{matrix}$$

Now, x_{i, p, j, q} and y_{i, p} are defined as shown in Expressions (18) and (19).

$$\begin{matrix}[ Expression 18 ] & \\ {X}_{i , p , j , q} = {\sum }_{k = 1}^{K} {x}_{i , k} {t}_{p} {x}_{j , k} {t}_{q} \\ ( i = 1 , 2 , … , N \text{:} j = 1 , 2 , … , N \text{:} p = 1 , 2 , … , M \text{:} q = 1 , 2 , … , M ) & ( 18 ) \\ [ Expression 19 ] & \\ {Y}_{i , p} = {\sum }_{k = 1}^{K} {x}_{i , k} {t}_{p} {y}_{k} & ( 19 )\end{matrix}$$

In this case, Expression (17) can be representing by the normal equation shown in Expression (20) using X_{i, p, j, q} and Y_{i, p}.

$$\begin{matrix}[ Expression 20 ] & \\ [ \begin{matrix}{X}_{1 , 1 , 1 , 1} & {X}_{1 , 1 , 1 , 2} & ⋯ & {X}_{1 , 1 , 1 , M} & {X}_{1 , 1 , 2 , 1} & ⋯ & {X}_{1 , 1 , N , M} \\ {X}_{1 , 2 , 1 , 1} & {X}_{1 , 2 , 1 , 2} & ⋯ & {X}_{1 , 2 , 1 , M} & {X}_{1 , 2 , 2 , 1} & ⋯ & {X}_{1 , 2 , N , M} \\ ⋮ & ⋮ & ⋱ & ⋮ & ⋮ & & ⋮ \\ {X}_{1 , M , 1 , 1} & {X}_{1 , M , 1 , 2} & ⋯ & {X}_{1 , M , 1 , M} & {X}_{1 , M , 2 , 1} & ⋯ & {X}_{1 , M , N , M} \\ {X}_{2 , 1 , 1 , 1} & {X}_{2 , 1 , 1 , 2} & ⋯ & {X}_{2 , M , 1 , M} & {X}_{2 , M , 2 , 1} & ⋯ & {X}_{2 , M , N , M} \\ ⋮ & ⋮ & & ⋮ & ⋮ & ⋱ & ⋮ \\ {X}_{N , M , 1 , 1} & {X}_{N , M , 1 , 2} & ⋯ & {X}_{N , M , 1 , M} & {X}_{N , M , 2 , M} & ⋯ & {X}_{N , M , N , M}\end{matrix} ] [ \begin{matrix}{β}_{1 , 1} \\ {β}_{2 , 1} \\ ⋮ \\ {β}_{M , 1} \\ {β}_{1 , 2} \\ ⋮ \\ {β}_{M , N}\end{matrix} ] = [ \begin{matrix}{Y}_{1 , 1} \\ {Y}_{1 , 2} \\ ⋮ \\ {Y}_{1 , M} \\ {Y}_{2 , 1} \\ ⋮ \\ {Y}_{N , M}\end{matrix} ] & ( 20 )\end{matrix}$$

The normal equation of Expression (20) can be solved, for example, by using the discharge method (Gauss-Jordan elimination method) or the like, with regard to the coefficient seed data β_{m, n}.

In the image conversion apparatus 51 of FIG. 7, the coefficient seed data for each class β_{m, n} obtained by performing the learning by establishing the normal equation of Expression (20) for each class while a large number of the high image quality pixels y₁, y₂, . . . , y_{K} are set as the teacher data serving as a teacher for the learning and also the low image quality pixels x_{1, k}, x_{2, k}, . . . , x_{N, k} constituting the prediction tap with regard to the respective high image quality pixels yₖ are set as the student data serving as a student for the learning is stored in the coefficient seed memory 62 of the coefficient output unit 55 (FIG. 8). In the coefficient generation unit 61, from the coefficient seed data β_{m, n} and the parameter z stored in the parameter memory 63, while following Expression (9), the tap coefficient wₙ for each class is generated. Then, in the prediction computation unit 16, by using the tap coefficient wₙ and the low image quality pixel(the pixel of the first image data) xₙ constituting the prediction tap with regard to the attention pixel serving as the high image quality pixel, Expression (1) is calculated, and (a predicted value close to) the pixel value of the attention pixel serving as the high image quality pixel is obtained.

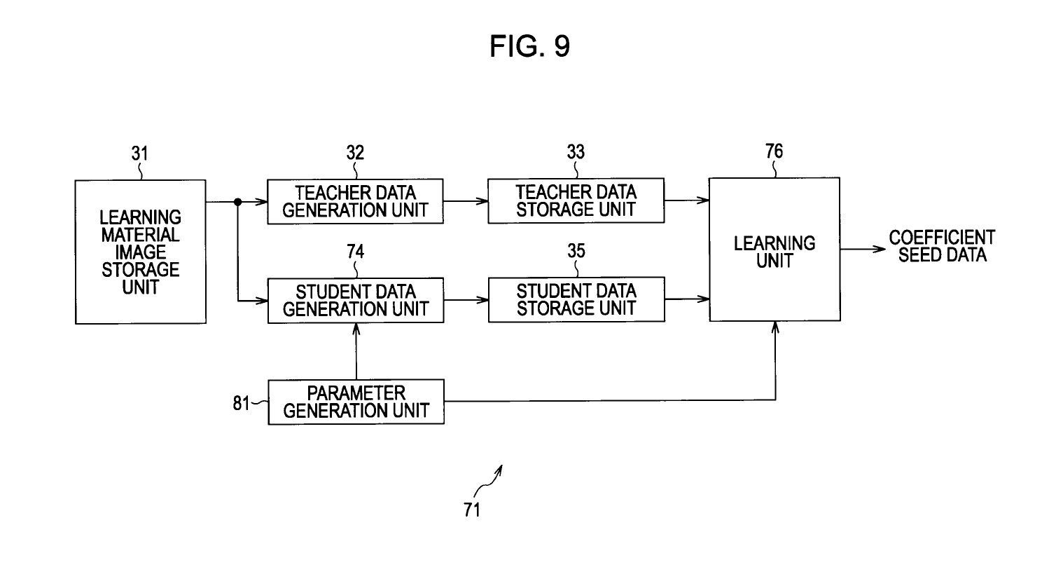

FIG. 9 shows a configuration example of a learning apparatus 71 configured to perform a leaning for obtaining the coefficient seed data for each class β_{m, n} by establishing and solving the normal equation of Expression (20) for each class.

It should be noted that in the drawing, a part corresponding to the case in the learning apparatus 21 of FIG. 3 is assigned with the same reference symbol, and hereinafter, a description thereof will be appropriately omitted. That is, the learning apparatus 71 is configured similarly as in the learning apparatus 21 of FIG. 3 except that instead of the student data generation unit 34 and the learning unit 36, a student data generation unit 74 and a learning unit 76 are respectively provided, and also a parameter generation unit 81 is newly provided.

Similarly as in the student data generation unit 34 of FIG. 3, the student data generation unit 74 generates the student data from the learning material image data to be supplied to the student data storage unit 35 and stored.

It should be however that to the student data generation unit 74, in addition to the learning material image data, some of values in a range where the parameter z supplied to the parameter memory 63 of FIG. 8 can take are supplied from the parameter generation unit 81. That is, now, when values that the parameter z can take is real numbers in a range of 0 to Z, for example, the student data generation unit 74 is the student data generation unit 74 with z=0, 1, 2, . . . , Z from the parameter generation unit 81.

The student data generation unit 74 performs a filtering on the high image quality image data serving as the learning material image data, for example, through an LPF with a cutoff frequency corresponding to the parameter z supplied thereto, so that the low image quality image data serving as the student data is generated.

Therefore, regarding the high image quality image data serving as the learning material image data, in the student data generation unit 74, Z+1 types of the low image quality image data serving as the student data with different resolutions are generated.

It should be noted that herein, for example, as the number of the parameter z increases, an LPF with a higher cutoff frequency is used for filtering the high image quality image data, and the low image quality image data serving as the student data is generated. Therefore, herein, as the low image quality image data corresponding to the parameter z with a larger value, the spatial resolution is higher.

Also, according to the present embodiment, to simplify the description, in the student data generation unit 74, the low image quality image data is generated in which the spatial resolutions in both the directions of the horizontal direction and the vertical direction of the high image quality image data are decreased by an amount corresponding to the parameter z.

The learning unit 76 uses the teacher data stored in the teacher data storage unit 33, the student data stored in the student data storage unit 35, and the parameter z supplied from the parameter generation unit 81 to obtain and output the coefficient seed data for each class.

The parameter generation unit 81 generates, for example, z=0, 1, 2, . . . , Z described above as some of values in a range where the parameter z can take to be supplied to the student data generation unit 74 and the learning unit 76.

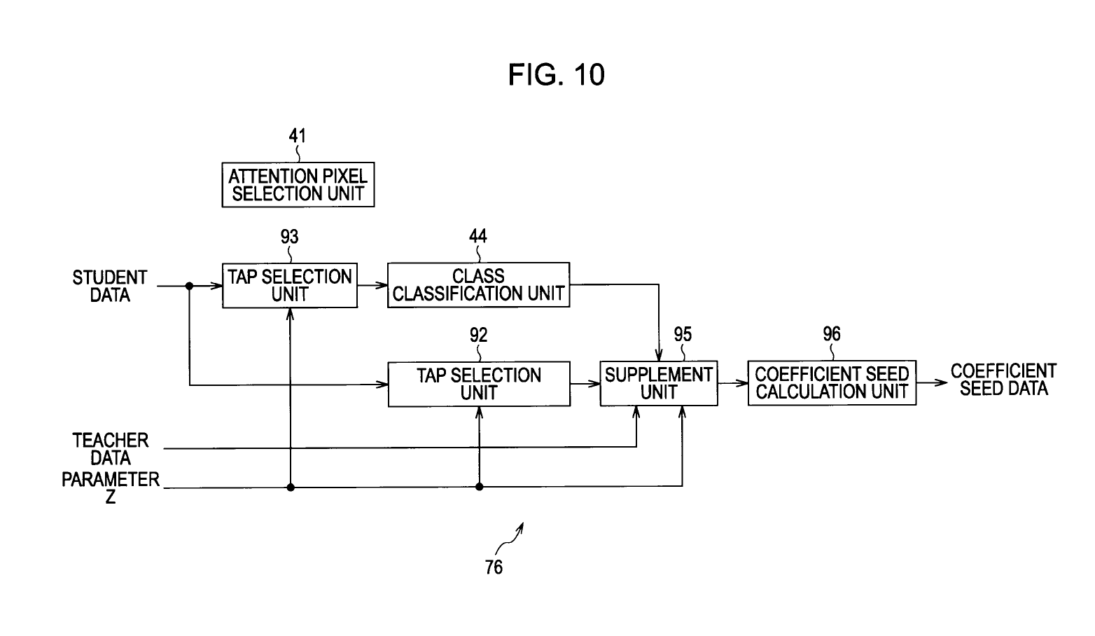

FIG. 10 shows a configuration example of the learning unit 76 of FIG. 9. It should be noted that in the drawing, a part corresponding to the case in the learning unit 36 of FIG. 4 is assigned with the same reference symbol, and hereinafter, a description thereof will be appropriately omitted.

Similarly as in the tap selection unit 42 of FIG. 4, regarding the attention pixel, a tap selection unit 92 selects a prediction tap with the same tap structure as one selected by the tap selection unit 12 of FIG. 7 from the low image quality pixel constituting the low image quality image data serving as the student data stored in the student data storage unit 35 to be supplied to a supplement unit 95.

Similarly as in the tap selection unit 43 of FIG. 4, regarding the attention pixel, the tap selection unit 93 also selects a class tap with the same tap structure as one selected by the tap selection unit 13 of FIG. 7 from the low image quality pixel constituting the low image quality image data serving as the student data stored in the student data storage unit 35 to be supplied to the class classification unit 44.

It should be however that in FIG. 10, the tap selection units 42 and 43 are supplied with the parameter z generated by the parameter generation unit 81 of FIG. 9, and the tap selection units 42 and 43 respectively select the prediction tap and the class tap from the student data generated while corresponding to the parameter z supplied from the parameter generation unit 81 (herein, the low image quality image data serving as the student data generated by using the LPF with the cutoff frequency corresponding to the parameter z).

The supplement unit 95 reads out the attention pixel from the teacher data storage unit 33 of FIG. 9 and performs the supplement while the attention pixel, the attention pixel supplied from the student data constituting the prediction tap constructed with regard to the tap selection unit 42, and the parameter z at the time of generating the student data are set as the target for each class supplied from the class classification unit 44.

That is, the supplement unit 95 is supplied with the teacher data yₖ serving as the attention pixel stored in the teacher data storage unit 33, the prediction tap x_{i, k}(x_{j, k}) with regard to the attention pixel output by the tap selection unit 42, and the class of the attention pixel output by the class classification unit 44, and also the parameter z at the time of generating the student data constituting the prediction tap with regard to the attention pixel is supplied from the parameter generation unit 81.

Then, for each class supplied from the class classification unit 44, the supplement unit 95 uses the prediction tap (student data) x_{i, k}(x_{j, k}) and the parameter z to perform a multiplication of the student data for obtaining the component X_{i, p, j, q} defined by Expression (18) in a matrix on the left side in Expression (20) and the parameter z (x_{i, k}tₚx_{j, k}t_{q}) and a computation comparable to the summation (E). It should be noted that tₚ of Expression (18) is calculated from the parameter z while following Expression (10). t_{q} of Expression (18) is also similar.

Furthermore, for each class corresponding to the class code supplied from the class classification unit 44, the supplement unit 95 all the same uses the prediction tap (student data) x_{i, k}, the teacher data yₖ, and the parameter z to perform a multiplication of the student data x_{i, k} for obtaining the component Y_{i, p} defined by Expression (19) in a vector on the right side in Expression (20), the teacher data yₖ, and the parameter z (x_{i, k}tₚyₖ) and a computation comparable to the summation (E). It should be noted that tₚ of Expression (19) is calculated from the parameter z while following Expression (10).

That is, the supplement unit 95 stores the component X_{i, p, j, q} in a matrix on the left side and the component Y_{i, p} in a vector on the right side in Expression (20) obtained regarding the teacher data set as the attention pixel in the previous time in a built-in memory thereof (not shown), and with respect to the component X_{i, p, j, q} in the matrix or the component Y_{i, p} in the vector, regarding the teacher data newly set as the attention pixel, supplements the teacher data yₖ, the student data x_{i, k}(x_{j, k}), and the corresponding component x_{i, k}tₚx_{j, k}t_{q} or x_{i, k}tₚyₖ calculated by using the parameter z (performs the addition represented by the summation in the component X_{i, p, j, q} of Expression (18) or the component Y_{i, p} of Expression (19)).

Then, the supplement unit 95 performs the above-mentioned supplement on while all the teacher data stored in the teacher data storage unit 33 as the attention pixels for the parameters z for all the values of 0, 1, . . . , Z, and thus, with regard to the respective classes, when the normal equation shown in Expression (20) is established, the normal equation is supplied to a coefficient seed calculation unit 96.

The coefficient seed calculation unit 96 obtains and outputs the respective coefficient seed data for each class β_{m, n} by solving the normal equation for each of the classes supplied from the supplement unit 95.

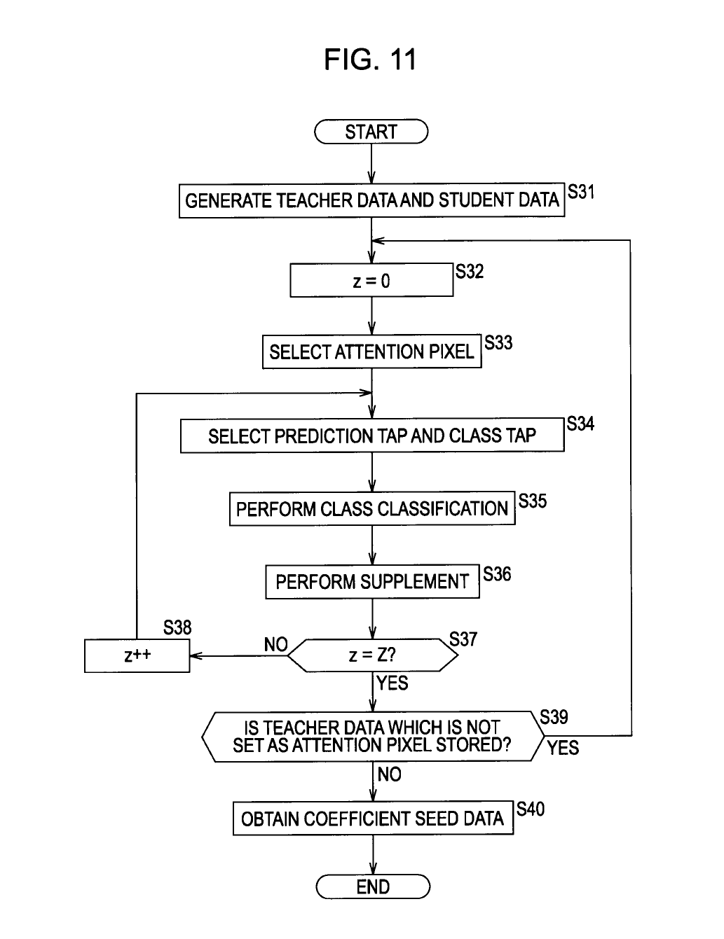

Next, with reference to a flow chart of FIG. 11, the processing (learning processing) of FIG. 9 by the learning apparatus 71 will be described.

First, in step S31, the teacher data generation unit 32 and the student data generation unit 74 respectively generate the teacher data and the student data from the learning material image data stored in the learning material image storage unit 31 to be output. That is, the teacher data generation unit 32 outputs the learning material image data, for example, as the teacher data as it is. Also, the student data generation unit 74 is provided with the parameter z with a value of Z+1 generated by the parameter generation unit 81. The student data generation unit 74 performs the filtering, for example, on the learning material image data through the LPF with the cutoff frequency corresponding to the parameter z with the value of Z+1 (0, 1, . . . , Z) from the parameter generation unit 81, so that regarding the teacher data for the respective frames (the learning material image data), the student data with the frames Z+1 is generated and output.

The teacher data output by the teacher data generation unit 32 is supplied to the teacher data storage unit 33 to be stored, and the student data output by the student data generation unit 74 is supplied to the student data storage unit 35 to be stored.

After that, in step S32, the parameter generation unit 81 sets the parameter z, for example, 0 as an initial value to be supplied to the tap selection units 42 and 43 of the learning unit 76 (FIG. 10), and the supplement unit 95. In step S33, the attention pixel selection unit 41 selects one which is not set as the attention pixel yet as the attention pixel among the teacher data stored in the teacher data storage unit 33.

In step S34, regarding the attention pixel, the tap selection unit 42 selects the prediction tap from the student data stored in the student data storage unit 35 corresponding to the parameter z output by the parameter generation unit 81 (the student data generated by filtering the learning material image data corresponding to the teacher data which becomes the attention pixel through the LPF with the cutoff frequency corresponding to the parameter z) to be supplied to the supplement unit 95. Furthermore, in step S34, regarding the attention pixel, the tap selection unit 43 all the same selects the class tap from the student data stored in the student data storage unit 35 corresponding to the parameter z output by the parameter generation unit 81 to be supplied to the class classification unit 44.

Then, in step S35, the class classification unit 44 performs the class classification of the attention pixel on the basis of the class tap regarding the attention pixel and outputs the class of the attention pixel obtained as the result to the supplement unit 95.

In step S36, the supplement unit 95 reads out the attention pixel from the teacher data storage unit 33 and uses the attention pixel, the prediction tap supplied from the tap selection unit 42, and the parameter z output by the parameter generation unit 81 to calculate the component x_{i, k}tₚx_{j, K}t_{q} in a matrix on the left side and the component x_{i, K}tₚy_{K} in a vector on the right side in Expression (20). Furthermore, the supplement unit 95 performs the supplement of the attention pixel, the prediction tap, and the component x_{i, K}tₚx_{j, K}t_{q} in the matrix and the component x_{i, K}tₚy_{K} in the vector obtained from the parameter z with respect to one corresponding to the class of the attention pixel from the class classification unit 44 among the component in the matrix and the component in the vector already obtained.

In step S37, the parameter generation unit 81 determines whether or not the parameter z output by itself is equal to Z which is a maximum value of the value that can be taken. In step S37, in a case where it is determined that the parameter z output by the parameter generation unit 81 is not equal to the maximum value Z (smaller than the maximum value Z), the processing proceeds to step S38, and the parameter generation unit 81 adds 1 to the parameter z and outputs the added value as the new parameter z to the tap selection units 42 and 43 of the learning unit 76 (FIG. 10) as well as the supplement unit 95. Then, the processing returns to step S34, and afterward the similar processing is repeatedly performed.

Also, in step S37, in a case where it is determined that the parameter z is equal to the maximum value Z, the processing proceeds to step S39, and the attention pixel selection unit 41 determines whether or not the teacher data which is not set as the attention pixel is still stored in the teacher data storage unit 33. In step S38, in a case where it is determined that the teacher data which is not set as the attention pixel is still stored in the teacher data storage unit 33, the processing returns to step S32, and afterward the similar processing is repeatedly performed.

Also, in step S39, in a case where it is determined that the teacher data which is not set as the attention pixel is not stored in the teacher data storage unit 33, the processing proceeds to step S40, and the supplement unit 95 supplies the matrix on the left side and the vector on the right side in Expression (20) for each of the classes obtained through the processing up to now to the coefficient seed calculation unit 96.

Furthermore, in step S40, by solving the normal equation for each of the classes constituted by the matrix on the left side and the vector on the right side in Expression (20) for each of the classes supplied from the supplement unit 95, the coefficient seed calculation unit 96 obtains and outputs the coefficient seed data β_{m, n} for the respective classes, and the processing is ended.

It should be noted that due to a state or the like where the number of the learning material image data is not sufficient, a class may be generated with which the number of the normal equations necessary for obtaining the coefficient seed data cannot be obtained. However, as to such a class, the coefficient seed calculation unit 96 is configured to output, for example, default coefficient seed data.

Incidentally, in the learning apparatus 71 of FIG. 9, the learning is performed for directly obtaining the coefficient seed data β_{m, n} for minimizing a total sum for square errors of the predicted value y of the teacher data predicted from the tap coefficient wₙ and the student data xₙ through the linear primary expression of Expression (1) while the high image quality image data serving as the learning material image data is set as the teacher data and also the low image quality image data in which the spatial resolution of the high image quality image data is degraded while corresponding to the parameter z is set as the student data. However, other than that, the learning on the coefficient seed data β_{m, n} can be performed in the following manner, for example.

That is, while the high image quality image data serving as the learning material image data is set as the teacher data and also the low image quality image data in which the high image quality image data is subjected to the filtering by the LPF with the cutoff frequency corresponding to the parameter z to decrease the horizontal resolution and the vertical resolution is set as the student data, first, the learning apparatus 71 obtains the tap coefficient wₙ for minimizing the total sum for the square errors of the predicted value y of the teacher data predicted through the linear first-order prediction expression of Expression (1) by using the tap coefficient wₙ and the student data xₙ for each value of the parameter z (herein, z=0, 1, . . . , Z). Then, the learning apparatus 71 obtains the coefficient seed data β_{m, n} for minimizing the total sum for the square errors of the predicted value of the tap coefficient wₙ serving as the teacher data predicted from the variable tₘ corresponding to the coefficient seed data β_{m, n} and the parameter z which is the student data through Expression (11) while the tap coefficient wₙ obtained for each value of the parameter z is set as the teacher data and also the parameter z is set as the student data.

Herein, the tap coefficient wₙ for minimizing (diminishing) the total sum E for the square errors of the predicted value y of the teacher data predicted by the linear first-order prediction expression of Expression (1) can be obtained with regard to the respective classes for each of the values of the parameter z(z=0, 1, . . . , Z), similarly as in the case in the learning apparatus 21 of FIG. 3, by establishing and solving the normal equation of Expression (8).

Incidentally, the tap coefficient is obtained from the coefficient seed data β_{m, n} and the variable tₘ corresponding to the parameter z as shown in Expression (11). Then, now, if this tap coefficient obtained through Expression (11) is denoted by wₙ′, the coefficient seed data β_{m, n} for setting an error eₙ as 0 which is represented by the following Expression (21) between the optimal tap coefficient wₙ and the tap coefficient wₙ′ obtained through Expression (11) becomes the optimal coefficient seed data for obtaining the optimal tap coefficient wₙ, but with regard to all the tap coefficients wₙ, it is generally difficult to obtain such coefficient seed data β_{m, n}.

[Expression 21]

eₙ=wₙ−wₙ′ (21)

It should be noted that Expression (21) can be transformed into the following expression by Expression (11).

$$\begin{matrix}[ Expression 22 ] & \\ {e}_{n} = {w}_{n} - ( {\sum }_{m = 1}^{M} {β}_{m , n} {t}_{m} ) & ( 22 )\end{matrix}$$

In view of the above, all the same, if the method of least squares is adopted as a rule representing that the coefficient seed data β_{m, n} is optimal, for example, the optimal coefficient seed data β_{m, n} can be obtained by minimizing the total sum E for the square errors represented by the following expression.

$$\begin{matrix}[ Expression 23 ] & \\ E = {\sum }_{n = 1}^{N} {e}_{n}^{2} & ( 23 )\end{matrix}$$

The minimum value (local minimal value) of the total sum E for the square errors of Expression (23) is given, as shown in Expression (24), by β_{m, n} with which the total sum E subjected to the partial differentiation by the coefficient seed data is set as 0.

$$\begin{matrix}[ Expression 24 ] & \\ \frac{\partial E}{\partial {β}_{m , n}} = {\sum }_{m = 1}^{M} 2 \frac{\partial {e}_{n}}{\partial {β}_{m , n}} \cdot {e}_{n} = 0 & ( 24 )\end{matrix}$$

Expression (22) is assigned to Expression (24), so that the following expression is obtained.

$$\begin{matrix}[ Expression 25 ] & \\ {\sum }_{m = 1}^{M} {t}_{m} ( {w}_{n} - ( {\sum }_{m = 1}^{M} {β}_{m , n} {t}_{m} ) ) = 0 & ( 25 )\end{matrix}$$

Now, X_{i, j}, and Yᵢ are defined as shown in Expressions (26) and (27).

$$\begin{matrix}[ Expression 26 ] & \\ {X}_{i , j} = {\sum }_{z = 0}^{Z} {t}_{i} {t}_{j} ( i = 1 , 2 , … , M \text{:} j = 1 , 2 , … , M ) & ( 26 ) \\ [ Expression 27 ] & \\ {Y}_{i} = {\sum }_{z = 0}^{Z} {t}_{i} {w}_{n} & ( 27 )\end{matrix}$$

In this case, Expression (25) can be represented by the normal equation shown in Expression (28) using X_{i, j} and Yᵢ.

$$\begin{matrix}[ Expression 28 ] & \\ [ \begin{matrix}{X}_{1 , 1} & {X}_{1 , 2} & ⋯ & {X}_{1 , M} \\ {X}_{2 , 1} & {X}_{2 , 1} & ⋯ & {X}_{2 , 2} \\ ⋮ & ⋮ & ⋱ & ⋮ \\ {X}_{M , 1} & {X}_{M , 2} & ⋯ & {X}_{M , M}\end{matrix} ] [ \begin{matrix}{β}_{1 , n} \\ {β}_{2 , n} \\ ⋮ \\ {β}_{M , n}\end{matrix} ] = [ \begin{matrix}{Y}_{1} \\ {Y}_{2} \\ ⋮ \\ {Y}_{M}\end{matrix} ] & ( 28 )\end{matrix}$$

The normal equation of Expression (28) can also solve the coefficient seed data β_{m, n}, for example, by using the discharge method (Gauss-Jordan elimination method) or the like.

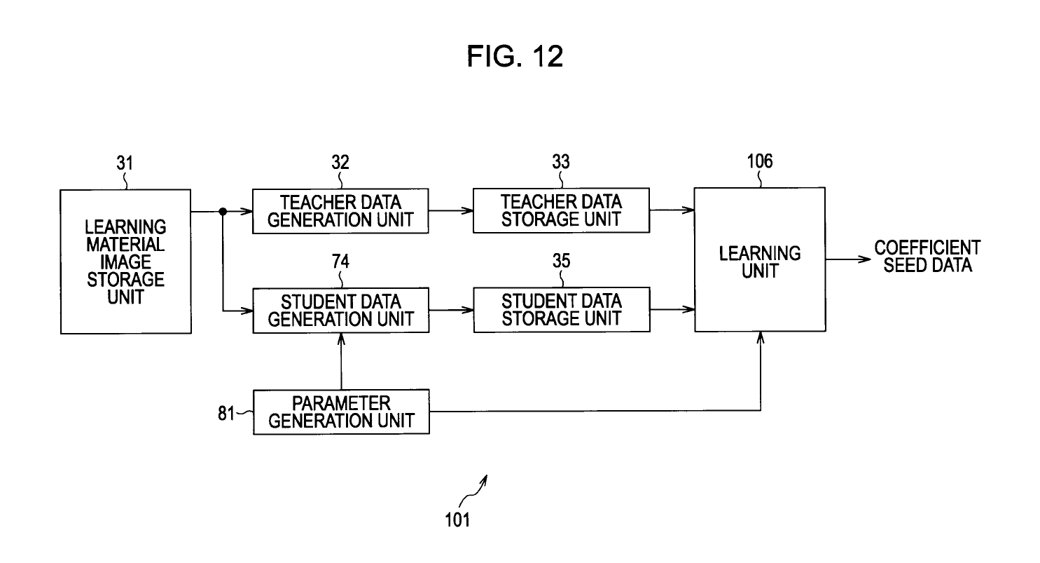

FIG. 12 shows a configuration example of a learning apparatus 101 configured to perform learning by establishing and solving the normal equation of Expression (28) to obtain the coefficient seed data β_{m, n}.

It should be noted that in the drawing, a part corresponding to the case in the learning apparatus 21 of FIG. 3 or the learning apparatus 71 of FIG. 9 is assigned with the same reference symbol, and hereinafter, a description thereof will be appropriately omitted. That is, the learning apparatus 101 is configured similarly as in the learning apparatus 71 of FIG. 9 except that a learning unit 106 is provided instead of the learning unit 76.

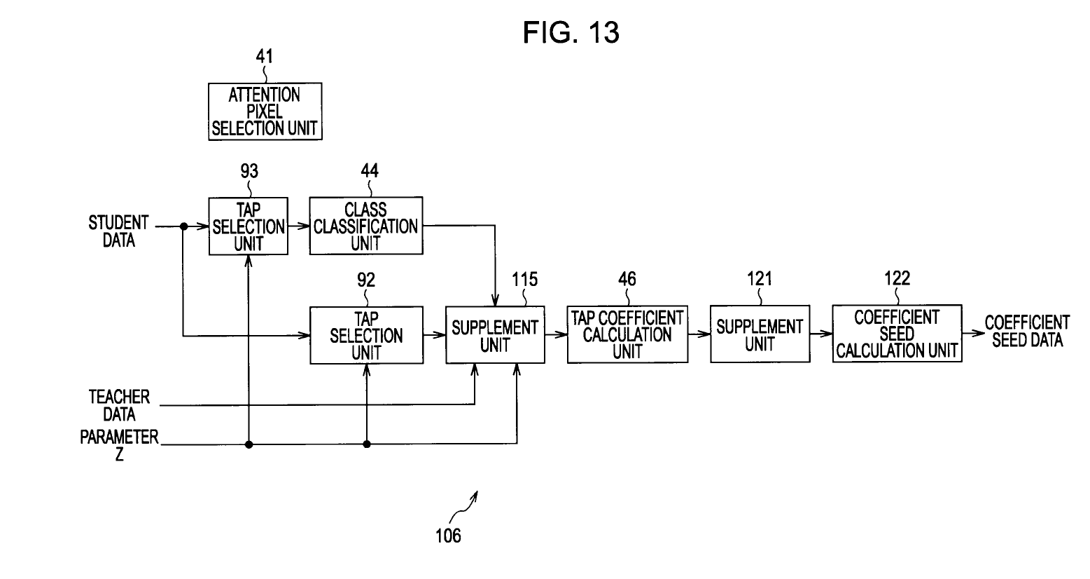

FIG. 13 shows a configuration example of the learning unit 106 of FIG. 12. It should be noted that in the drawing, a part corresponding to the case in the learning unit 36 of FIG. 4 or the learning unit 76 of FIG. 10 is assigned with the same reference symbol, and hereinafter, a description thereof will be appropriately omitted.

A supplement unit 115 is provided with the class of the attention pixel output by the class classification unit 44 and the parameter z output by the parameter generation unit 81. Then, the supplement unit 115 reads out the attention pixel from the teacher data storage unit 33 and performs the supplement while the attention pixel and the student data constituting the prediction tap regarding the attention pixel supplied from the tap selection unit 42 are set as the targets for each class supplied from the class classification unit 44 and also for each value of the parameters z output by the parameter generation unit 81.

That is, the supplement unit 115 is supplied with stored in the teacher data yₖ the teacher data storage unit (FIG. 12), the prediction tap x_{n, k} output by the tap selection unit 42, the class output by the class classification unit 44, and the parameter z at the time of generating output by the parameter generation unit 81 (FIG. 12) the student data constituting the prediction tap x_{n, k}.

Then, for each class supplied from the class classification unit 44, and also for each value of the parameters z output by the parameter generation unit 81, the supplement unit 115 uses the prediction tap (student data) x_{n, k} to perform a multiplication of mutual student data in a matrix on the left side in Expression (8) (x_{n, k}x_{n′, k}) and a computation comparable to the summation (Σ).

Furthermore, for each class supplied from the class classification unit 44 and also for each value of the parameters z output by the parameter generation unit 81, the supplement unit 115 all the same uses the prediction tap (student data) x_{n, k} and the teacher data yₖ to perform the multiplication (x_{n, k}yₖ) of the student data x_{n, k} and the teacher data yₖ in the vector on the right side in Expression (8) and a computation comparable to the summation (Σ).

That is, the supplement unit 115 stores the component (Σx_{n, k}x_{n′, k}) in a matrix on the left side and the component (Σx_{n, k}yₖ) in a vector on the right side in Expression (8) obtained regarding the teacher data set as the attention pixel in the previous time in a built-in memory thereof (not shown) and performs the supplement of the corresponding component x_{n, k+1}x_{n′, k+1} or x_{n, k+1}yₖ₊₁ calculated by using the teacher data yₖ₊₁ and the student data x_{n, k+1} regarding the teacher data newly set as the attention pixel with respect to the component (Σx_{n, k}x_{n′, k}) in the matrix or the component (Σx_{n, k}yₖ) in the vector (performs the addition represented by the summation in Expression (8)).

Then, by performing the above-mentioned supplement while all the teacher data stored in the teacher data storage unit 33 is set as the attention pixel, with regard to the respective classes, for each value of the parameters z, when the normal equation shown in Expression (8) is established, the supplement unit 115 supplies the normal equation to the tap coefficient calculation unit 46.

Therefore, similarly as in the supplement unit 45 of FIG. 4, with regard to the respective classes, the supplement unit 115 establishes the normal equation of Expression (8). It should be however that the supplement unit 115 is different from the supplement unit 45 of FIG. 4 in a point that the normal equation of Expression (8) is further established for each value of the parameters z too.

By solving the normal equation supplied from the supplement unit 115 for each value of the parameters z with regard to the respective classes, the tap coefficient calculation unit 46 obtains the optimal tap coefficient wₙ for each value of the parameters z with regard to the respective classes to be supplied to a supplement unit 121.

The supplement unit 121 performs the supplement while (the variable tₘ corresponding to) the parameter z supplied from the parameter generation unit 81 (FIG. 12) and the optimal tap coefficient wₙ supplied from the tap coefficient calculation unit 46 are set as the targets for each of the classes.

That is, the supplement unit 121 uses the variable tᵢ(tⱼ) obtained from the parameter z supplied from the parameter generation unit 81 (FIG. 12) through Expression (10) to perform a multiplication of mutual the variable tᵢ(tⱼ) corresponding to the parameter z for obtaining the component X_{i, j} defined by Expression (26) in a matrix on the left side in Expression (28) (tᵢtⱼ) and a computation comparable to the summation (Σ) for each class.

Herein, as the component X_{i, j} is decided by only the parameter z and is not relevant to the class, the calculation for the component X_{i, j} is completed by only once in actuality without a necessity to be performed for each class.

Furthermore, the supplement unit 121 uses the variable tᵢ obtained from the parameter z supplied from the parameter generation unit 81 through Expression (10) and the optimal tap coefficient wₙ supplied from the tap coefficient calculation unit 46 to perform the multiplication (tᵢwₙ) of the variable tᵢ corresponding to the parameter z for obtaining the component Yᵢ defined by Expression (27) in the vector on the right side of Expression (28) and the optimal tap coefficient wₙ and a computation comparable to the summation (Σ) for each class.

For the respective classes, by obtaining the component X_{i, j} represented by Expression (26) and the component Yᵢ represented by Expression (27), with regard to the respective classes, when the normal equation of Expression (28) is established, the supplement unit 121 supplies the normal equation to a coefficient seed calculation unit 122.

By solving the normal equation of Expression (28) for each class supplied from the supplement unit 121, the coefficient seed calculation unit 122 obtains and outputs the respective coefficient seed data for each of the classes β_{m, n}.

The coefficient seed memory 62 in the coefficient output unit 55 of FIG. 8 can also store the coefficient seed data for each class β_{m, n} obtained as described above.

It should be noted that in the learning on the coefficient seed data too, similarly as in the case of the learning on the tap coefficient described in FIG. 5, depending on a manner of selecting the image data serving as the student data corresponding to the first image data and the teacher data corresponding to the second image data, for the coefficient seed data, one for performing the various image conversion processings can be obtained.

That is, in the above-mentioned case, the learning on the coefficient seed data is performed in which the learning material image data is set as the teacher data corresponding to the second image data as it is and also the low image quality image data in which the spatial resolution of the learning material image data is degraded is set as the student data corresponding to the first image data, and thus one for performing the image conversion processing serving as the spatial resolution creation processing for converting the first image data into the second image data in which the spatial resolution is improved can be obtained as the coefficient seed data.

In this case, in the image conversion apparatus 51 of FIG. 7, the horizontal resolution and the vertical resolution of the image data can be improved to the resolution corresponding to the parameter z.

Also, for example, by performing the learning on the coefficient seed data while the high image quality image data is set as the teacher data and also with respect to the high image quality image data serving as the teacher data and the image data on which the noise at a level corresponding to the parameter z is overlapped is set as the student data, one for performing the image conversion processing serving as the noise removal processing for converting the first image data into the second image data in which the noise therein is removed (reduced) can be obtained as the coefficient seed data. In this case, in the image conversion apparatus 51 of FIG. 7, it is possible to obtain the image data with the S/N corresponding to the parameter z.

Also, for example, by performing the learning on the coefficient seed data while certain image data is set as the teacher data and also the image data in which the pixel number of the image data serving as the teacher data is thinned out while corresponding to the parameter z is set as the student data or the image data with a predetermined size is set as the student data and also the image data in which the pixel of the image data serving as the student data is thinned out at a thinning out date corresponding to the parameter z is set as the teacher data, one for performing the image conversion processing serving as the resize processing for converting the first image data into the second image data in which the size is expanded or reduced can be obtained as the coefficient seed data. In this case, in the image conversion apparatus 51 of FIG. 7, it is possible to obtain the image data expanded or reduced to the size corresponding to the parameter z.

It should be noted that in the above-mentioned case, as shown in Expression (9), the tap coefficient wₙ is defined by β_{1, n}z⁰+β_{2, n}z¹+ . . . +β_{M, n}z^{M-1}, and with this Expression (9), the tap coefficient wₙ for improving the spatial resolutions in the horizontal and vertical directions while both corresponding to the parameter z is obtained. However, as the tap coefficient wₙ, it is also possible to obtain one for independently improving the horizontal resolution and the vertical resolution while corresponding to the independent parameters zₓ and z_{y}.

That is, instead of Expression (9), for example, the tap coefficient wₙ is defined by the third-order expression β_{1, n}zₓ⁰z_{y}⁰+β_{2, n}zₓ¹z_{y}⁰+β_{3, n}zₓ²z_{y}⁰+β_{4, n}zₓ³z_{y}⁰+β_{5, n}zₓ⁰z_{y}¹+β_{6, n}zₓ⁰z_{y}²+β_{7, n}zₓ⁰z_{y}³+β_{8, n}zₓ¹z_{y}¹+β_{9, n}zₓ²z_{y}¹+β_{10, n}zₓ¹z_{y}², and also the variable tₘ defined by Expression (10) is defined by, for example, t₁=zₓ⁰z_{y}⁰, t₂=zₓ¹z_{y}⁰, t₃=zₓ²z_{y}⁰, t₄=zₓ³z_{y}⁰, t₅=zₓ⁰z_{y}¹, t₆=zₓ⁰z_{y}², t₇=zₓ⁰z_{y}³, t₈=zₓ¹z_{y}¹, t₉=zₓ²z_{y}¹, t₁₀=zₓ¹z_{y}² instead of Expression (10). In this case too, the tap coefficient wₙ can be eventually represented by Expression (11), and therefore, in the learning apparatus 71 of FIG. 9 or the learning apparatus 101 of FIG. 12, the learning is performed by the image data as the student data in which the horizontal resolution and the vertical resolution of the teacher data are respectively degraded while corresponding to the parameter zₓ and z_{y} to obtain the coefficient seed data β_{m, n}, so that it is possible to obtain the tap coefficient wₙ for independently improving the horizontal resolution and the vertical resolution respectively while corresponding to the independent parameters zₓ and z_{y}.

Other than that, for example, in addition to the parameter zₓ and z_{y} respectively corresponding to the horizontal resolution and the vertical resolution, further, by introducing a parameter zₜ corresponding to a resolution in the time direction, it is possible to obtain the tap coefficient wₙ for independently improving the horizontal resolution, the vertical resolution, and the time resolution respectively while corresponding to the independent parameters zₓ, z_{y}, and zₜ.

Also, regarding the resize processing too, similarly to the case of the spatial resolution creation processing, in addition to the tap coefficient wₙ for resizing the horizontal and vertical directions at an expansion rate (or a reduction rate) both corresponding to the parameter z, it is possible to obtain the tap coefficient wₙ for independently resizing the horizontal and vertical directions at expansion rates respectively corresponding to the parameters zₓ and z_{y}.

Furthermore, in the learning apparatus 71 of FIG. 9 or the learning apparatus 101 of FIG. 12, as the coefficient seed data β_{m, n} is obtained by performing the learning by using the image data as the student data in which the horizontal resolution and the vertical resolution of the teacher data are degraded while corresponding to the parameter zₓ and also noise is added to the teacher data while corresponding to the parameter z_{y}, it is possible to obtain the tap coefficient wₙ for improving the horizontal resolution and the vertical resolution while corresponding to the parameter zₓ and also performing the noise removal while corresponding to the parameter z_{y}.

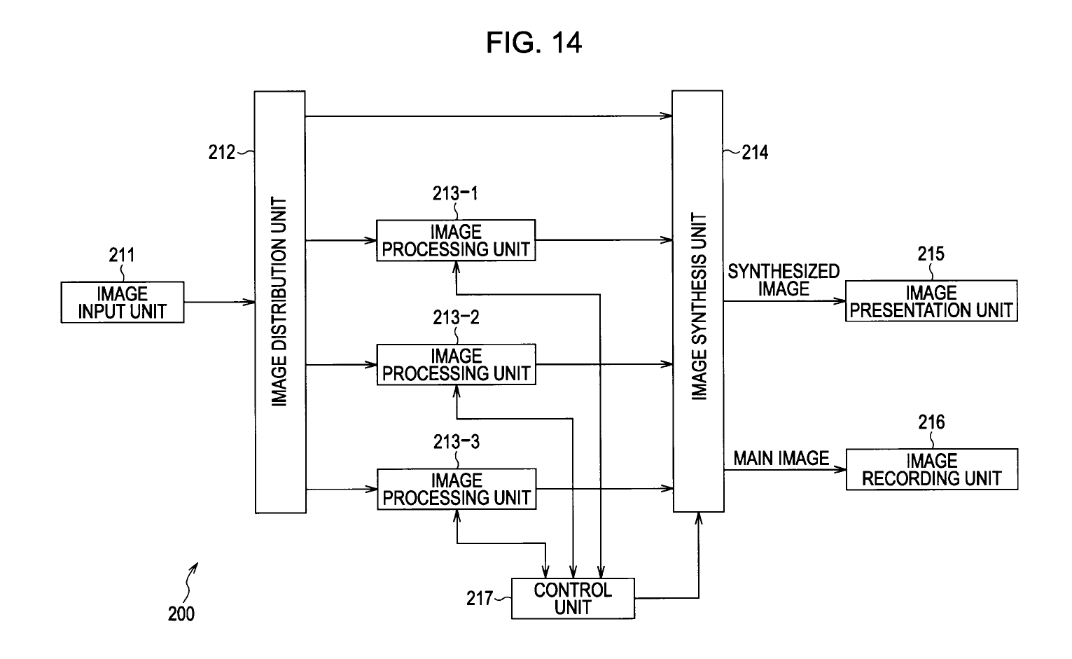

An embodiment of the image processing apparatus which is an image processing apparatus provided with a processing unit for performing the above-mentioned class classification adaptive processing to which the present invention is applied will be described below. In other words, the image processing apparatus (image processing system) which will be described below is an apparatus provided with the above-mentioned image conversion apparatus as an image processing unit (image processing units 213-1 to 213-3 of FIG. 14).

FIG. 14 shows a configuration example of an embodiment of the image processing apparatus to which the present invention is applied.

An image processing apparatus 200 of FIG. 14 is composed of an image input unit 211, an image distribution unit 212, the image processing units 213-1 to 213-3, an image synthesis unit 214, an image presentation unit 215, an image recording unit 216, and a control unit 217.

To the image processing apparatus 200, a moving image is input. A plurality of images constituting the image are sequentially obtained by the image input unit 211 and supplied to the image distribution unit 212 as the input images.

The image distribution unit 212 supplies the input image supplied from the image input unit 211 to the image processing units 213-1 to 213-3 and the image synthesis unit 214.

Under a control by the control unit 217, the respective image processing units 213-1 to 213-3 execute a predetermined image processing on the input image supplied from the image distribution unit 212 at the same time (in parallel) and supply processed images which are the images after the processing to the image synthesis unit 214. Herein, the image processing performed by the image processing units 213-1 to 213-3 is, for example, a high image quality realization processing for setting an image quality into a high image quality, an expansion processing for expanding a predetermined area of the image, or the like. Also, those image processing units 213-1 to 213-3 execute mutually different processings, in which, for example, degrees of the image quality are different or the areas on which the expansion processing is performed are different. For the image processings performed by these image processing units 213-1 to 213-3, it is possible to utilize the above-mentioned class classification adaptive processing.

The image synthesis unit 214 is supplied with the input image from the image distribution unit 212 and also supplied with the processed images respectively from the image processing units 213-1 to 213-3.

Under a control by the control unit 217, the image synthesis unit 214 uses the input image and the three types of the processed images to generate a synthesized image to be supplied to the image presentation unit 215. Also, the image synthesis unit 214 supplies a main image which is an image functioning as a principal among a plurality of images used for the synthesized image to the image recording unit 216.

By displaying the synthesis image supplied from the image synthesis unit 214 on a predetermined display unit, the image presentation unit 215 presents the synthesis image to the user. The image recording unit 216 records the main image supplied from the image synthesis unit 214 on a predetermined recording medium.

The control unit 217 obtains operation information which is information where the user operates a remote commander not shown in the drawing or the like and supplies control information corresponding to the operation to the image processing units 213-1 to 213-3 and the image synthesis unit 214.

In FIG. 14, an example in which the image processing apparatus 200 is provided with the three image processing units 213-1 to 213-3, but the number of the image processing unit 213 provided to the image processing apparatus 200 may be two or 4 or more.

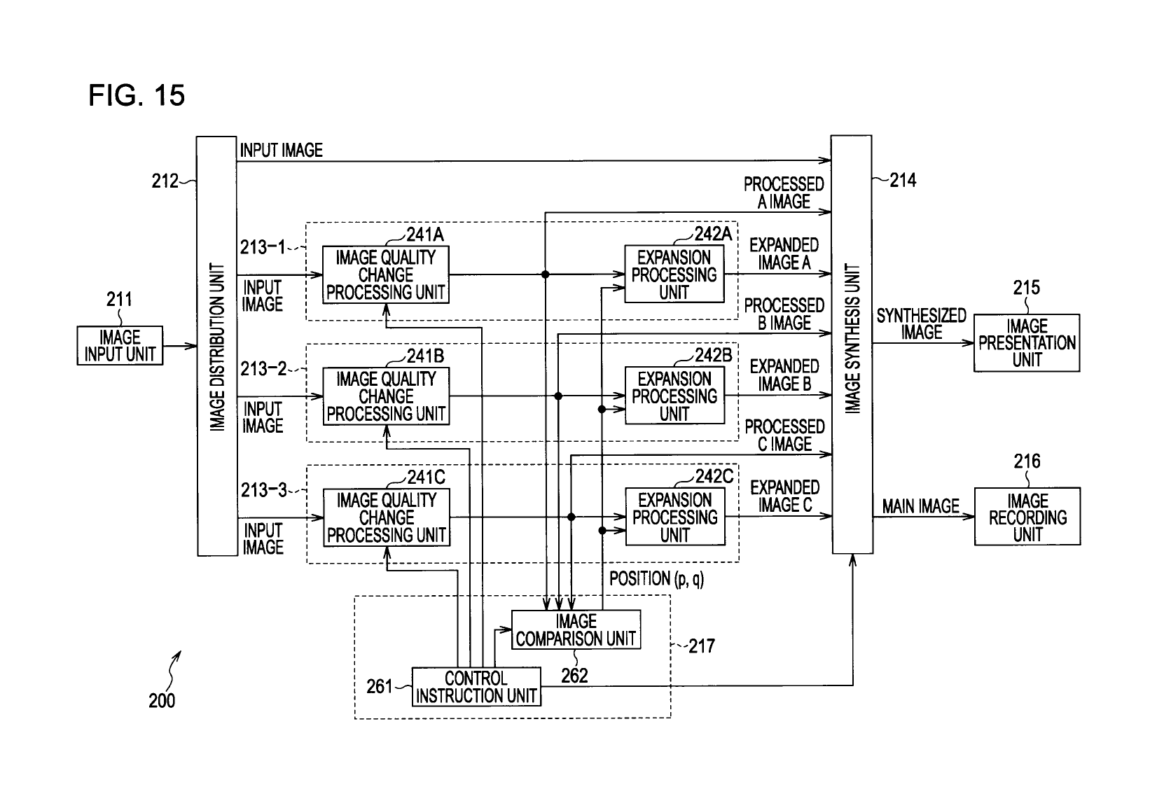

FIG. 15 is a block diagram showing a first configuration example (hereinafter, which is referred to as first embodiment) which is a detailed configuration example of the image processing apparatus 200.

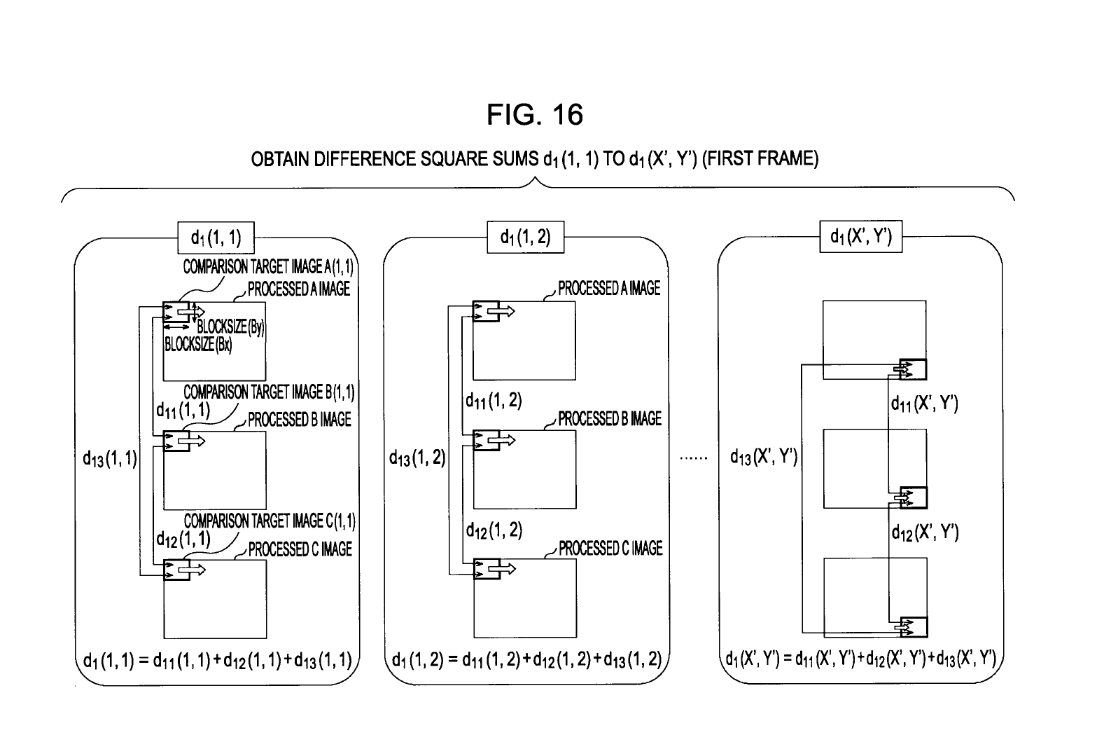

In FIG. 15, the same reference numeral is assigned to a part corresponding to FIG. 14, and a description thereof is appropriately omitted. The same applies to drawings of FIG. 16 afterwards described below.

The image processing unit 213-1 is composed of an image quality change processing unit 241A and an expansion processing unit 242A, and the image processing unit 213-2 is composed of an image quality change processing unit 241B and the expansion processing unit 242B. Also, the image processing unit 213-3 is composed of an image quality change processing unit 241C and an expansion processing unit 242C.

Also, the control unit 217 is composed of a control instruction unit 261 and an image comparison unit 262.

The image quality change processing units 241A to 241C apply different image parameters to generate and output images different in the image quality. For example, the image quality change processing units 241A to 241C generate the images different in the image quality such that the levels (degrees) of the image quality are higher in the order of the image quality change processing units 241A, 241B, and 241C. The levels of the image quality are decided by the control information supplied from the control instruction unit 261.

The image quality change processing units 241A to 241C can respectively execute, for example, the above-mentioned class classification adaptive processing, and as the image parameters in this case, the parameter z for specifying the resolution and the noise removal degree, for example, and the coefficient seed data can be set. Also, a general image processing other than the class classification adaptive processing may be adopted, and parameters for changing a hue, a luminance, a γ value γ, and the like can also be set.

The image quality change processing unit 241A supplies the image after the image quality change processing (hereinafter, which is referred to as processing A image) to the image comparison unit 262, the expansion processing unit 242A, and the image synthesis unit 214. The image quality change processing unit 241B supplies the image after the image quality change processing (hereinafter, which is referred to as the processing B image) to the image comparison unit 262, the expansion processing unit 242B, and the image synthesis unit 214. The image quality change processing unit 241C supplies the image after the image quality change processing (hereinafter, which is referred to as the processing C image) to the image comparison unit 262, the expansion processing unit 242C, and the image synthesis unit 214.

The expansion processing units 242A to 242C respectively execute an expansion processing based on a position (p, q) supplied from the image comparison unit 262. That is, the expansion processing units 242A to 242C generate expanded images where a predetermined area is expanded while the position (p, q) is set as the center to be supplied to the image synthesis unit 214. Herein, an area size indicating how much of the area is expanded with respect to the position (p, q) is previously specified by the user on a setting screen or the like and decided. It should be noted that in a case where the area size decided by the user specification is not matched with the size of the respective areas of a display screen 270 which will be described below with reference to FIG. 20, in the expansion processing units 242A to 242C, a processing of further adjusting the area decided by the user specification into the size of the respective areas of the display screen 270.

As a system of the expansion processing executed by the expansion processing units 242A to 242C, in addition to the above-mentioned class classification adaptive processing, a linear interpolation system, a bi-linear system, or the like can be adopted.

The control instruction unit 261 supplies control information for controlling the processing contents to the image quality change processing units 241A to 241C, the expansion processing units 242A to 242C, and the image synthesis unit 214 on the basis of the operation information indicating the contents operated by the user. For example, as described above, the control instruction unit 261 supplies the parameter for deciding the levels of the image quality to the image quality change processing units 241A to 241C as the control information and supplies the parameter for deciding the area size where the expansion processing is performed to the expansion processing units 242A to 242C as the control information.

The image comparison unit 262 performs a mutual comparison computation on the processed images respectively supplied from the image quality change processing units 241A to 241C to detect the position (pixel) (p, q) where the image quality is most different among the processing A image, the processing B image, and the processing C image respectively output by the image quality change processing units 241A to 241C to be supplied to the expansion processing units 242A to 242C.

With reference to FIGS. 16 to 18, a detail of the image comparison processing by the image comparison unit 262 will be described.

The image comparison unit 262 is supplied from the control instruction unit 261 with BLOCKSIZE (B_{y}, B_{y}) which is the comparison area size and a processing frame number F_{N} as control information. Also, the image comparison unit 262 is supplied from the image quality change processing units 241A to 241C with the processing A image to the processing C image. Herein, the processing A image to the processing C image are images where a corner on the upper left of the image is set as an origin and which are composed of X pixels in the horizontal direction and Y pixels in the vertical direction.

First, as shown in FIG. 16, the image comparison unit 262 sets the pixel (1, 1) as the reference position and decides the images of the processing A image to the processing C image identified by BLOCKSIZE (B_{y}, B_{y}) as a comparison target images A (1, 1) to C (1, 1) which are comparison target images. The pixel (1, 1) of the reference position is at the upper left of the area of BLOCKSIZE (Bₓ, B_{y}).

Then, the image comparison unit 262 executes the following processing on the processing A image to the processing C image at a predetermined frame supplied from the image quality change processing units 241A to 241C (for example, at the first frame). That is, the image comparison unit 262 calculates a difference square sum d₁₁(1, 1) of luminance values (pixel values) of mutual pixels at the same position between the comparison target image A (1, 1) and a comparison target image B (1, 1). Also similarly, the image comparison unit 262 calculates a difference square sum d₁₂(1, 1) of luminance values of mutual pixels at the same position between the comparison target image B (1, 1) and a comparison target image C (1, 1) and calculates a difference square sum d₁₃(1, 1) of mutual pixels at the same position between the comparison target image A (1, 1) and the comparison target image C (1, 1).

Next, the image comparison unit 262 obtains a total of the calculated difference square sum d₁₁(1, 1), the difference square sum d₁₂(1, 1), and the difference square sum d₁₃(1, 1) to be set as a difference square sum d₁(1, 1). That is, the image comparison unit 262 calculates d₁(1, 1)=d₁₁(1, 1)+d₁₂(1, 1)+d₁₃(1, 1).

The image comparison unit 262 executes the above-mentioned processing while the position (1, 2) to (X′, Y′) of the processing A image to the processing C image are set as the reference position. Herein, X′=X−Bₓ+1 and Y′=Y−B_{y}+1 are established. That is, the image comparison unit 262 obtains the difference square sums d₁(1, 1) to d₁(X′, Y′) regarding all the reference positions (1, 1) to (X′, Y′) with which the processing A image to the processing C image can be set without a protrusion with respect to the input image at the first frame.

Furthermore, the image comparison unit 262 repeatedly performs the processing for obtaining the difference square sums d₁(1, 1) to d₁(X′, Y′) on the input image of the processing frame number F_{N} supplied from the control instruction unit 261.

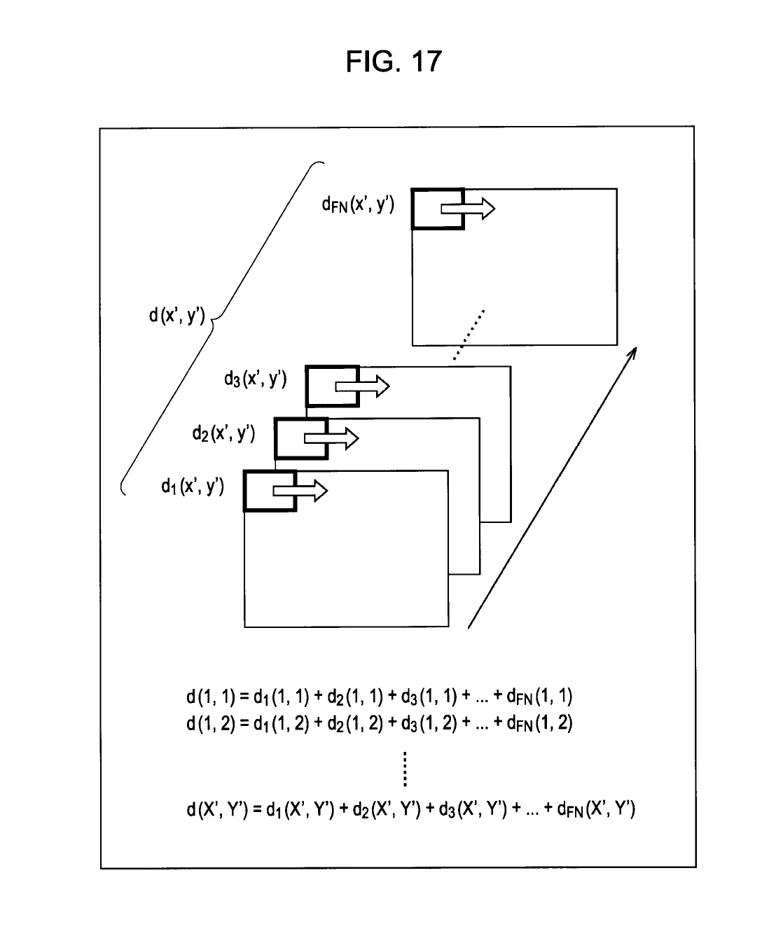

As a result, as shown in FIG. 17, d₁(x′, y′) to d_{FN}(x′, y′) are obtained with respect to the pixels in the processing A image to the processing C image (x′, y′)(x′=1, 2, . . . , X′, y′=1, 2, . . . , Y′).

Then, the image comparison unit 262 calculates the total sum of the difference square sums d(x′, y′)=Σdₖ(x′, y′) with regard to all x′=1, 2, . . . , X′ and y′=1, 2, . . . , Y′ and obtains and decides the position (p, q) where the total sum d(p, q) is largest among the total sums d(1, 1) to d(X′, Y′) which are the calculation results. Therefore, (p, q) is one of (1, 1) to (X′, Y′). It should be noted that Σ denotes a sum from a time when k=1 is set until k=F_{N} is set.

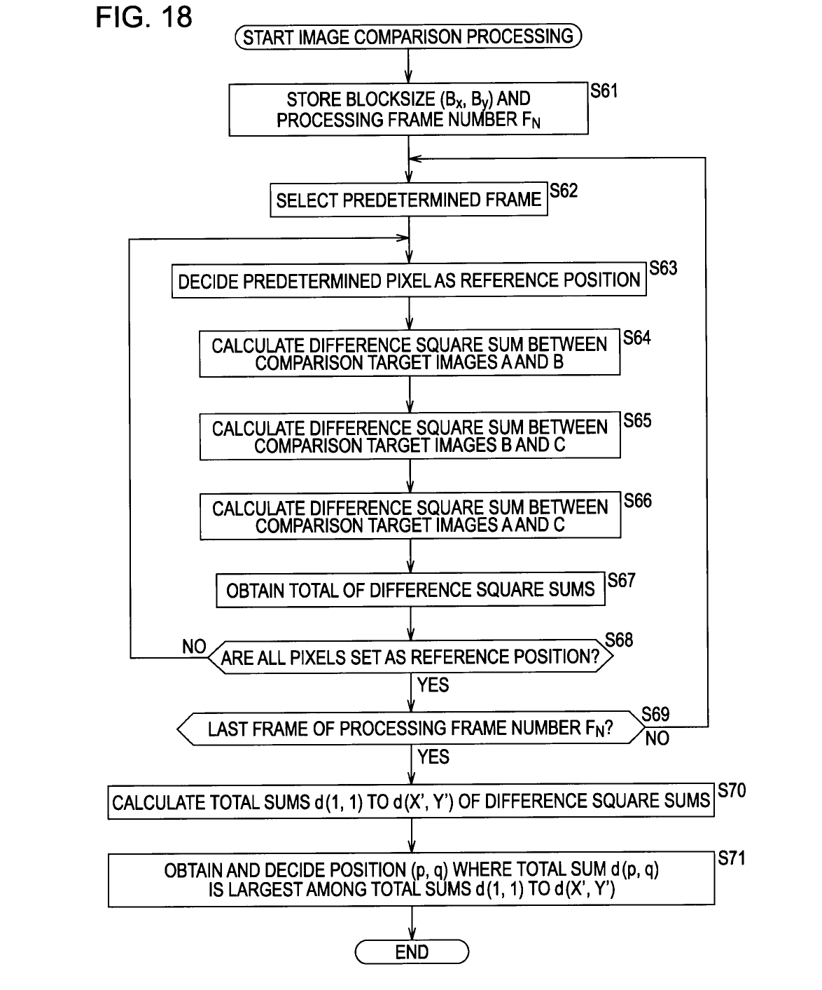

With reference to a flow chart of FIG. 18, the image comparison processing by the image comparison unit 262 will be further described.

First, in step S61, the image comparison unit 262 stores BLOCKSIZE (Bₓ, B_{y}) supplied from the control instruction unit 261 and the processing frame number F_{N} therein.

In step S62, the image comparison unit 262 selects the processing A image to the processing C image at a predetermined frame. For example, the processing A image to the processing C image on which the image quality change processing is performed on the input image at the first frame are selected.

In step S63, the image comparison unit 262 decides a predetermined pixel of the processing A image to the processing C image as the reference position. For example, the image comparison unit 262 decides the position (1, 1) as the reference position. According to this, the comparison target images A (1, 1) to C (1, 1) are decided.

In step S64, the image comparison unit 262 calculates the difference square sum of the luminance values of the mutual pixels at the same position between the comparison target image A and the comparison target image B. For example, in the comparison target images A (1, 1) to C (1, 1) regarding the reference position (1, 1), the image comparison unit 262 calculates the difference square sum d₁₁(1, 1) of the luminance values of the mutual pixels at the same position between the comparison target image A (1, 1) and the comparison target image B (1, 1).

In step S65, the image comparison unit 262 calculates the difference square sum of the luminance values of the mutual pixels at the same position between the comparison target image B and the comparison target image C. For example, in the comparison target images A (1, 1) to C (1, 1) regarding the reference position (1, 1), the image comparison unit 262 calculates the difference square sum d₁₂(1, 1) of the mutual pixels at the same position between the comparison target image B (1, 1) and the comparison target image C (1, 1).

In step S66, the image comparison unit 262 calculates the difference square sum of the mutual pixels at the same position between the comparison target image A and the comparison target image C. For example, in the comparison target images A (1, 1) to C (1, 1) regarding the reference position (1, 1), the image comparison unit 262 calculates the difference square sum d₁₃(1, 1) of the mutual pixels at the same position between the comparison target image A (1, 1) and the comparison target image C (1, 1).

In step S67, the image comparison unit 262 obtains a total of the difference square sums obtained in steps S64 to S66. For example, the image comparison unit 262 obtains a the calculated difference square sum d₁₁(1, 1), the difference square sum d₁₂(1, 1), and the difference square sum d₁₃(1, 1) to be set as the difference square sum d₁(1, 1).

In step S68, the image comparison unit 262 determines whether or not all the pixels with which the processing A image to the processing C image can be set without a protrusion are set as the reference position. In step S68, in a case where it is determined that all the pixels are not set as the reference position yet, the processing returns to step S63. According to this, the pixel which is not set as the reference position yet is set as the next reference position, and a subsequent processing is repeatedly performed.

On the other hand, in step S68, in a case where it is determined that all the pixels are set as the reference position, the processing proceeds to step S69, and the image comparison unit 262 determines whether or not the frame where the difference square sum is currently calculated is the last frame of the processing frame number F_{N}.

In step S69, in a case where it is determined that the frame where the difference square sum is currently calculated is not the last frame of the processing frame number F_{N}, the processing returns to step S62, and the subsequent processing is repeatedly performed.

On the other hand, in step S69, in a case where it is determined that the frame where the difference square sum is currently calculated is the last frame of the processing frame number F_{N}, that is, in a case where the difference square sum is calculated regarding the input image of the processing frame number F_{N}, in step S70, the image comparison unit 262 calculates the total sum of the difference square sums d(x′, y′)=Σdₖ(x′, y′) with regard to the pixel (1, 1) to (X′, Y′) to calculate the total sum of the difference square sums d(1, 1) to d(X′, Y′).

In step S71, the image comparison unit 262 obtains and decides obtains the position (p, q) where the total sum d(p, q) is largest among the calculated total sums of the difference square sums d(1, 1) to d(X′, Y′). Also, the image comparison unit 262 supplies the decided position (p, q) to the expansion processing units 242A to 242C, respectively, and the processing is ended.

In the image comparison unit 262, in the above-mentioned manner, the processing A image to the processing C image are compared, and the position (p, q) is obtained.

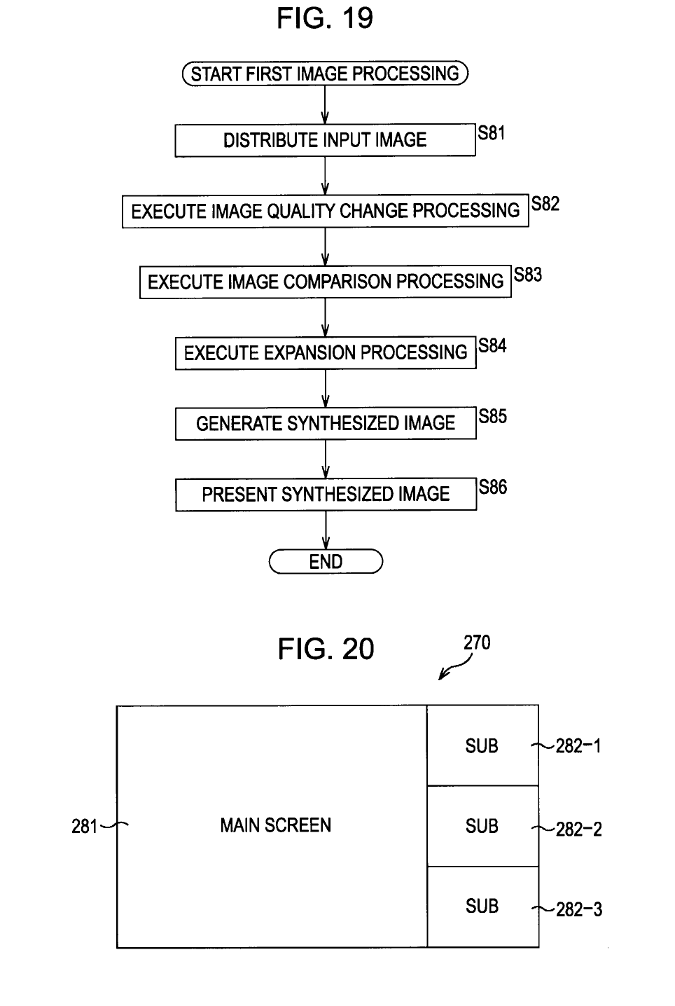

Next, with reference to a flow chart of FIG. 19, an image processing by the image processing apparatus 200 of FIG. 15 (first image processing) will be described.

First, in step S81, the image distribution unit 212 distributes the input image supplied from the image input unit 211. That is, the image distribution unit 212 supplies the image input to the image processing units 213-1 to 213-3 and the image synthesis unit 214.

In step S82, the image quality change processing units 241A to 241C execute an image quality change processing which is a processing of changing an image quality on the image input. It should be noted that in the image quality change processing units 241A to 241C, by the control of the control instruction unit 261, the image quality change processing is performed so that the image qualities of the generated images are different from each other. The processing A image to the processing C image after the image quality change processing are supplied to the image comparison unit 262.

In step S83, the image comparison unit 262 executes the image comparison processing described with reference to FIGS. 16 to 18. According to this, the position (p, q) where the image quality is most different is detected among the processing A image, the processing B image, and the processing C image respectively output by the image quality change processing units 241A to 241C and supplied to the expansion processing units 242A to 242C.

In step S84, the expansion processing units 242A to 242C execute an expansion processing of expanding a part of the input processed image. That is, the expansion processing unit 242A generates an expanded image A where a predetermined area is expanded while the position (p, q) of the processed A image supplied from the image quality change processing unit 241A is set as the reference to be supplied to the image synthesis unit 214. The expansion processing unit 242B generates an expanded image B where a predetermined area is expanded while the position (p, q) of the processed B image supplied from the image quality change processing unit 241B is set as the reference to be supplied to the image synthesis unit 214. The expansion processing unit 242C generates an expanded image C where a predetermined area is expanded while the position (p, q) of the processed C image supplied from the image quality change processing unit 241C is set as the reference to be supplied to the image synthesis unit 214.

In step S85, the image synthesis unit 214 uses the input image supplied from the image distribution unit 212 and the expanded images A to C supplied from the expansion processing units 242A to 242C and generates a synthesized image to be supplied to the image presentation unit 215. Also, the image synthesis unit 214 supplies one image selected among the image input and the expanded images A to C as a main image to the image recording unit 216.

It should be noted that which image among the image input and the expanded images A to C is set as the main image id decided by an instruction of the user supplied via the control unit 217 as will be described with reference to FIGS. 20 to 23.

In step S86, by displaying the synthesis image supplied from the image synthesis unit 214 on the predetermined display unit, the image presentation unit 215 presents the synthesis image to the user. Also, in step S86, the image recording unit 216 records the main image supplied from the image synthesis unit 214 in a predetermined recording medium, and the processing is ended.

With reference to FIGS. 20 to 23, a screen control (GUI (Graphical User Interface)) by the image presentation unit 215 will be described.

FIG. 20 shows an example of a display screen displayed by the image presentation unit 215.

The image synthesis unit 214 generates a synthesized image so that expanded images can be displayed on the respective areas where the display screen 270 is divided into a main screen area 281 shown in FIG. 20 and sub screen areas 282-1 to 282-3 arranged on the right side thereof.

The display screen 270 is composed of the main screen area 281 and the sub screen areas 282-1 to 282-3 arranged on the right side thereof. The sub screen areas 282-1 to 282-3 are arranged lined up in the up and down direction, and an overall height of the three sub screen areas 282-1 to 282-3 is the same as a height of the main screen area 281.

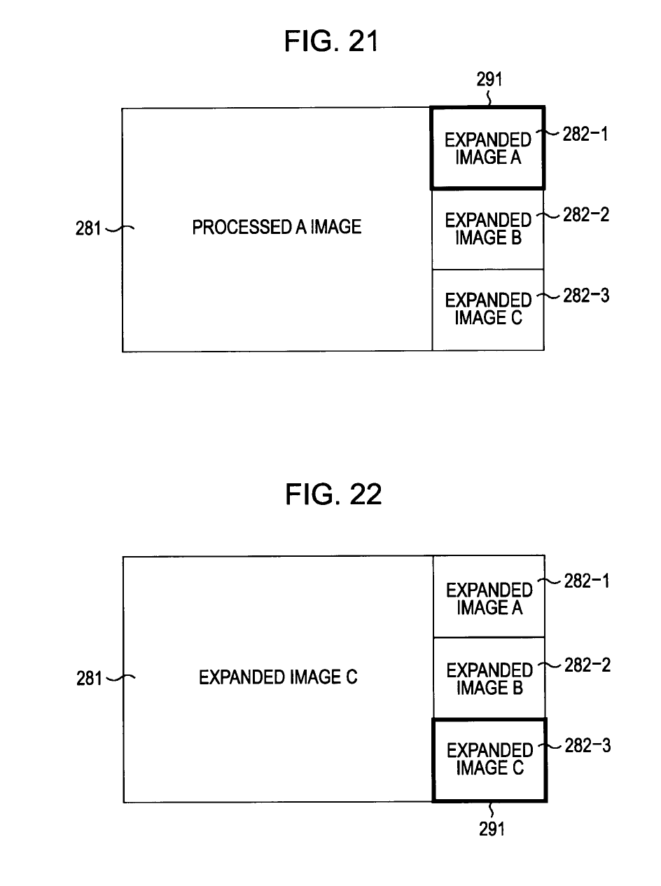

The synthesized image shown, for example, in FIG. 21 is generated with respect to the above-mentioned display screen 270 to be presented to the user.

In the synthesized image shown in FIG. 21, the processed A image obtained by performing the image quality change processing in the image quality change processing unit 241A is arranged in the main screen area 281, and the expanded images A to C obtained by performing the expansion processing in the expansion processing units 242A to 242C are arranged in the sub screen areas 282-1 to 282-3.

Then, a highlight display 291 is displayed in one of the sub screen areas 282-1 to 282-3, and the user can move the highlight display 291 to a desired position of the sub screen areas 282-1 to 282-3 by operating up and down keys (not shown) of the remote commander. That is, the image synthesis unit 214 generates an image in which the highlight display 291 is overlapped on the synthesized image to be supplied to the image presentation unit 215. FIG. 21 shows an example in which the highlight display 291 is displayed in the sub screen area 282-1.

When control information indicating that the up key of the remote commander is operated is supplied to the image synthesis unit 214 in a state where the highlight display 291 is at the sub screen area 282-1, the image synthesis unit 214 moves the highlight display 291 to the sub screen area 282-3.

Also, when control information indicating that the down key of the remote commander is operated is supplied to the image synthesis unit 214 in a state where the highlight display 291 is at the sub screen area 282-3, the image synthesis unit 214 moves the highlight display 291 to the sub screen area 282-1.

Alternatively, when control information indicating that a decision key (not shown) of the remote commander is operated is supplied to the image synthesis unit 214 in a state where the highlight display 291 is at the sub screen area 282-3, the image synthesis unit 214 generates a synthesized image shown in FIG. 22. In FIG. 22, the expanded image C selected by the user is displayed in the main screen area 281.

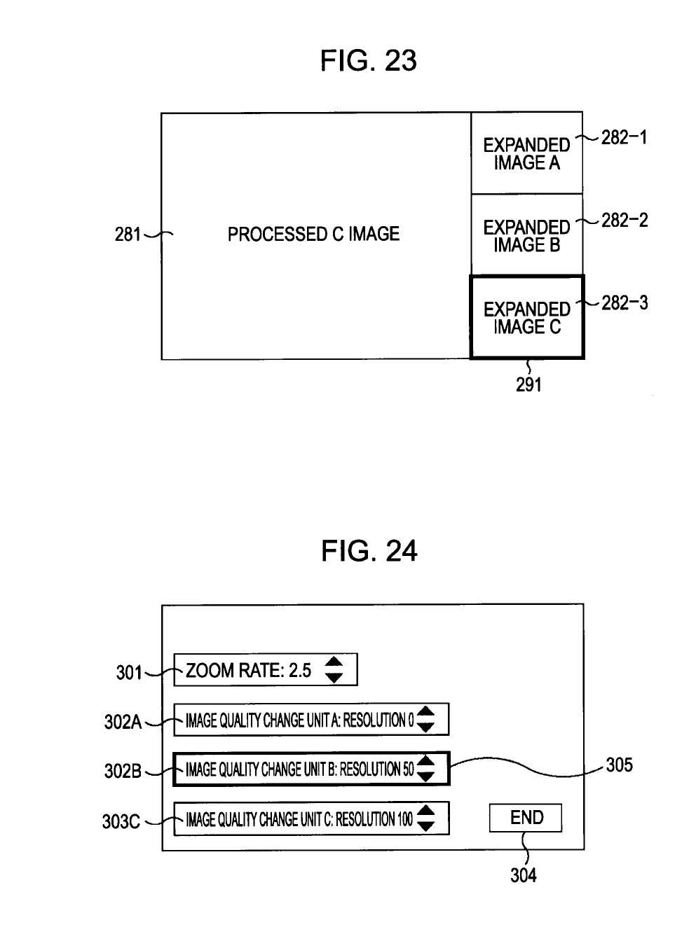

Also, in a case where control information indicating that the decision key (not shown) of the remote commander is operated is supplied to the image synthesis unit 214 in a state where the highlight display 291 is at the sub screen area 282-3, the image synthesis unit 214 can also generate a synthesized image shown in FIG. 23.

FIG. 23 is an example of the synthesized image in which the processed C image which is an entire image corresponding to the expanded image C selected by the user is displayed in the main screen area 281. The screen control (display) displayed in FIG. 23 is effective in a case where it is necessary to perform an image quality evaluation on the entire screen while a focus is on a detail part.

Next, a GUI for the user to set parameters necessary to the first image processing will be described.

With respect to the image quality change processing performed by the image quality change processing units 241A to 241C, by using a parameter setting screen shown in FIG. 24, the user can set a plurality of parameters.

In the parameter setting screen shown in FIG. 24, a zoom setting box 301, resolution change boxes 302A to 302C, and an end box 304 are provided.

In the zoom setting box 301, it is possible to decide a zoom rate at the time of performing the expansion processing with respect to the image input in the image quality change processing units 241A to 241C. Although not described so far, in the image quality change processing units 241A to 241C, the image input after is expanded at a predetermined zoom rate, the image quality can be changed. At about which zoom rate the image quality change processing units 241A to 241C expand the image input is specified in this zoom setting box 301.

After the user moves a cursor 305 to the zoom setting box 301 and the selection is made by the decision key, by operating the up and down keys, the zoom rate is set as a desired value. In FIG. 24, the zoom rate is set as “2.5”. It should be noted that in a case where the zoom rate is set as “0.0”, as described above, the image quality change processing units 241A to 241C perform only the image quality change processing on the image input.

In the resolution change boxes 302A to 302C, it is possible to decide a resolution which is a parameter for deciding the image quality when the image quality change processing units 241A to 241C perform the image quality change processing. This resolution is, for example, the spatial resolution.

In a case where the respective parameters of the resolution change boxes 302A to 302C are changed, similarly as in the case of changing the zoom rate, the user moves the cursor 305 to the resolution change boxes 302A to 302C where the change is desired and changes the resolution (numeric value) by the up and down key. According to this, the parameter z and the coefficient seed data in a case where the class classification processing is applied.

By moving the cursor to the end box 304 and operating a decision button, the changed parameter is stored inside the control instruction unit 261 and also supplied from the control instruction unit 261 to the image quality change processing units 241A to 241C.

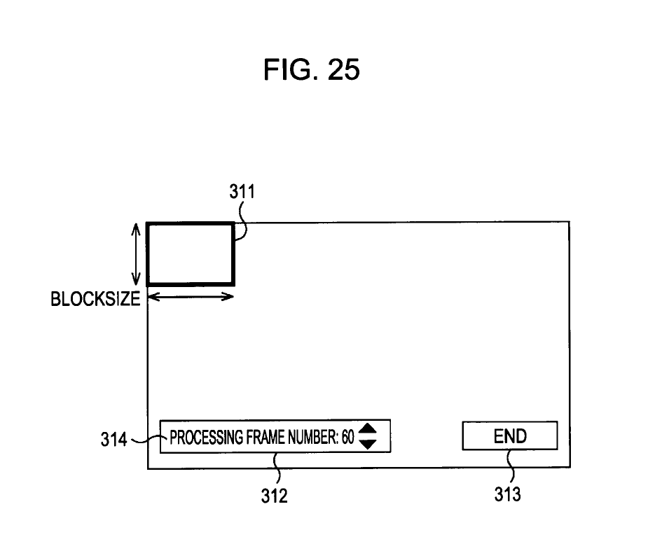

FIG. 25 is an example of parameter setting screen for setting parameters regarding the image comparison processing performed in the image comparison unit 262.

In the parameter setting screen shown in FIG. 25, it is possible to set BLOCKSIZE (Bₓ, B_{y}) which is the comparison area size and the processing frame number F_{N}.

In a case where BLOCKSIZE (Bₓ, B_{y}) is changed, the user changes a size of an area frame 311 displayed on the parameter setting screen shown in FIG. 25. The size of the area frame 311 after the change is decided as BLOCKSIZE (B_{y}, B_{y}) as it is.

In a case where the processing frame number F_{N} is changed, after the user moves a cursor 312 to a frame number setting box 314, a numeric value displayed therein is changed by the up and down key. An end box 313 is a button operated at the time of instructing an end of the parameter setting similarly as in the end box 304. Upon the end of the parameter setting screen, the parameter after the change is supplied via the control instruction unit 261 to the image comparison unit 262 and stored therein.

As described above, according to the first embodiment the image processing apparatus 200 shown in FIG. 15, the plurality of different image processings are applied on the same image input, and when the results are synthesized and displayed at the same time, the part where the difference is largest among the respective processed images is cut out to be displayed. Therefore, the difference due to the respective image quality change processings can be easily checked, and it is possible to perform the more accurate and efficient image quality evaluation.

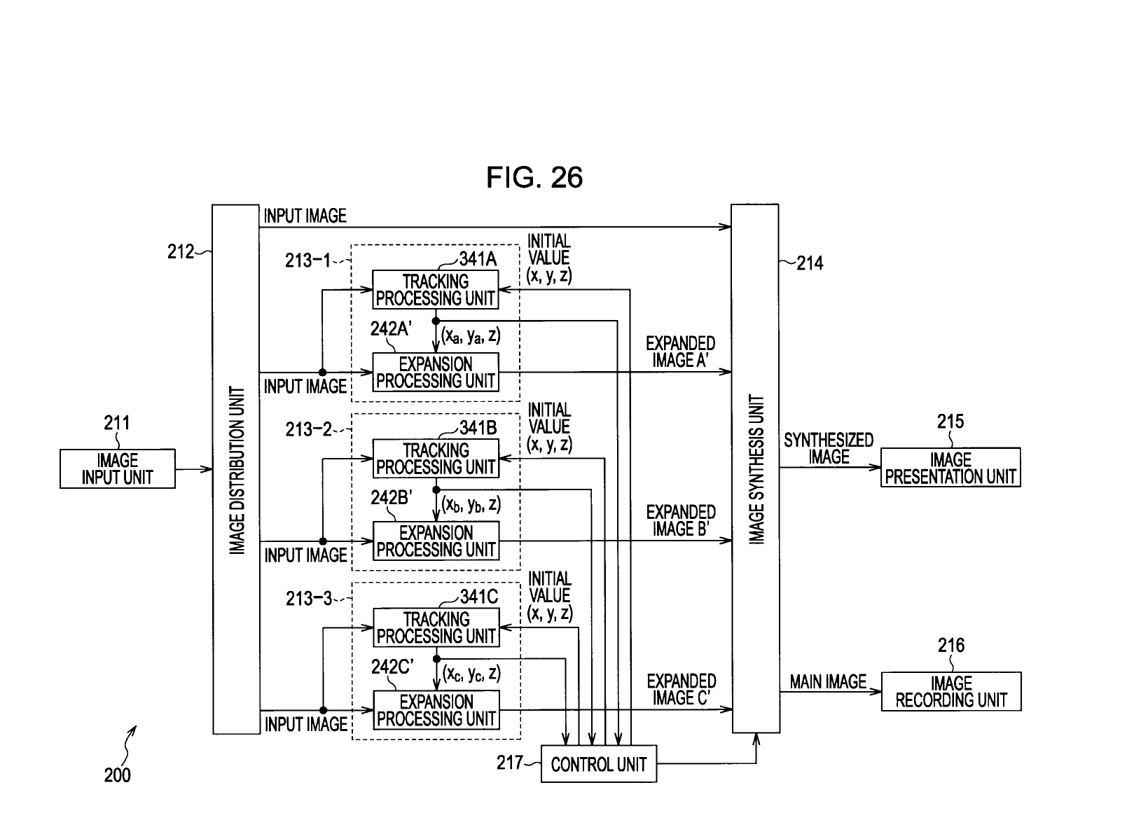

FIG. 26 is a block diagram showing a second detailed configuration example (second embodiment) of the image processing apparatus 200 in FIG. 14.

The image processing unit 213-1 is composed of a tracking processing unit 341A and an expansion processing unit 242A′, the image processing unit 213-2 is composed of a tracking processing unit 341B and an expansion processing unit 242B′. Also, the image processing unit 213-3 is composed of a tracking processing unit 341C and an expansion processing unit 242C′.

To the tracking processing units 341A to 341C, the position (hereinafter, which is referred to as user instruction point) (x, y) in the image input instructed by the user at a predetermined timing and the zoom rate z are supplied as the initial value (x, y, z) from the control unit 217.

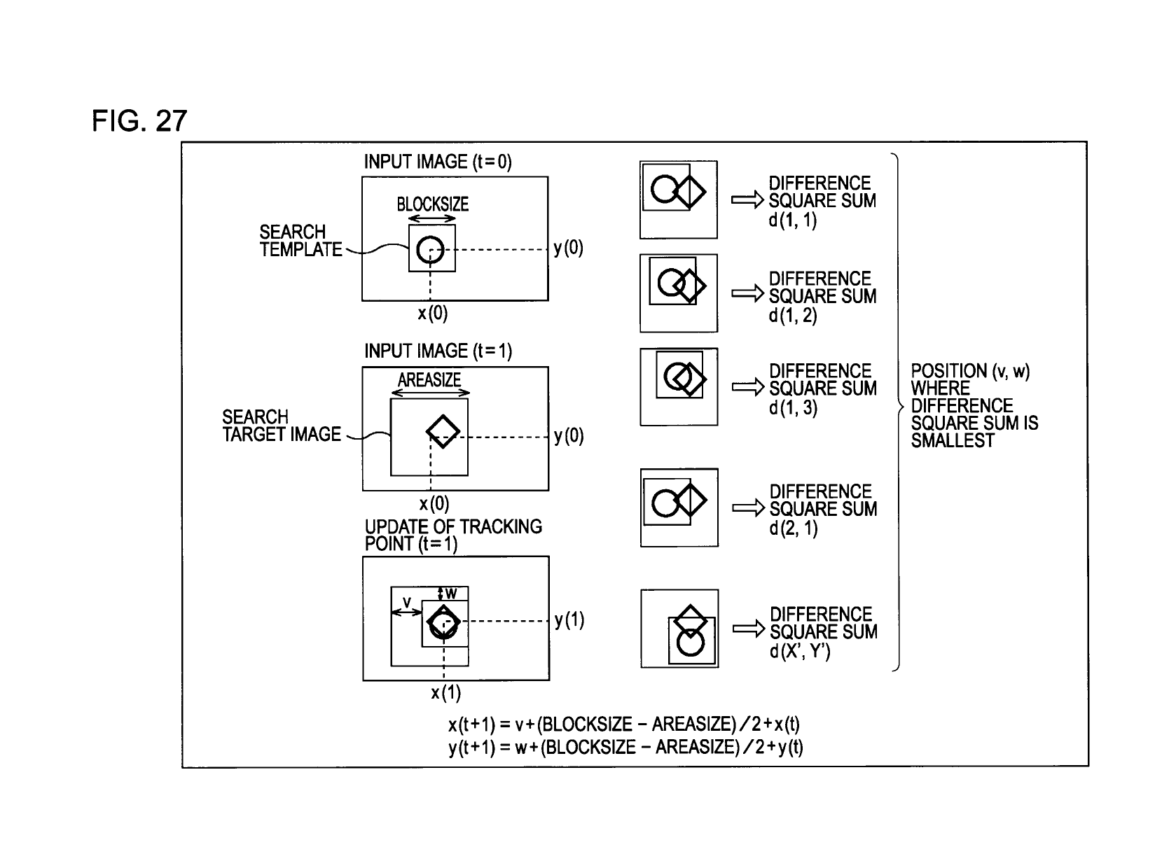

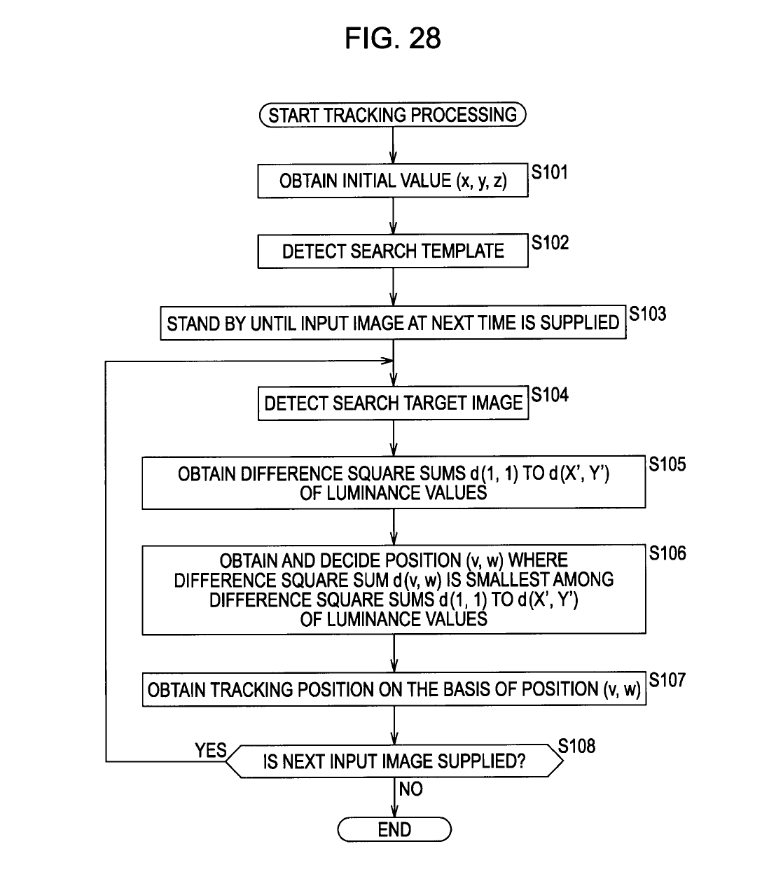

On the basis of the initial value (x, y, z), the tracking processing units 341A to 341C execute the tracking processing for tracking the user instruction point (x, y) of the image input. It should be noted that the tracking processing units 341A to 341C execute the tracking processing in mutually different tracking processing systems. Therefore, the results of executing the tracking processing while the same user instruction point (x, y) is set as the reference are not necessarily the same. Details of the tracking processing systems performed by the respective tracking processing units 341A to 341C will be described below with reference to FIGS. 27 and 28.

The tracking processing unit 341A supplies a tracking processing result (xₐ, yₐ, z) composed of the position after the tracking (xₐ, yₐ) and the zoom rate z to the expansion processing unit 242A′ and the control unit 217. The tracking processing unit 341B supplies the tracking processing result (x_{b}, y_{b}, z) composed of the position after the tracking (x_{b}, y_{b}) and the zoom rate z to the expansion processing unit 242B′ and the control unit 217. The tracking processing unit 341C supplies the tracking processing result (x_{c}, y_{c}, z) composed of the position after the tracking (x_{c}, y_{c}) and the zoom rate z to the expansion processing unit 242C′ and the control unit 217.

It should be noted that in a case where the respective tracking processing units 341A to 341C are not particularly necessarily distinguished, those are simply referred to as tracking processing unit 341.

The expansion processing units 242A′ to 242C′ execute an expansion processing similarly as in the expansion processing units 242A to 242C according to the first embodiment and supply expanded images A′ to C′ after the expansion processing to the image synthesis unit 214. An area where the expansion processing is respectively performed by the expansion processing units 242A′ to 242C′ is an area decided by the tracking processing result (xₐ, yₐ, z), (x_{b}, y_{b}, z) of the image input supplied from the tracking processing units 341A to 341C or (x_{c}, y_{c}, z).

The control unit 217 supplies the user instruction point (x, y) instructed by the user and the zoom rate z as the initial value (x, y, z) to the tracking processing units 341A to 341C. Also, in the second image processing according to the second embodiment, the expanded images A′ to C′ after the expansion processing by the expansion processing units 242A′ to 242C′ are displayed on one screen at the same time as described with reference to FIGS. 20 to 23 according to the first embodiment, but in a case where the user selects one of the displayed expanded images A′ to C′, the control unit 217 supplies the tracking processing result of the selected expanded image as the next initial value (x, y, z) to the tracking processing units 341A to 341C.

With reference to FIG. 27, the tracking processing by the tracking processing unit 341A will be described in detail.

FIG. 27 shows an example in which a search image (search template which will be described below) detected in the image input at a time t=0 is tracked by the image input at the time t=1. It should be noted that in FIG. 27, the position (x, y) of the image input at the time t is indicated by (x(t), y(t)).

The tracking processing unit 341A detects BLOCKSIZE (Bₓ, B_{y}) in which the user instruction point (x(0), y(0)) is set as the center with respect to the image input at the time t=0 as the search template. It should be noted that BLOCKSIZE (Bₓ, B_{y}) according to the second embodiment does not need to have the same value as BLOCKSIZE (Bₓ, B_{y}) according to the first embodiment. Also, according to the second embodiment, BLOCKSIZE (Bₓ, B_{y}) is set as a square (Bₓ=B_{y}) and simply described as BLOCKSIZE.

Then, when the image input at the time t=1 is supplied, the tracking processing unit 341A detects AREASIZE (Aₓ, A_{y}) while the user instruction point (x(0), y(0)) is set as the center as a search target image. It should be noted that according to the second embodiment, AREASIZE (Aₓ, A_{y}) is set as a square (Aₓ=A_{y}) and simply described as AREASIZE.

In FIG. 27, main target objects within the search template in the image input at the time t=0 are indicated by circles, and the same target objects are indicated by lozenges in the image input at the time t=1.

Next, the tracking processing unit 341A obtains a difference square sum of the luminance value d(x′, y′) with respect to the pixel (x′, y′)(x′=1, 2, . . . , X′, y′=1, 2, . . . , Y′) in AREASIZE. Herein, X′=Aₓ−Bₓ+1 and Y′=A_{y}−B_{y}+1 are established. It should be noted that the difference square sum d(x′, y′) according to this second embodiment is a value different from the difference square sum d(x′, y′) according to the first embodiment.

The tracking processing unit 341A obtains and decides the position (v, w) where the difference square sum d(v, w) is smallest among the difference square sums of the luminance values d(1, 1) to d(X′, Y′) regarding all the pixels (1, 1) to (X′, Y′) with which BLOCKSIZE in AREASIZE can be set without a protrusion. Therefore, (v, w) is one of (1, 1) to (X′, Y′).

Then, the tracking processing unit 341A assigns the position (v, w) to the following.

x(t+1)=v+(BLOCKSIZE−AREASIZE)/2+x(t)

y(t+1)=w+(BLOCKSIZE−AREASIZE)/2+y(t)

Thus, the tracking position (x(1), y(1)) in the image input at the time t=1 is obtained. The thus obtained tracking position (x(1), y(1)) is supplied together with the zoom rate (z) to the expansion processing unit 242A′ as the tracking processing result (xₐ, yₐ, z) at the time t=1.

FIG. 28 is a flow chart of the tracking processing by the tracking processing unit 341A described with reference to FIG. 27.

First, in step S101, the tracking processing unit 341A obtains the initial value (x, y, z) supplied from the control unit 217. The obtained initial value (x, y, z) is stored inside the tracking processing unit 341A.

In step S102, the tracking processing unit 341A detects the search template from the image input at the time t=0 supplied from the image distribution unit 212. To be more specific, the tracking processing unit 341A detects BLOCKSIZE while the user instruction point (x(0), y(0)) is set as the center with respect to the image input at the time t=0 supplied from the image distribution unit 212 as the search template.

In step S103, the tracking processing unit 341A stands by until the image input at a next time is supplied from the image distribution unit 212.

In step S104, the tracking processing unit 341A detects the search target image from the image input at the next time. That is, the tracking processing unit 341A detects AREASIZE as the search target image while the user instruction point (x(0), y(0)) is set as the center with respect to the image input at the next time.

In step S105, the tracking processing unit 341A obtains the difference square sums of the luminance values d(1, 1) to d(X′, Y′) with regard to all the pixels (1, 1) to (X′, Y′) with which BLOCKSIZE in AREASIZE can be set without a protrusion. The obtained difference square sums of the luminance values d(1, 1) to d(X′, Y′) are stored inside the tracking processing unit 341A as evaluation value tables.

In step S106, the tracking processing unit 341A obtains and decides the position (v, w) where the difference square sum d(v, w) is smallest among the difference square sums of the luminance values d(1, 1) to d(X′, Y′).

In step S107, on the basis of the position (v, w), the tracking processing unit 341A obtains the tracking position of the image input at the next time. For example, in a case where the next time is the time t+1, on the basis of the position (v, w), the tracking processing unit 341A calculates as follows.

x(t+1)=v+(BLOCKSIZE−AREASIZE)/2+x(t)

y(t+1)=w+(BLOCKSIZE−AREASIZE)/2+y(t)

Thus, the tracking position (x(1), y(1)) in the image input at the time t+1 is obtained. In step S107, also, the obtained tracking position is supplied together with the zoom rate as the tracking processing result (xa, ya, z) at the next time to the expansion processing unit 242A′.

In step S108, the tracking processing unit 341A determines whether or not the next image input is supplied. In step S108, in a case where it is determined that the next image input is supplied, the processing returns to step S104, and the subsequent processing is repeatedly executed.

On the other hand, in step S108, in a case where it is determined that the next image input is not supplied, the processing is ended.

As described above, in the tracking processing by the tracking processing unit 341A, at the time t, when the user instruction point (x(t), y(t)) with respect to the image input is instructed by the user, the search template set to the image input where the user instruction point (x(t), y(t)) is specified and the search target images set to the image inputs sequentially input are compared, so that the user instruction point (x(t), y(t)) is tracked. The tracking processing result (x(t+1), y(t+1)) and the zoom rate z are supplied as the tracking processing result (xₐ, yₐ, z) to the expansion processing unit 242A′.

This tracking processing by the tracking processing unit 341A is a general method called block matching.

In contrast to this, a system of the tracking processing performed by the tracking processing unit 341B is different in that in step S108 of the tracking processing shown in FIG. 28, in a case where it is determined that the next image input is supplied, the processing is returned to the processing in step S102 instead of being returned to step S104.

That is, in the tracking processing by the tracking processing unit 341A, the search template is not changed while the image input when the user instructs the user instruction point (x(t), y(t)) is regularly set as the reference image, but a different point is that in the tracking processing by the tracking processing unit 341B, the search template is also set by the image input at the latest time. This tracking processing by the tracking processing unit 341B has an advantage as superior to a shape change of the tracking target but on the other hand also has an aspect that the tracking target is gradually shifted.

On the other hand, in the tracking processing by the tracking processing unit 341C, a different point is that the difference square sums d(1, 1) to d(X′, Y′) calculated in step S105 in the tracking processing shown in FIG. 28 are not calculated by the luminance values but are calculated by values of color-difference signals. A method of this tracking processing by the tracking processing unit 341C has an advantage of being superior to a luminance change at the tracking target or over the entire screen but on the other hand also has an aspect that the color-difference signal generally has a lower spatial frequency than the luminance signal, and therefore the tracking accuracy is slightly inferior.

As described above, the tracking processing units 341A to 341C execute the tracking processing in respectively different tracking processing systems and supply the tracking processing results (xₐ, yₐ, z), (x_{b}, y_{b}, z), and (x_{c}, y_{c}, z) obtained as the results to the expansion processing units 242A′ to 242C′ on a one-to-one basis.

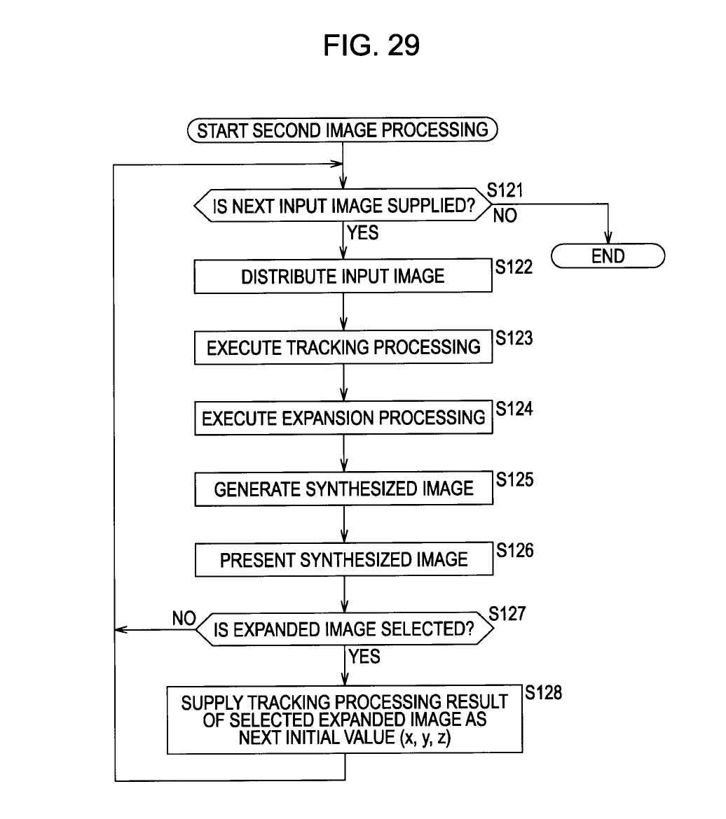

Next, with reference to a flow chart of FIG. 29, an image processing (second image processing) by the image processing apparatus 200 of FIG. 26 will be described.

First, in step S121, the image distribution unit 212 determines whether or not the image input is supplied from the image input unit 211. In step S121, in a case where it is determined that the image input is not supplied, the processing is ended.

On the other hand, in step S121, in a case where it is determined that the image input is supplied from the image input unit 211, the processing proceeds to step S122, and the image distribution unit 212 distributes the supplied image input. That is, the image distribution unit 212 supplies the image input and the image processing units 213-1 to 213-3 and the image synthesis unit 214.

In step S123, as described with reference to FIGS. 27 and 28, the tracking processing unit 341A performs the block matching by the luminance values while keeping the search template to execute the tracking processing. Also, in step S123, at the same time, the tracking processing unit 341B performs the block matching by the luminance values while updating the search template to execute the tracking processing, and also the tracking processing unit 341C performs the block matching by the color-difference signals while the search template to execute the tracking processing.

The tracking processing result (xₐ, yₐ, z) by the tracking processing unit 341A is supplied to the expansion processing unit 242A′, and the tracking processing result (x_{b}, y_{b}, z) by the tracking processing unit 341B is supplied to the expansion processing unit 242B′. Also, the tracking processing result (x_{c}, y_{c}, z) by the tracking processing unit 341C is supplied to the expansion processing unit 242C′.

In step S124, the expansion processing units 242A′ to 242C′ execute the expansion processing in parallel for expanding a part of the image input which is input from the image distribution unit 212. That is, the expansion processing unit 242A′ generates an expanded image A′ which is expanded at the zoom rate z while the position after the tracking (xₐ, yₐ) supplied from the tracking processing unit 341A is set as the center to be supplied to the image synthesis unit 214. The expansion processing unit 242B′ generates an expanded image B′ which is expanded at the zoom rate z while the position after the tracking (x_{b}, y_{b}) supplied from the tracking processing unit 341B is set as the center to be supplied to the image synthesis unit 214. The expansion processing unit 242C′ generates an expanded image C′ which is expanded at the zoom rate z while the position after the tracking (x_{c}, y_{c}) supplied from the tracking processing unit 341C is set as the center to be supplied to the image synthesis unit 214.

In step S125, the image synthesis unit 214 uses the input image supplied from the image distribution unit 212 and the expanded images A′ to C′ supplied from the expansion processing units 242A′ to 242C′ to generate a synthesized image to be supplied to the image presentation unit 215. Also, the image synthesis unit 214 supplies the main image which is an image arranged in the main screen area 281 in the synthesized image to the image recording unit 216.

In step S126, By displaying the synthesis image supplied from the image synthesis unit 214 on the predetermined display unit, the image presentation unit 215 presents the synthesis image to the user. Also, in step S126, the image recording unit 216 records the main image supplied from the image synthesis unit 214 on the predetermined recording medium.

In step S127, the control unit 217 determines whether or not one expanded image of the expanded images A′ to C′ displayed in the image presentation unit 215 is selected by the user.

In step S127, in a case where it is determined that one expanded image of the expanded images A′ to C′ is not selected by the user, the processing returns to step S121, and the subsequent processing is repeatedly executed.

On the other hand, in step S127, in a case where it is determined that one expanded image of the expanded images A′ to C′ is selected by the user, the processing proceeds to step S128, and the control unit 217 supplies the tracking processing result of the expanded image selected by the user to the tracking processing units 341A to 341C as the next initial value (x, y, z). After that, the processing returns to step S121, and the subsequent processing is repeatedly executed.

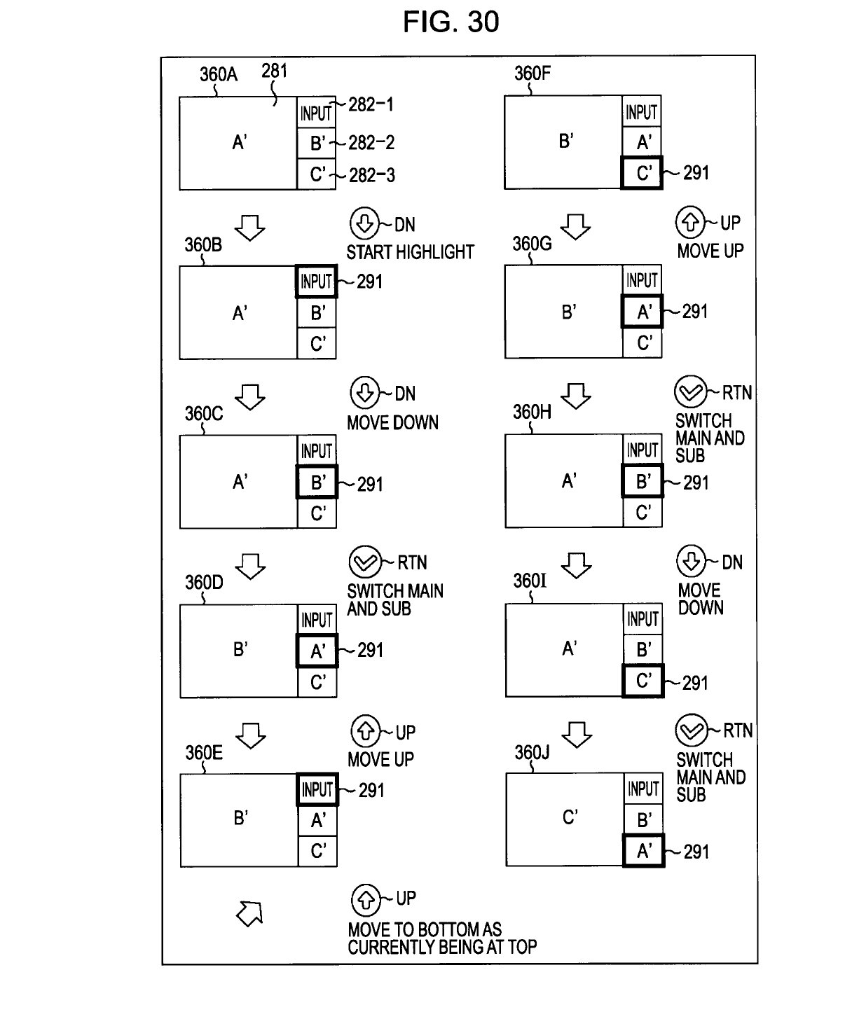

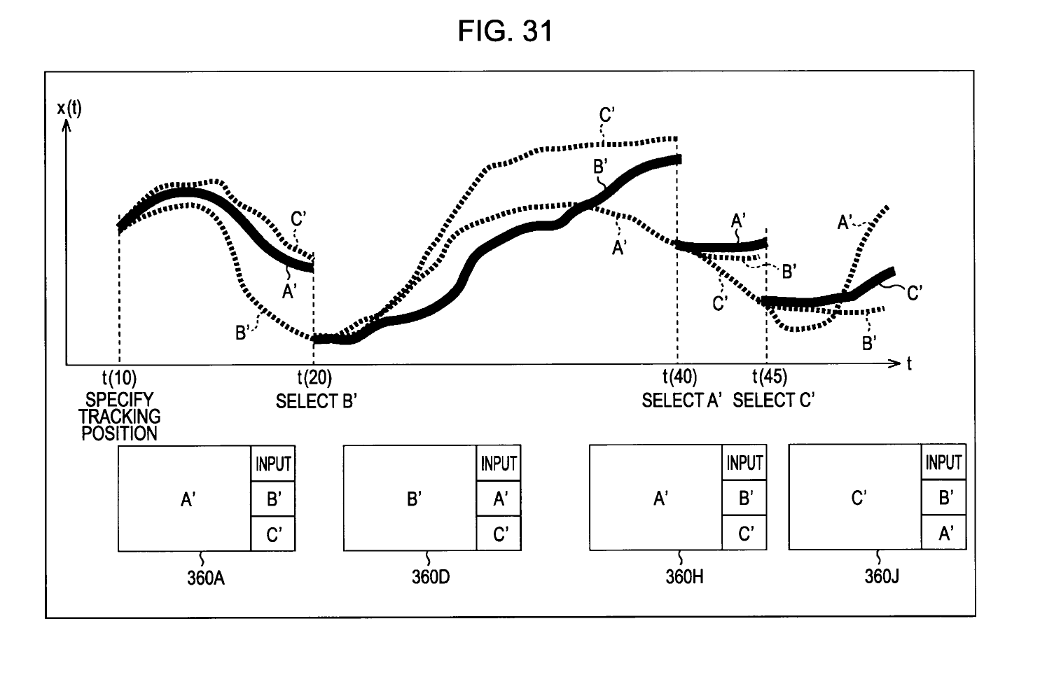

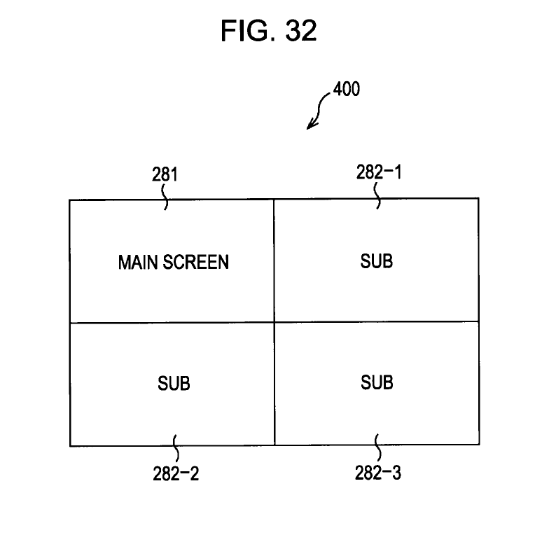

With reference to FIGS. 30 and 31, the screen control according to the second embodiment will be described.

FIG. 30 shows a state in which the display screen displayed in the image presentation unit 215 are shifted in the order of display screens 360A to 360J on the basis of the operation of the user. It should be noted that in FIG. 30, to avoid complication of the drawing, a part of graphic representation of reference symbols for the main screen area 281 and the sub screen areas 282-1 to 282-3 are omitted.

For example, as an initial state, in the image presentation unit 215, it is supposed that the display screen 360A is displayed. On the display screen 360A, the expanded image A′ from the expansion processing unit 242A′ is displayed in the main screen area 281, and the image input is displayed in the sub screen area 282-1. Also, the expanded image B′ is displayed in the sub screen area 282-2, and the expanded image C′ is displayed in the sub screen area 282-3.

In this initial state, when the user operates a down key DN of the remote commander, the image presentation unit 215 obtains the operation via the control unit 217 to display the display screen 360B. On the display screen 360B, in addition to the display of the display screen 360A, the highlight display 291 for highlighting a predetermined sub screen area is displayed in the sub screen area 282-1.

In a state where the display screen 360B is displayed, when the user operates the down key DN of the remote commander, the image presentation unit 215 displays the display screen 360C on which the highlight display 291 is moved to the sub screen area 282-2.

Next, in a state where the display screen 360C is displayed, when the user operates a decision key RTN of the remote commander, the image presentation unit 215 displays the display screen 360D on which the expanded image A′ of the main screen area 281 and the expanded image B′ of the sub screen area 282-2 are switched the display screen 360D on which.

In a state where the display screen 360D is displayed, when the user operates an up key UP of the remote commander, the image presentation unit 215 displays the display screen 360E on which the highlight display 291 is moved to the sub screen area 282-1.

Furthermore, in a state where the display screen 360E is displayed, when the user operates the up key UP of the remote commander, as the current highlight display 291 is the sub screen area 282-1 on the top among the sub screen areas 282-1 to 282-3, the image presentation unit 215 displays the display screen 360F on which the sub screen area 282-3 is moved to the highlight display 291.

In a state where the display screen 360F is displayed, when the user further operates the up key UP of the remote commander, the image presentation unit 215 displays the display screen 360G on which the highlight display 291 is moved to the sub screen area 282-2.

Then, in a state where the display screen 360G is displayed, when the user operates the decision key RTN of the remote commander, the image presentation unit 215 displays the display screen 360H on which the expanded image B′ of the main screen area 281 and the expanded image A′ of the sub screen area 282-2 are switched.

In a state where the display screen 360H is displayed, when the user operates the down key DN of the remote commander, the image presentation unit 215 displays the display screen 3601 on which the sub screen area 282-3 is moved to the highlight display 291.

Then, in a state where the display screen 360I is displayed, when the user operates the decision key RTN of the remote commander, the image presentation unit 215 displays the display screen 360J on which the expanded image At of the main screen area 281 and the expanded image C′ of the sub screen area 282-3 are switched.

As described above, according to the second embodiment, the expanded image selected by the user among the sub screen areas 282-1 to 282-3 is displayed in the main screen area 281, and the expanded image displayed so far in the main screen area 281 is displayed in the sub screen area selected among the sub screen areas 282-1 to 282-3. That is, the expanded image in the main screen area 281 and the expanded image selected by the user among the sub screen areas 282-1 to 282-3 are switched.

Next, the shift of the tracking position in a case where, as described in FIG. 30, the expanded images A′ to C′ displayed in the sub screen areas 282-1 to 282-3 are selected will be described with reference to FIG. 31.

In FIG. 31, the horizontal axis indicates a time t, and the vertical axis indicates an x(t) coordinate of the tracking position (x(t), y(t)).

As described above, the tracking processing units 341A to 341C perform the tracking processing in respectively different tracking systems, when the user selects one of the expanded images A′ to C′ displayed in the sub screen areas 282-1 to 282-3, the control unit 217 supplies the tracking processing result of the selected expanded image as the next initial value (x, y, z) to the tracking processing units 341A to 341C, so that the tracking position is reset.

In the example shown in FIG. 31, at a time x(10), the initial value (x, y, z) instructed by the user is supplied from the control unit 217 to the tracking processing units 341A to 341C, and thereafter, the tracking processing units 341A to 341C perform the tracking processing in respective different tracking systems. At the time x(10), it is a state in which the display screen 360A is presented by the image presentation unit 215.

At a time x(20) in a state in which the display screen 360C (FIG. 30) is displayed, when the user operates the decision key RTN of the remote commander, the image presentation unit 215 displays the display screen 360D on which the expanded image A′ of the main screen area 281 and the expanded image B′ of the sub screen area 282-2 are switched. Also, the control unit 217 supplies the tracking processing result (x_{b}, y_{b}, z) supplied from the tracking processing unit 341B at the time x(20) to the tracking processing units 341A to 341C as the initial value (x, y, z) again. According to this, all the tracking processing units 341A to 341C execute the tracking processing from the tracking processing result (x_{b}, y_{b}, z) at the time x(20) after the time x(20).

At a time x(40) in a state in which the display screen 360G (FIG. 30) is displayed after a further predetermined period of time, when the user operates the decision key RTN of the remote commander, the image presentation unit 215 displays the display screen 360H on which the expanded image B′ of the main screen area 281 and the expanded image A′ of the sub screen area 282-2 are switched. Also, the control unit 217 supplies the tracking processing result (xₐ, yₐ, z) supplied from the tracking processing unit 341A at the time x(40) to the tracking processing units 341A to 341C as the initial value (x, y, z) again. According to this, all the tracking processing units 341A to 341C executes the tracking processing from the tracking processing result (xₐ, yₐ, z) at the time x(40) after the time x(40).

Similarly, at a time x(45) after a predetermined period of time from the time x(40), in a state in which the display screen 3601 (FIG. 30) is displayed, when the user operates the decision key RTN of the remote commander, the image presentation unit 215 displays the display screen 360J on which the expanded image A′ of the main screen area 281 and the expanded image C′ of the sub screen area 282-3 are switched. Also, the control unit 217 supplies the tracking processing result (x_{c}, y_{c}, z) supplied from the tracking processing unit 341C at the time x(45) to the tracking processing units 341A to 341C as the initial value (x, y, z) again. According to this, all the tracking processing units 341A to 341C execute the tracking processing from the tracking processing result (x_{c}, y_{c}, z) at the time x(45) after the time x(45).

As described above, the tracking processing results obtained when the tracking processing units 341A to 341C perform the tracking processing in the different tracking processing systems are displayed at the same time and presented to the user, so that the user can select the tracking processing result where advantages of the respective tracking processing systems appear. The expanded image (one of the expanded images A′ to C′) selected by the user and displayed in the main screen area 281 is recorded in the image recording unit 216, so that the user can obtain still more desired processing results.

FIG. 32 shows another example of a display screen on which a difference in the tracking processing results by the respective tracking processings is still easier to be noticed according to the second embodiment.

FIG. 32 shows an example of a display screen 400 in which the area is evenly divided into four, the main screen area 281 is set on the upper left, and the other three areas are set as the sub screen areas 282-1 to 282-3.

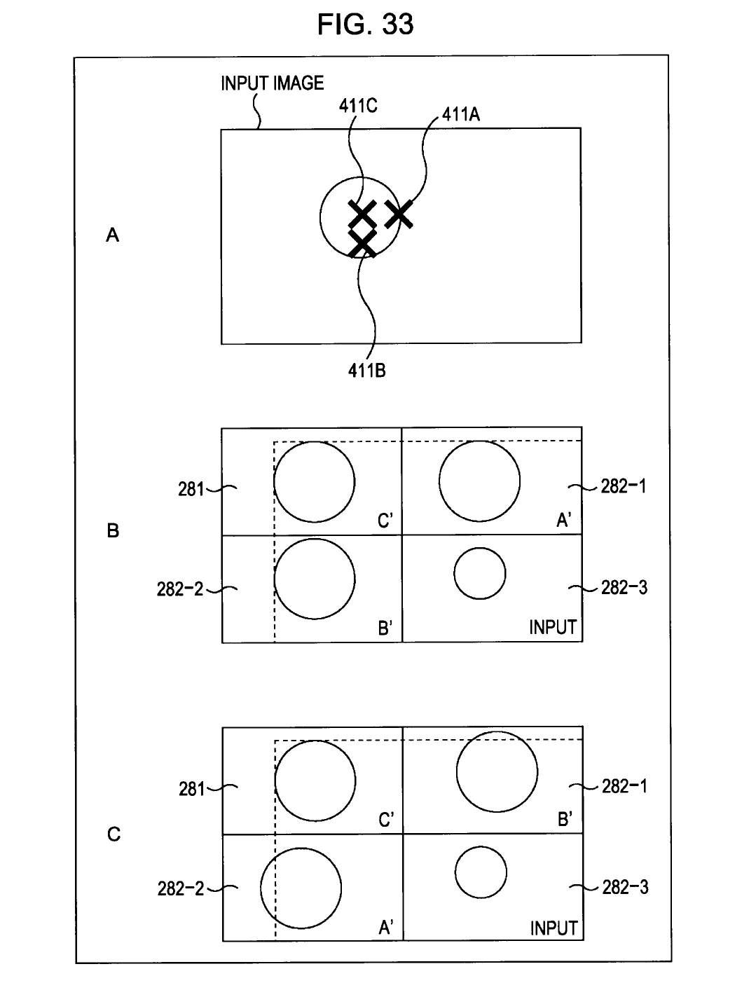

Now, in the image processing apparatus 200 of FIG. 26, the tracking processing result of applying the tracking processing on the image input is as shown in A of FIG. 33. That is, in A of FIG. 33, tracking positions by the tracking processing units 341A to 341C are respectively tracking position 411A, 411B, and 411C.

Also, it is supposed that the tracking processing result by the tracking processing unit 341C is selected by the user. That is, on the main screen area 281 of the display screen 400 of FIG. 32, the tracking processing result by the tracking processing unit 3410 is displayed.

Herein, when the tracking position 411C displayed in the main screen area 281 is set as the reference, the tracking position 411A is shifted in position in the x direction. On the other hand, the tracking position 411B is shifted in position in the y direction.

Under such a condition, for example, a display shown in B of FIG. 33 and a display shown in C of FIG. 33 are considerable.

In B of FIG. 33, in the sub screen area 282-1, the expanded image A′ subjected to the expansion processing is arranged while the tracking position 411A by the tracking processing unit 341A is set as the reference, in the sub screen area 282-2, the expanded image B′ subjected to the expansion processing is arranged while the tracking position 411B by the tracking processing unit 341B is set as the reference, and in the sub screen area 282-3, a display screen on which the image input is arranged is shown.

On the other hand, in C of FIG. 33, in the sub screen area 282-1, the expanded image B′ subjected to the expansion processing is arranged while the tracking position 411B by the tracking processing unit 341B is set as the reference, in the sub screen area 282-2, the expanded image A′ subjected to the expansion processing is arranged while the tracking position 411A by the tracking processing unit 341A is set as the reference, and in the sub screen area 282-3, a display screen on which the image input is arranged is shown.

It should be noted that dotted lines in B of FIG. 33 and C of FIG. 33 are auxiliary lines added for making it easier to notice the difference.

When the display screens in B of FIG. 33 and C of FIG. 33 are compared, the display screen in C of FIG. 33 is easier to notice the difference with the expanded image C′ subjected to the expansion processing while the tracking position 411C displayed in the main screen area 281 is set as the reference.

In view of the above, the image synthesis unit 214 changes the expanded images displayed in the sub screen areas 282-1 and 282-2 in accordance with the tracking processing results so as to be easily compared with the expanded image displayed in the main screen area 281.

To be more specific, the image synthesis unit 214 obtains a difference between the tracking position of the tracking processing unit 341 displayed in the main screen area 281 and the respective tracking positions of the unselected remaining two tracking processing units 341 as a tracking difference vector and further obtains a ratio of the horizontal component and the vertical component of the obtained tracking difference vector (the vertical component/the horizontal component). Then, the image synthesis unit 214 displays the expanded image in which the tracking position of the tracking processing unit 341 corresponding to the larger one among the obtained two ratios is set as the reference in the sub screen area 282-2 and the expanded image in which the tracking position of the tracking processing unit 341 corresponding to the small one is set as the reference in the sub screen area 282-1.

By doing so, the expanded images can be displayed in the sub screen areas 282-1 and 282-2 so as to be easily compared with the expanded image displayed in the main screen area 281.

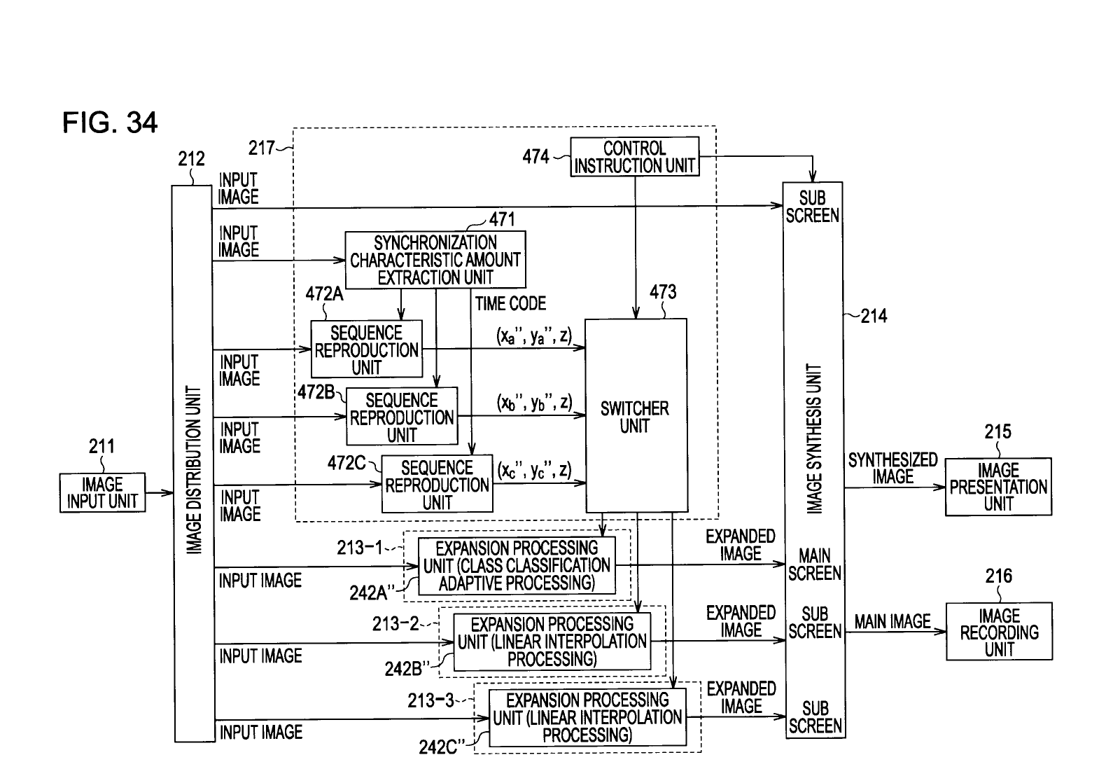

FIG. 34 is a block diagram showing a third detailed configuration example (third embodiment) of the image processing apparatus 200 in FIG. 14.

The image processing unit 213-1 is composed of an expansion processing unit 242A″, and the image processing unit 213-2 is composed of an expansion processing unit 242B″. Also, the image processing unit 213-3 is composed of an expansion processing unit 242C″.

The control unit 217 is composed of a synchronization characteristic amount extraction unit 471, sequence reproduction units 472A to 472C, a switcher unit 473, and a control instruction unit 474.

Similarly as in the expansion processing units 242A′ to 242C′ according to the second embodiment, the expansion processing units 242A″ to 242C″ execute the expansion processing to be supplied to the expanded images after the processing to the image synthesis unit 214. The area in which the expansion processing units 242A″ to 242C″ respectively perform the expansion processing is a predetermined area of the image input decided by a zoom parameter (xₐ″, yₐ″, z) , (x_{b}″, y_{b}″, z) , or (x_{c}″, y_{c}″, z) supplied from the switcher unit 473. It should be noted that hereinafter, the expanded image expanded on the basis of the zoom parameter (xₐ″, yₐ″, z) is set as the expanded image A″, the expanded image expanded on the basis of the zoom parameter (x_{b}″, y_{b}″, z) is set as the expanded image B″, and the expanded image expanded on the basis of the zoom parameter (x_{c}″, y_{c}″, z) is set as the expanded image C″.

The expansion processing units 242A″ to 242C″ execute the expansion processing in the respectively difference systems. In the image synthesis unit 214, the expanded images after the expansion processing A″ to C″ are displayed on the display screen 270 composed of the main screen area 281 and the sub screen areas 282-1 to 282-3 shown in FIG. 20, but the expansion processing unit 242A″ performs the high image quality (high performance) expansion processing for the main screen area 281. On the other hand, the expansion processing units 242B″ and 242C″ perform the low image quality (simple) expansion processing for the sub screen areas 282-1 to 282-3.

The expansion processing By the expansion processing unit 242A″ can be set, for example, as a processing adopting the above-mentioned class classification adaptive processing. Also, the expansion processing performed by the expansion processing units 242B″ and 242C″ is set as, for example, a processing based on the linear interpolation, and intervals for interpolation can be set different from each other in the expansion processing units 242B″ and 242C″.

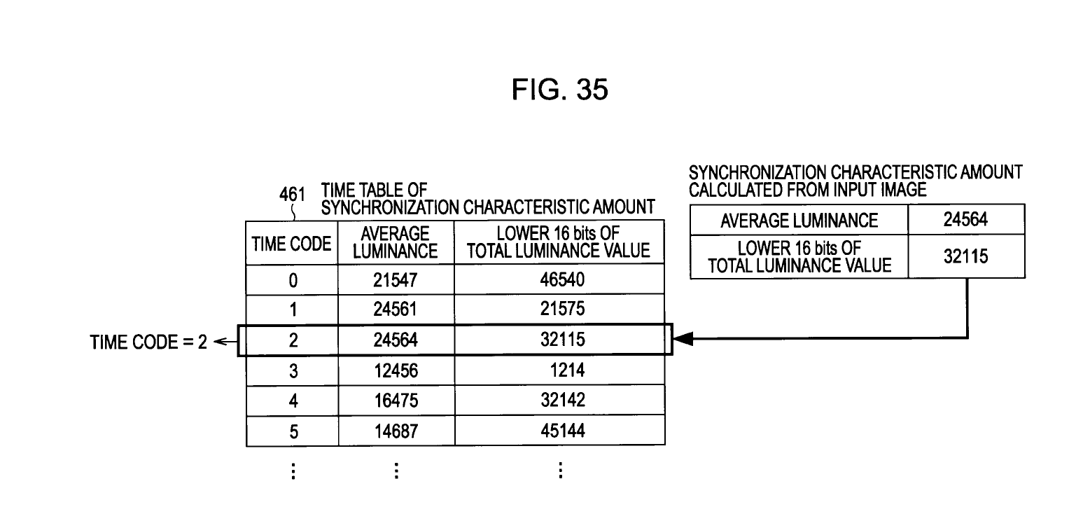

The synchronization characteristic amount extraction unit 471 of the control unit 217 stores therein a synchronization characteristic amount time table 461 (FIG. 35) with respect to the image input. Herein, the synchronization characteristic amount is the characteristic amount of the image input used for taking the synchronization of the image inputs, and according to the present embodiment, as the synchronization characteristic amount, an average value of the luminance values in the image inputs (average luminance value) represented by 16 bits and lower 16 bits of the total value of the luminance values of all the pixels in the image inputs (total luminance value) are adopted. Also, the synchronization characteristic amount time table 461 is a table in which time codes representing which scenes of images the respective image inputs are among the moving images are associated with the synchronization characteristic amounts of the image inputs. In the image inputs having a reproducibility such as a film with a length of about 2 hours, by using the above-mentioned two synchronization characteristic amounts, it is possible to almost certainly determine the scene of the image input. It should be noted that as the synchronization characteristic amount, it is of course possible to adopt another characteristic amount of the image.

The synchronization characteristic amount extraction unit 471 calculates (extracts) the synchronization characteristic amount of the input image supplied from the image distribution unit 212 and refer to the synchronization characteristic amount time table 461, so that the time code currently corresponding to the input image supplied from the image distribution unit 212 is detected. The synchronization characteristic amount extraction unit 471 supplies the detected time code to the sequence reproduction units 472A to 472C.

The sequence reproduction units 472A to 472C respectively store a parameter table in which time codes are associated with zoom parameters. The zoom parameters stored by the sequence reproduction units 472A to 472C as the parameter tables are mutually different. Therefore, the same time code is supplied from the synchronization characteristic amount extraction unit 471 to the sequence reproduction units 472A to 472C, but different zoom parameters are supplied to the switcher unit 473 from the respective sequence reproduction units 472A to 472C.

To be more specific, while corresponding to the time code supplied from the synchronization characteristic amount extraction unit 471, the sequence reproduction unit 472A supplies the zoom parameter (xₐ″, yₐ″, z) to the switcher unit 473. While corresponding to the time code supplied from the synchronization characteristic amount extraction unit 471, the sequence reproduction unit 472B supplies the zoom parameter (x_{b}″, y_{b}″, z) to the switcher unit 473. While corresponding to the time code supplied from the synchronization characteristic amount extraction unit 471, the sequence reproduction unit 472C supplies the zoom parameter (x_{c}″, y_{c}″, z) to the switcher unit 473.

The zoom parameter (xₐ″, yₐ″, z) denotes the center position (xₐ″, yₐ″) when the expansion processing is performed and the zoom rate z. The same applies to the zoom parameter (x_{b}″, y_{b}″, z) and (x_{c}″, y_{c}″, z) too. It should be noted that the zoom rate z is common among the zoom parameters output by the sequence reproduction units 472A to 472C, but the zoom rate z can also be set as different values in the sequence reproduction units 472A to 472C.

To the switcher unit 473, selection information is supplied from the control instruction unit 474 which is information indicating that the expanded image displayed in the main screen area 281 of the display screen 270 is selected while the user operates the remote commander or the like and indicating one of the expanded images A″ to C″.

The switcher unit 473 appropriately selects the zoom parameter (xₐ″, yₐ″, z), (x_{b}″, y_{b}″, z), and (x_{c}″, y_{c}″, z) so that the expansion processing at the highest image quality is performed on the expanded image indicated by the selection information to be supplied to the expansion processing units 242A″ to 242C″ on a one-on-one basis. That is, in a case where the expanded image A″ is supplied as the selection information, the switcher unit 473 supplies the zoom parameter (xₐ″, yₐ″, z) to the expansion processing unit 242A″, in a case where the expanded image B″ is supplied as the selection information, supplies the zoom parameter (x_{b}″, y_{b}″, z) to the expansion processing unit 242A″, and in a case where the expanded image C″ is supplied as the selection information, supplies the zoom parameter (x_{c}″, y_{c}″, z) to the expansion processing unit 242A″.

The control instruction unit 474 supplies the expanded image instructed by the user by operating the remote commander or the like to be displayed in the main screen area 281 of the display screen 270 to the switcher unit 473 as the selection information. Also, the control instruction unit 474 supplies the operation information indicating the operations of the down key DN, the up key, and the decision key RTN, and the like of the remote commander to the image synthesis unit 214.

The image synthesis unit 214 generates a synthesized image in which the expanded images A″ to C″ supplied from the expansion processing units 242A″ to 242C″ and the image input supplied from the image distribution unit 212 are synthesized to be supplied to the image presentation unit 215. Herein, the image synthesis unit 214 generates the synthesized image so that the expanded image supplied from the expansion processing unit 242A″ is arranged in the main screen area 281 of the display screen 270.

Also, on the basis of the operation information from the control instruction unit 474, the image synthesis unit 214 performs the highlight display 291 in a predetermined area in the sub screen areas 282-1 to 282-3.

Next, with reference to FIG. 35, a time code detection processing by the synchronization characteristic amount extraction unit 471 will be described.

First, the synchronization characteristic amount extraction unit 471 calculates the synchronization characteristic amount of the input image supplied from the image distribution unit 212. FIG. 35 shows an example in which the calculated synchronization characteristic amounts are the average luminance value “24564” and the lower 16 bits of the total luminance value “32155”.

Then, the synchronization characteristic amount extraction unit 471 detects the time code having the same synchronization characteristic amount from the synchronization characteristic amount time table 461. In the time table 461 of FIG. 35, the synchronization characteristic amount corresponding to the time code “2” is matched with the calculated synchronization characteristic amount. Therefore, the synchronization characteristic amount extraction unit 471 supplies the time code “2” to the sequence reproduction units 472A to 472C.

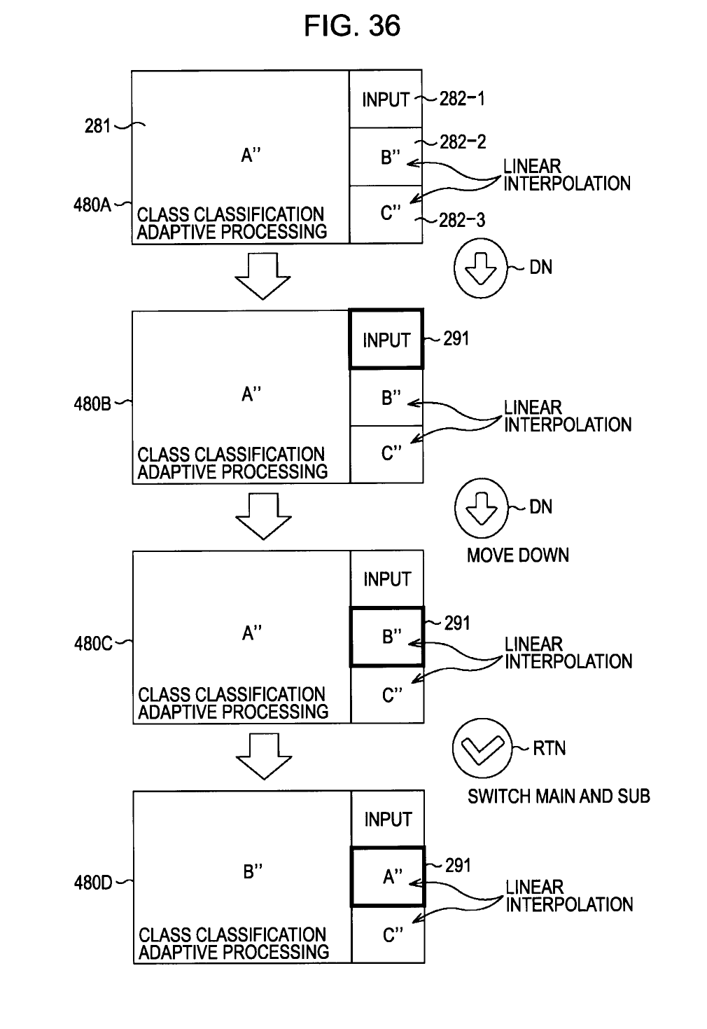

Next, with reference to FIGS. 36 to 38, the screen control according to the third embodiment will be described.

FIG. 36 shows a state in which a display screen to be displayed in the image presentation unit 215 is shifted in the order of display screens 480A to 480D on the basis of the operation of the user. It should be noted that in FIG. 36, similarly as in FIG. 30, graphical representation of reference symbols for the main screen area 281 and the sub screen areas 282-1 to 282-3 is partially omitted.

In the initial state, the display screen 480A is displayed. In the display screen 480A, the expanded image A″ expanded on the basis of the zoom parameter (xₐ″, yₐ″, z) instructed by the sequence reproduction unit 472A is displayed in the main screen area 281. The image input is displayed in the sub screen area 282-1. The expanded image B″ expanded on the basis of the zoom parameter (x_{b}″, y_{b}″, z) instructed by the sequence reproduction unit 472B is displayed in the sub screen area 282-2. The expanded image C″ expanded on the basis of the zoom parameter (x_{c}″, y_{c}″, z) instructed by the sequence reproduction unit 472C is displayed in the sub screen area 282-3.

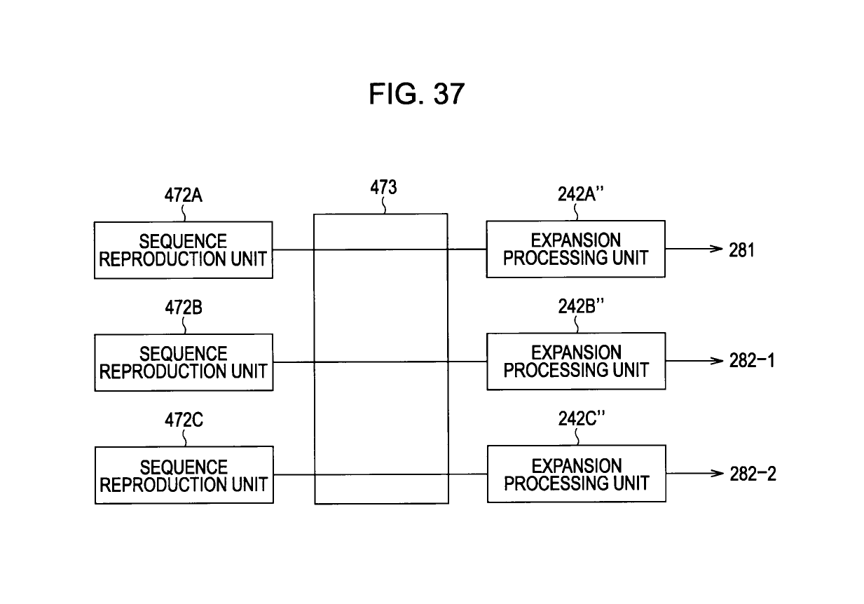

That is, the initial state, as shown in FIG. 37, the switcher unit 473 supplies the zoom parameter (xₐ″, yₐ″, z) supplied from the sequence reproduction unit 472A to the expansion processing unit 242A″ and supplies the zoom parameter (x_{b}″, y_{b}″, z) supplied from the sequence reproduction unit 472B to the expansion processing unit 242B″. Also, the switcher unit 473 supplies the zoom parameter (x_{c}″, y_{c}″, z) supplied from the sequence reproduction unit 472C to the expansion processing unit 242C″.

While returning back to FIG. 36, from the state of the display screen 480A, when the user operates the down key DN of the remote commander, the image presentation unit 215 obtains the operation via the control instruction unit 474 to display the display screen 480B. On the display screen 480B, in addition to the display of the display screen 480A, the highlight display 291 for highlighting a predetermined sub screen area is displayed in the sub screen area 282-1.

In a state in which the display screen 480B is displayed, when the user operates the down key DN of the remote commander, the image presentation unit 215 displays the display screen 480C in which the highlight display 291 is moved to the sub screen area 282-2.

Next, in a state in which the display screen 480C is displayed, when the user operates the decision key RTN of the remote commander, the selection information indicating that the expanded image B″ is selected is supplied from the control instruction unit 474 to the switcher unit 473.

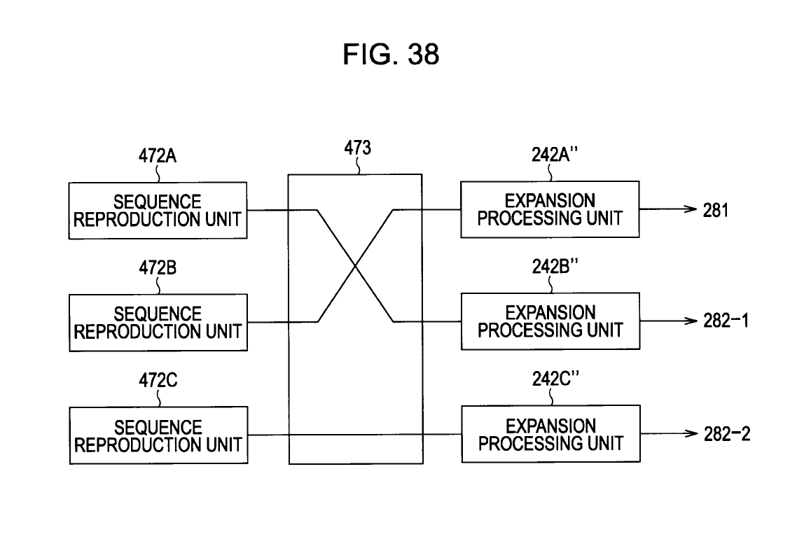

As shown in FIG. 38, the switcher unit 473 switches the zoom parameters supplied to the expansion processing unit 242A″ and the expansion processing unit 242B″. That is, the switcher unit 473 supplies the zoom parameter (xₐ″, yₐ″, z) supplied from the sequence reproduction unit 472A to the expansion processing unit 242B″ and the zoom parameter (x_{b}″, y_{b}″, z) supplied from the sequence reproduction unit 472B to the expansion processing unit 242A″. The zoom parameter (x_{c}″, y_{c}″, z) supplied from the sequence reproduction unit 472C is supplied to the expansion processing unit 242C″ as it is.

As a result, the display screen 480D of FIG. 36 is displayed. On the display screen 480D, in the main screen area 281, the large image A″ expanded on the basis of the zoom parameter (xₐ″, yₐ″, z) is displayed, and in the sub screen area 282-2, the expanded image B″ expanded on the basis of the zoom parameter (x_{b}″, y_{b}″, z) is displayed.

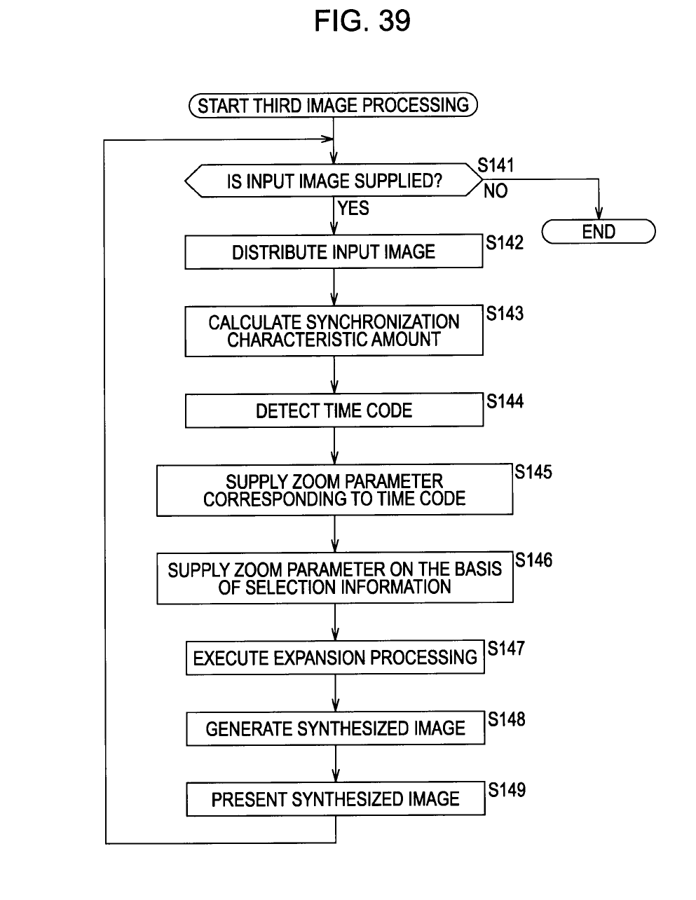

Next, with reference to a flow chart of FIG. 39, an image processing by the image processing apparatus 200 of FIG. 34 (third image processing) will be described.

First, in step S141, the image distribution unit 212 determines whether or not the image input is supplied from the image input unit 211. In step S141, in a case where it is determined that the image input is not supplied, the processing is ended.

On the other hand, in step S141, in a case where it is determined that the image input is supplied from the image input unit 211, the processing proceeds to step S142, and the image distribution unit 212 distributes the supplied image input. That is, the image distribution unit 212 supplies the image input to the synchronization characteristic amount extraction unit 471, the sequence reproduction units 472A to 472C, the expansion processing units 242A″ to 242C″, and the image synthesis unit 214.

In step S143, the synchronization characteristic amount extraction unit 471 calculates the synchronization characteristic amount of the input image supplied from the image distribution unit 212, and in step S144, by referring to the time table 461, the time code corresponding to the calculated synchronization characteristic amount is detected. The detected time code is supplied to the sequence reproduction units 472A to 472C.

In step S145, the sequence reproduction units 472A to 472C refer to the parameter table in which the time codes are associated with the zoom parameters and supply the zoom parameter corresponding to the supplied time code to the switcher unit 473. The sequence reproduction unit 472A supplies the zoom parameter (xₐ″, yₐ″, z) to the switcher unit 473, and the sequence reproduction unit 472B supplies the zoom parameter (x_{b}″, y_{b}″, z) to the switcher unit 473. The sequence reproduction unit 472C supplies the zoom parameter (x_{c}″, y_{c}″, z) to the switcher unit 473.

In step S146, on the basis of the selection information from the control instruction unit 474, the switcher unit 473 supplies the zoom parameter supplied from the sequence reproduction units 472A to 472C to the expansion processing units 242A″ to 242C″.

In step S147, the expansion processing units 242A″ to 242C″ respectively execute the expansion processing to supply the expanded images after the processing to the image synthesis unit 214.

In step S148, the image synthesis unit 214 uses the input image supplied from the image distribution unit 212 and the expanded images A″ to C″ subjected to the expansion processing to generate a synthesized image to be supplied to the image presentation unit 215. Herein, the image synthesis unit 214 generates the synthesized image so that the expanded image supplied from the expansion processing unit 242A″ is displayed in the main screen area 281. Also, the image synthesis unit 214 supplies the main image which is the image arranged in the main screen area 281 among the synthesized image to the image recording unit 216.

In step S149, the image presentation unit 215 displays the synthesized image supplied from the image synthesis unit 214 in a predetermined display unit to be presented to the user. Also, in step S149, the image recording unit 216 records the main image supplied from the image synthesis unit 214 on the predetermined recording medium. After the processing in step S149, the processing returns to step S141, and the subsequent processing is repeatedly executed.

As described above, in the third image processing by the image processing apparatus 200 of FIG. 34, the synthesized image based on the input image supplied from the image distribution unit 212 and the expanded images A″ to C″ subjected to the expansion processing is displayed in the image presentation unit 215, and the user can select a desired image among the displayed images.

The expanded images A″ to C″ subjected to the expansion processing are images where areas decided by the different zoom parameters (xₐ″, yₐ″, z), (x_{b}″, y_{b}″, z), and (x_{c}″, y_{c}″, z) are expanded, which are therefore respectively different images. Therefore, by sequentially switching the image input or the expanded images A″ to C″, the user can perform editing as if the inputs from a plurality of camera image frames are switched in the main screen area 281. Also, other unselected image input or expanded images A″ to C″ are also displayed in the sub screen areas 282-1 to 282-3, and therefore the user can perform editing while performing the comparison.

Also, the switcher unit 473 switches the zoom parameters supplied to the expansion processing units 242A″ to 242C″ in accordance with a selection of the user, and thus the main image displayed in the main screen area 281 and the main image recorded in the image recording unit 216 can be set as the expanded images expanded by the expansion processing regularly having the high image quality. According to this, it is possible to perform the expansion processing at the high image quality on the expanded image to be viewed on a large screen or to be recorded, and on the other hand it is possible to adopt an inexpensive processing unit on the expanded image which is not necessary for the recording. Thus, the overall cost can be suppressed, and also the performances which the expansion processing units 242A″ to 242C″ have can be effectively utilized. That is, it is possible to effectively distribute the resource for the processing.

Next, a modified example of the third embodiment will be described.

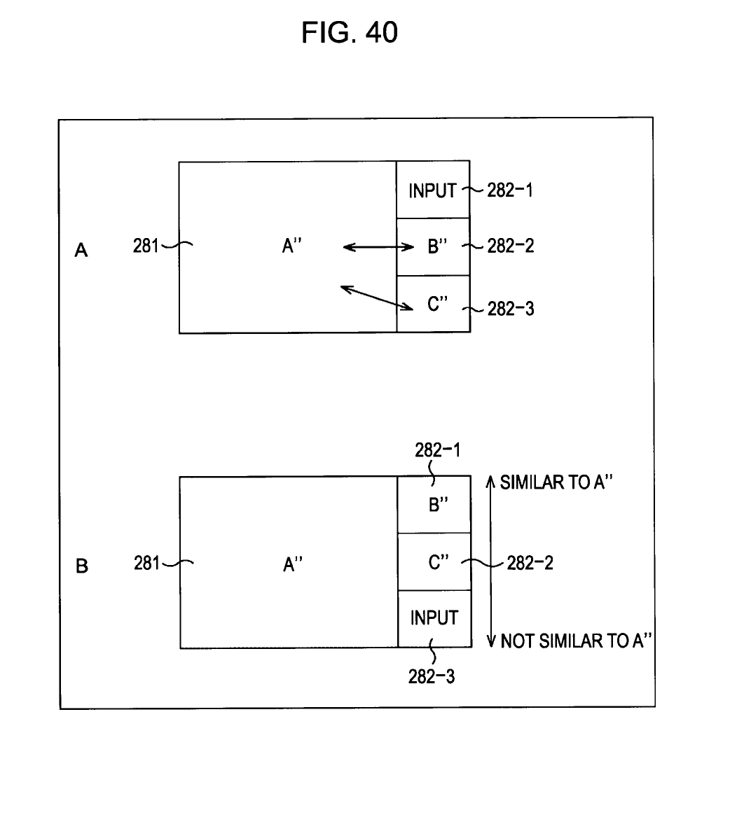

In the above-mentioned example, as shown in A of FIG. 40, the arrangements of the expanded image which is the expanded image displayed in one of the sub screen areas 282-1 to 282-3 and which is selected by the user and the expanded image displayed in the main screen area 281 are switched, and other than the selection by the user, the arrangements of the other images displayed in the sub screen areas 282-1 to 282-3 are not changed, but the arrangements of the images displayed in the sub screen areas 282-1 to 282-3 can be changed in accordance with a correlation with the expanded image displayed in the main screen area 281. For example, as shown in B of FIG. 40, the image processing apparatus 200 arranges an image more similar to the expanded image A″ (an image with a large correlation value) displayed in the main screen area 281 on a still upper position of the sub screen areas 282-1 to 282-3.

To be more specific, the image synthesis unit 214 calculates, periodically or at a predetermined timing, a correlation value corr of the image displayed in the main screen area 281 for the display and the respective three images input in the sub screen areas 282-1 to 282-3 for the display through the following Expression (29).

$$\begin{matrix}[ Expression 29 ] & \\ corr = \frac{{Σ}_{x , y} ( {pv}_{1} ( x , y ) - {pv}_{1 \_ av} ) ( {pv}_{2} ( x , y ) - {pv}_{2 \_ av} )}{\begin{matrix}\sqrt{{{Σ}_{x , y} ( {pv}_{1} ( x , y ) - {pv}_{1 \_ av} )}^{2}} \cdot \\ \sqrt{{{Σ}_{x , y} ( {pv}_{2} ( x , y ) - {pv}_{2 \_ av} )}^{2}}\end{matrix}} & ( 29 )\end{matrix}$$

In Expression (29), pv₁(x, y) denotes a luminance value in a predetermined position (x, y) of the image displayed in the main screen area 281, pv₂(x, y) denotes a luminance value in the position (x, y) corresponding to one of the comparison target images displayed in the sub screen areas 282-1 to 282-3, pv₁_{_{—}}ₐᵥ denotes an average luminance value of the image displayed in the main screen area 281, and pv₂_{_{—}}ₐᵥ denotes an average luminance value of one of the comparison target images displayed in the sub screen areas 282-1 to 282-3.

Then, the image synthesis unit 214 generates a synthesized image in which the display is performed from the top of the sub screen areas 282-1 to 282-3 in the descending order of the three calculated correlation values corr to be supplied to the image presentation unit 215. According to this, the user can easily find a desired image from the switching candidate images.

As described above, according to the above-mentioned first to third embodiments, a plurality of different image processings are applied on the input moving image, and the images after the processings are displayed at the same time, so that it is possible to easily perform the comparison.

It should be noted that in the above-mentioned example, the image synthesis unit 214 generates the synthesized image while corresponding to the display screen 270 (FIG. 20) composed of the main screen area 281 and the sub screen areas 282-1 to 282-3 arranged on the right side thereof and generates the synthesized image while corresponding to the display screen 400 (FIG. 32) on which the area is evenly divided into four, but other synthesis methods can also be adopted.

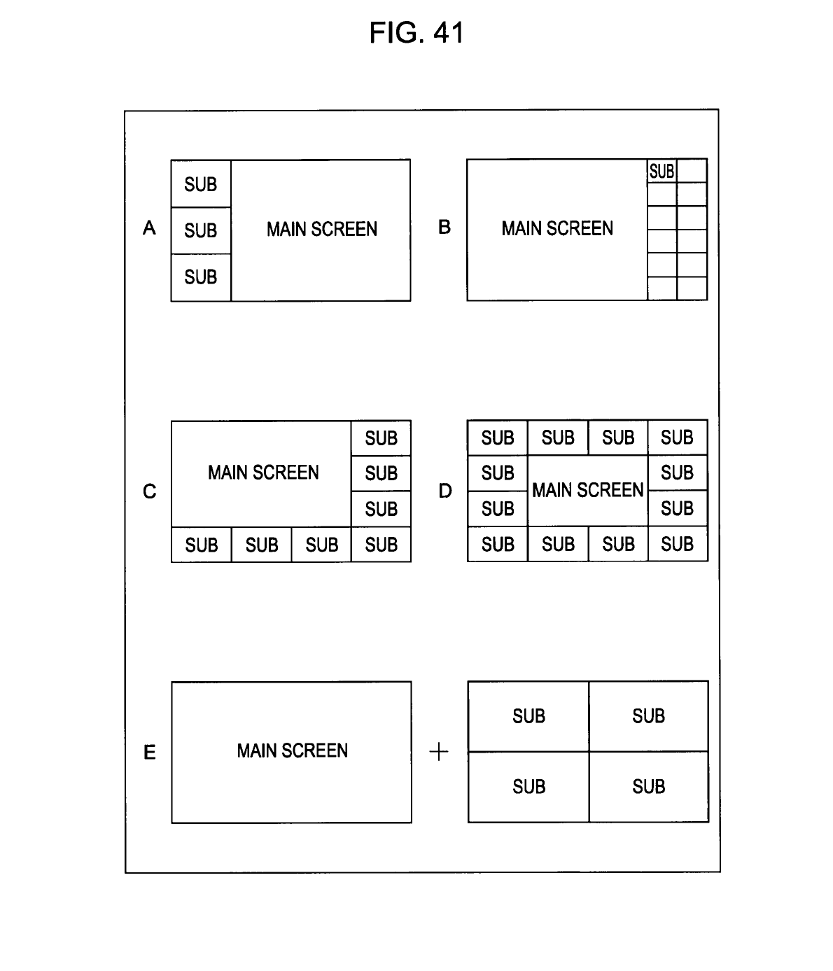

The other synthesis methods by the image synthesis unit 214 include synthesis methods shown in A of FIG. 41 to D of FIG. 41. Also, in a case where the display can be performed on a plurality of screens, as shown in E of FIG. 41, the main image and the sub images may also be displayed on separate screens.

As shown in B of FIG. 41 and C of FIG. 41, in a case where a plurality of sub images are arranged on one line, it is more effective to display in the descending order of the tracking difference vectors described with reference to FIG. 33 or in the descending order of the correlation values corr described with reference to FIG. 40.

Also, the highlight display can be set as a display other than the frame display enclosing the surrounding of the area shown in FIG. 21 or 30.

The above-mentioned series of processings can be executed by hardware and can also be executed by software. In a case where the above-mentioned series of processings is executed by the software, a program structuring the software is installed from a recording medium into a computer incorporated in dedicated-use hardware or, for example, a general-use personal computer or the like which is capable of executing various functions by installing various programs.

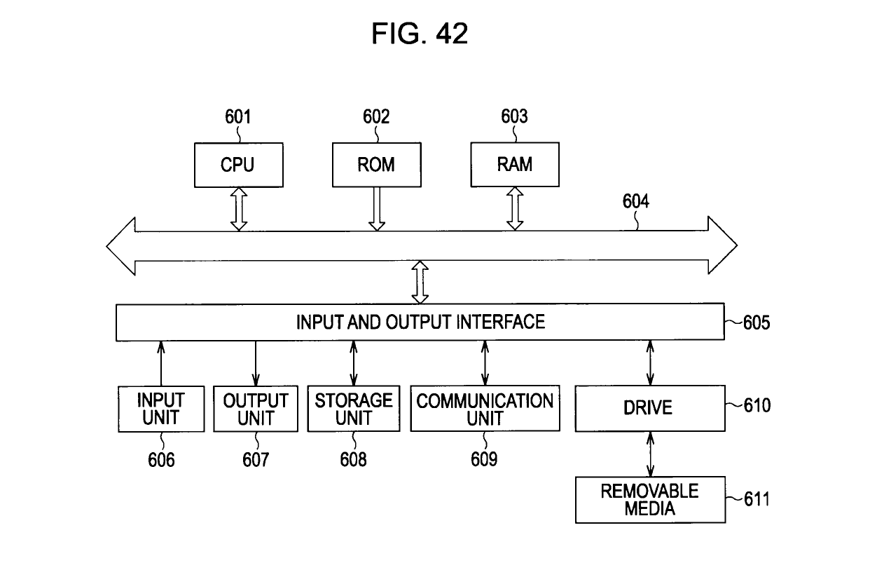

FIG. 42 is a block diagram showing a configuration example of the hardware of the computer for executing the above-mentioned series of processings by the programs.

In the computer, a CPU (Central Processing Unit) 601, a ROM (Read Only Memory) 602, and a RAM (Random Access Memory) 603 are mutually connected by a bus 604.

To the bus 604, furthermore, an input and output interface 605 is connected. To the input and output interface 605, an input unit 606 composed of a key board, a mouse, a microphone, or the like, an output unit 607 composed of a display, a speaker, or the like, a storage unit 608 composed of a hard disk drive, a non-volatile memory, or the like, a communication unit 609 composed of a network interface or the like, and a drive 610 for driving removable media 611 such as a magnetic disk, an optical disk, an opto-magnetic disk, or a semiconductor memory are connected.

In the computer configured as described above, the CPU 601 loads, for example, the programs stored in the storage unit 608 via the input and output interface 605 and the bus 604 onto RAM 603 to be executed, so that the above-mentioned first to third image processings are performed.

The programs executed by the computer (the CPU 601) are recorded, for example, in the removable media 611 which is package media composed of the magnetic disk (including a flexible disk), the optical disk (CD-ROM (Compact Disc-Read Only Memory), DVD (Digital Versatile Disc) or the like), the opto-magnetic disk, the semiconductor memory, or the like, or are provided via a wired or wireless transmission medium such as a local area network, the internet, or digital satellite broadcasting.

Then, the programs can be installed into the storage unit 608 via the input and output interface 605 by mounting the removable media 611 to the drive 610. Also, the programs can be received by the communication unit 609 via the wired or wireless transmission medium and installed into the storage unit 608. In addition, the programs can be previously installed into the ROM 602 or the storage unit 608.

It should be noted that the program executed by the computer may be a program where the processings are performed in a time sequence manner while following the order described in the present specification but may also be a program where the processings are performed in parallel or at a necessary timing when a call is performed or the like.

In the present specification, steps described in the flow chart of course include the processing executed in a time sequence manner while following the stated order but also the processing executed in parallel or individually instead of not necessarily being processed in the time sequence manner.

Also, in the present specification, the system represents an entire apparatus composed of a plurality of apparatuses.

Embodiments of the present invention is not limited to the above-mentioned embodiments, and various modifications can be made without departing from the gist of the present invention.

1. An image processing apparatus comprising:
a plurality of image processing means configured to perform a plurality of different image processings on one input image which is an image constituting a moving image and is sequentially input; and
synthesized image generation means configured to generate a synthesized image in which a plurality of processed images which are respectively processed by the plurality of image processing means are synthesized,
wherein the synthesized image changes in accordance with results of the plurality of image processings.

2. The image processing apparatus according to claim 1,
wherein each of the plurality of image processing means includes:
image quality change processing means configured to change an image quality of the input image into image qualities different in each of the plurality of image processing means; and
expansion processing means configured to perform an expansion processing while using a predetermined position of the image after the change processing which is subjected to the change processing by the image quality change processing means as a reference,
the image processing apparatus further comprising control means configured to decide the predetermined position on the basis of change processing results by the image quality change processing means of the plurality of image processing means.

3. The image processing apparatus according to claim 2,
wherein the control means decides a position as the predetermined position where a difference is large when the plurality of images after the change processings are mutually compared.

4. The image processing apparatus according to claim 1,
wherein the synthesized image is composed of a main image which is the processed image instructed by a user and a plurality of sub images which are the other processed images, and
wherein the synthesized image generation means changes an arrangement of the processed image which is set as the main image and the processed images set as the sub images on the basis of an instruction of the user.

5. The image processing apparatus according to claim 4,
wherein the synthesized image generation means performs a highlight display of the sub image selected by the user.

6. The image processing apparatus according to claim 4,
wherein the synthesized image is displayed on one screen.

7. The image processing apparatus according to claim 4,
wherein the main image is displayed on one screen, and the plurality of sub images are displayed on one screen.

8. The image processing apparatus according to claim 1,
wherein the plurality of image processing means performs the plurality of different image processings by using a class classification adaptive processing.

9. The image processing apparatus according to claim 1,
wherein each of the plurality of image processing means includes:
tracking processing means configured to track the predetermined position of the input image in tracking systems different in each of the plurality of image processing means; and
expansion processing means configured to perform an expansion processing while using a tracking position which is a result of the tracking processing by the tracking processing means as a reference.

10. The image processing apparatus according to claim 9, further comprising:
control means configured to supply the tracking position selected by a user among the plurality of tracking positions as the predetermined position to the tracking processing means.

11. The image processing apparatus according to claim 9,
wherein the synthesized image is composed of a main image which is the processed image instructed by a user and a plurality of sub images which are the other processed images, and
wherein the synthesized image generation means changes an arrangement of the sub images in accordance with a ratio of a horizontal component and a vertical component of a tracking difference vector representing a difference between the tracking position of the main image and the tracking position of the sub image.

12. The image processing apparatus according to claim 1, further comprising:
detection means configured to detect a time code representing which scene of the moving image the input image is on the basis of characteristic amounts of the plurality of input images; and
the same number of decision means configured to decide the predetermined positions as the number of the image processing means,
wherein the decision means stores the predetermined position in the input image while corresponding to the time code and decides the different predetermined positions by each of the plurality of decision means corresponding to the detected time code, and
wherein each of the plurality of image processing means includes
expansion processing means configured to perform an expansion processing while using the predetermined position decided by the decision means as a reference.

13. The image processing apparatus according to claim 12,
wherein the plurality of expansion processing means include the expansion processing means configured to perform a high image quality expansion processing and the expansion processing means configured to perform a low image quality expansion processing,
the image processing apparatus further comprising control means configured to control a supply of an expanded image selected by a user among a plurality of expanded images subjected to the expansion processing by each of the plurality of expansion processing means to the expansion processing means at the predetermined position decided by the decision means so as to be processed by the expansion processing means configured to perform the high image quality expansion processing.

14. The image processing apparatus according to claim 13,
wherein the synthesized image is composed of a main image which is the processed image instructed by the user and a plurality of sub images which are the other processed images, and
wherein the synthesized image generation means changes an arrangement of the processed images so as to set the expanded image processed by the expansion processing means configured to perform the high image quality expansion processing as the main image.

15. The image processing apparatus according to claim 14,
wherein the synthesized image generation means calculates correlation values between the expanded image of the main image and the expanded images of the sub images and changes an arrangement of the plurality of sub images in a descending order.

16. An image processing method comprising the steps of:
performing a plurality of different image processings on one input image which is an image constituting a moving image and is sequentially input; and
generating a synthesized image in which a plurality of processed images obtained as a result of being subjected to the image processings are synthesized,
wherein the synthesized image changes in accordance with results of the plurality of image processings.

17. A program for causing a computer to execute a processing comprising:
performing a plurality of different image processings on one input image which is an image constituting a moving image and is sequentially input; and
generating a synthesized image in which a plurality of processed images obtained as a result of being subjected to the image processings are synthesized,
wherein the synthesized image changes in accordance with results of the plurality of image processings.
